(19) United States
(12) Patent Application Publication
(10) Pub. No.: US 2026/0371346 A1
(43) Pub. Date: Nov. 19, 2026

(54) METHOD AND APPARATUS FOR PERFORMING TUNNELING RELAY COMMUNICATION IN WLAN

(71) Applicant: HOLISTIC MANIFOLD INC., Daejeon (KR)

(72) Inventors: Yongho KIM, Incheon (KR); Juseong MOON, Osan-si (KR)

(73) Assignee: HOLISTIC MANIFOLD INC., Daejeon (KR)

(21) Appl. No.: 19/743,890

(22) Filed: Jul. 16, 2026

Related U.S. Application Data
(63) Continuation of application No. PCT/KR2025/001029, filed on Jan. 17, 2025.

(30) Foreign Application Priority Data
Jan. 17, 2024 (KR) 10-2024-0007253

(51) Int. Cl. H04W 72/1273; H04B 7/155; H04W 84/12; H04W 88/10

(52) U.S. Cl. CPC H04W 72/1273; H04B 7/155; H04W 84/12; H04W 88/10

(57) ABSTRACT

A method of operating a relay in a wireless LAN system may comprise: receiving, by the relay, a first frame from an AP, wherein a medium access control (MAC) header of the first frame includes a first indicator indicating that the first frame is transferred through the relay; transmitting a second frame to a STA based on the first frame received by the relay; receiving, by the relay, a first response frame generated based on the first frame from the STA, wherein a MAC header of the first response frame includes a second indicator indicating that the first response frame is transferred through the relay; and transmitting a second response frame to the AP based on the first response frame.

### CROSS REFERENCE TO RELATED APPLICATION

This application is a continuation application of International Application No. PCT/KR2025/001029, filed on Jan. 17, 2025, which claims priority to Korean Patent Application No. 10-2024-0007253, filed on Jan. 17, 2024, the disclosures of which are incorporated herein by reference in their entireties.

### FIELD

The present disclosure relates to wireless local area network (WLAN) communication technology, and more specifically, to a method and apparatus for extending the communication range of a wireless LAN terminal through the operation of a wireless LAN relay terminal.

### DESCRIPTION OF THE RELATED ART

As the proliferation of mobile devices has recently expanded, wireless local area network (WLAN) technology capable of providing fast wireless communication services to mobile devices has been receiving significant attention. WLAN technology may be a technology that enables mobile devices, such as smartphones, smart pads, laptop computers, portable multimedia players, and embedded devices, to wirelessly access the Internet based on short-range wireless communication technology.

Standards utilizing WLAN technology are primarily being developed by the Institute of Electrical and Electronics Engineers (IEEE) as the IEEE 802.11 standard. As the aforementioned WLAN technology has been developed and disseminated, applications utilizing WLAN technology have diversified, and demand for WLAN technology supporting higher reliability has emerged.

As applications requiring higher reliability have emerged, the IEEE 802.11bn standard, which is an Ultra High Reliability (UHR) WLAN technology, is being developed for single Basic Service Set (BSS) environments and/or overlapping BSS environments. The goal of the IEEE 802.11bn standard may be to support improvements in data transmission rate, latency performance, and data error rate. In addition, the IEEE 802.11bn standard may support low-power operation, peer-to-peer communication, and relay communication for extending the communication range.

However, cases where the relay communication operation is not performed smoothly may be considered. In an embodiment, a relay terminal may have limitations in recording and managing the status of packets transmitted between other wireless LAN terminals, which may increase the complexity of relay terminal operations. Accordingly, a relay terminal may not correctly relay packets, and the performance of the communication range extension operation of the wireless LAN network may decrease. In the following, a method of performing tunneling relay communication in a wireless LAN is described in consideration of the foregoing.

Meanwhile, the technology serving as the background of the present disclosure has been described to promote understanding of the background of the present disclosure, and may include content that is not prior art already known to those of ordinary skill in the art to which this technology belongs.

### SUMMARY

The present disclosure relates to a method and apparatus for performing tunneling relay communication in a wireless LAN.

The present disclosure relates to a method and apparatus for generating a tunneled packet for a relay terminal performing a relay communication operation.

The present disclosure relates to a method and apparatus in which a relay terminal performing a relay communication operation receives a frame from a wireless LAN terminal and transmits the frame to another wireless LAN terminal.

The present disclosure relates to a method and apparatus for determining a relay terminal to which transmission is to be performed based on an artificial intelligence algorithm.

The technical objectives to be achieved in the present disclosure are not limited to the technical objectives mentioned above, and other technical objectives not mentioned will be clearly understood by those of ordinary skill in the art to which the present disclosure belongs from the description below.

In accordance with an embodiment of the present disclosure, a method of operating a relay in a wireless LAN system comprises: receiving, by the relay, a first frame from an access point (AP), wherein a medium access control (MAC) header of the first frame includes a first indicator indicating that the first frame is transferred through the relay; transmitting a second frame to a station (STA) based on the first frame received by the relay; receiving, by the relay, a first response frame generated based on the first frame from the STA, wherein a MAC header of the first response frame includes a second indicator indicating that the first response frame is transferred through the relay; and transmitting a second response frame to the AP based on the first response frame.

In accordance with an embodiment of the present disclosure, a relay may comprise at least one transceiver configured to transmit and receive signals, at least one processor configured to control the at least one transceiver, and a memory storing instructions that cause the relay to perform specific operations by the at least one processor. Here, the specific operations comprise: receiving a first frame from an access point (AP), wherein a medium access control (MAC) header of the first frame includes a first indicator indicating that the first frame is transferred through the relay; transmitting a second frame to a station (STA) based on the received first frame; receiving a first response frame generated based on the first frame from the STA, wherein a MAC header of the first response frame includes a second indicator indicating that the first response frame is transferred through the relay; and transmitting a second response frame to the AP based on the first response frame.

In addition, the following may be commonly applied.

In accordance with an embodiment of the present disclosure, when the relay performs a relay operation configuration procedure with the AP and the STA before transmitting the first frame, and performs a relay operation based on the relay operation configuration procedure, the MAC header of the first frame may not include the first indicator, and the MAC header of the first response frame may not include the second indicator.

In accordance with an embodiment of the present disclosure, the first indicator indicating that the first frame is transferred through the relay may be a relay address in an address field included in the MAC header of the first frame, or a subfield or bit included in the MAC header of the first frame. The second indicator indicating that the first response frame is transferred through the relay may be a relay address in an address field included in the MAC header of the first response frame, or a subfield or bit included in the MAC header of the first response frame.

In accordance with an embodiment of the present disclosure, the transmitter address of the first frame is the address of the AP, the receiver address of the first frame is the address of the STA, and the relay receives the first frame and generates the second frame, wherein the payload of the second frame includes the first frame, and the MAC header of the second frame may include a third indicator indicating that the first frame is encapsulated.

In accordance with an embodiment of the present disclosure, the transmitter address of the first response frame is the address of the STA, the receiver address of the first response frame is the address of the AP, and the relay receives the first response frame and generates the second response frame, wherein the payload of the second response frame includes the first response frame, and the MAC header of the second response frame may include a fourth indicator indicating that the first response frame is encapsulated.

In accordance with an embodiment of the present disclosure, the relay may transmit the second frame after a preset period of time from the time of receiving the first frame.

In accordance with an embodiment of the present disclosure, upon receiving the first frame, the relay may transmit a response frame to the first frame to the AP after a preset period of time from the time of receiving the first frame, and the relay may perform a channel access operation after transmitting the response frame to the first frame and transmit the second frame within the allocated transmission opportunity (TXOP).

In accordance with an embodiment of the present disclosure, the relay may be a relay multi-link device (MLD) comprising a first relay associated with a first link and a second relay associated with a second link, wherein the relay MLD may receive the first frame from an AP MLD on the first link for the first relay, and the relay MLD may transmit the second frame to a STA MLD on the second link for the second relay.

In accordance with an embodiment of the present disclosure, when the relay MLD successfully decodes the first frame or the relay MLD detects transmission of the first frame on the first link for the first relay, the relay MLD may perform a channel access operation on the second link for the second relay and transmit the second frame within the allocated transmission opportunity (TXOP).

In accordance with an embodiment of the present disclosure, the TXOP allocated on the second link may be set to a duration equal to or longer than the sum of the time for the relay MLD to transmit one or more second frames, the time for receiving the first response frame from the STA MLD, the time for transmitting the second response frame to the AP MLD, and the inter-frame interval durations.

In accordance with an embodiment of the present disclosure, the transmitter address of the first frame received by the relay is the address of the AP, the receiver address of the first frame is the address of the relay, and the relay receives the first frame and generates the second frame, wherein the transmitter address of the second frame is the address of the AP, and the receiver address of the second frame may be the address of the STA.

In accordance with an embodiment of the present disclosure, the relay generates the second frame through the original frame of the AP included in the payload of the first frame, wherein the second frame is a frame in which the MAC header is modified from the original frame of the AP, and the MAC header of the second frame may include a fifth indicator indicating that the original frame of the AP is transferred through the relay.

In accordance with an embodiment of the present disclosure, the transmitter address of the first response frame received by the relay is the address of the STA, the receiver address of the first frame is the address of the relay, and the relay receives the first response frame and generates the second response frame, wherein the transmitter address of the second response frame is the address of the STA, and the receiver address of the second frame may be the address of the AP.

In accordance with an embodiment of the present disclosure, the relay generates the second response frame through the original response frame of the STA included in the payload of the first response frame, wherein the second response frame is a frame in which the MAC header is modified from the original response frame of the STA, and the MAC header of the second response frame may include a sixth indicator indicating that the original response frame of the STA is transferred through the relay.

In accordance with an embodiment of the present disclosure, the relay may receive the first frame, generate a second frame identical to the first frame based on bits obtained through decoding and error correction, and transmit the second frame to the STA, and the relay may receive the first response frame, generate a second response frame identical to the first response frame based on bits obtained through decoding and error correction, and transmit the second response frame to the AP.

In accordance with an embodiment of the present disclosure, without performing a relay operation negotiation procedure with the AP and the STA, the relay may receive the first frame, wait from the end of retransmission of the first frame until a preset period of time elapses, and generate a second frame identical to the first frame based on bits obtained through decoding and error correction of the first frame, and transmit the second frame to the STA.

According to the present disclosure, a method of performing tunneling relay communication in a wireless LAN may be provided.

According to the present disclosure, a method of generating a tunneled packet for a relay terminal performing a relay communication operation may be provided.

According to the present disclosure, a method in which a relay terminal performing a relay communication operation receives a frame from a wireless LAN terminal and transmits the frame to another wireless LAN terminal may be provided.

According to the present disclosure, a method of determining a relay terminal to which transmission is to be performed based on an artificial intelligence algorithm may be provided.

The effects obtainable from the present disclosure are not limited to the effects mentioned above, and other effects not mentioned will be clearly understood by those of ordinary skill in the art to which the present disclosure belongs from the description below.

### BRIEF DESCRIPTION OF THE DRAWINGS

FIG. 1 is a diagram illustrating a communication node in a wireless LAN system to which the present disclosure is applied.

FIG. 2 is a diagram illustrating a wireless LAN system to which the present disclosure is applied.

FIG. 3 is a diagram illustrating a machine learning unit to which the present disclosure is applied.

FIG. 4 is a flowchart illustrating a method of performing communication based on a machine learning unit to which the present disclosure is applied.

FIG. 5A through FIG. 5C are diagrams illustrating a method of performing a relay communication operation to which the present disclosure is applied.

FIG. 6A and FIG. 6B are diagrams illustrating a method of performing a relay communication operation to which the present disclosure is applied.

FIG. 7A and FIG. 7B are diagrams illustrating a method of performing a relay communication operation to which the present disclosure is applied.

FIG. 8A and FIG. 8B are diagrams illustrating a method of performing a relay communication operation to which the present disclosure is applied.

FIG. 9 is a flowchart illustrating a method of performing a relay communication operation to which the present disclosure is applied.

### DETAILED DESCRIPTION

The present disclosure is susceptible to various modifications and may have various embodiments, and specific embodiments will be illustrated in the drawings and described in detail. However, this is not intended to limit the present disclosure to specific embodiments, and it should be understood that the present disclosure includes all modifications, equivalents, and substitutes within the spirit and technical scope of the present disclosure.

Terms such as first, second, etc. may be used to describe various components, but the components should not be limited by the terms. The terms are used only for the purpose of distinguishing one component from another component. In an embodiment, a first component may be designated as a second component, and similarly, a second component may also be designated as a first component, without departing from the scope of the present disclosure. The term “and/or” includes any combination of a plurality of related listed items or any one of a plurality of related listed items.

When a component is referred to as being “connected” or “coupled” to another component, it should be understood that the component may be directly connected or coupled to the other component, but another component may also exist in between. On the other hand, when a component is referred to as being “directly connected” or “directly coupled” to another component, it should be understood that no other component exists in between.

The terms used in the present disclosure are used only to describe specific embodiments and are not intended to limit the present disclosure. Singular expressions include plural expressions unless the context clearly indicates otherwise. In the present disclosure, terms such as “comprise” or “have” are intended to designate the presence of features, numbers, steps, operations, components, parts, or combinations thereof described in the specification, and should be understood as not precluding the possibility of the presence or addition of one or more other features, numbers, steps, operations, components, parts, or combinations thereof.

Unless otherwise defined, all terms used herein, including technical or scientific terms, have the same meaning as commonly understood by those of ordinary skill in the art to which the present disclosure pertains. Terms defined in commonly used dictionaries should be interpreted as having meanings consistent with the meanings they have in the context of the relevant art, and unless explicitly defined in the present disclosure, should not be interpreted in an ideal or excessively formal sense.

Hereinafter, preferred embodiments of the present disclosure will be described in greater detail with reference to the accompanying drawings. In describing the present disclosure, the same reference numerals are used for the same components in the drawings to facilitate overall understanding, and duplicate descriptions of the same components are omitted.

In the following, a wireless communication system to which embodiments according to the present disclosure are applied will be described. The wireless communication system to which the embodiments according to the present disclosure are applied is not limited to the content described below, and the embodiments according to the present disclosure may be applied to various wireless communication systems. A wireless communication system may be referred to as a “wireless communication network.”

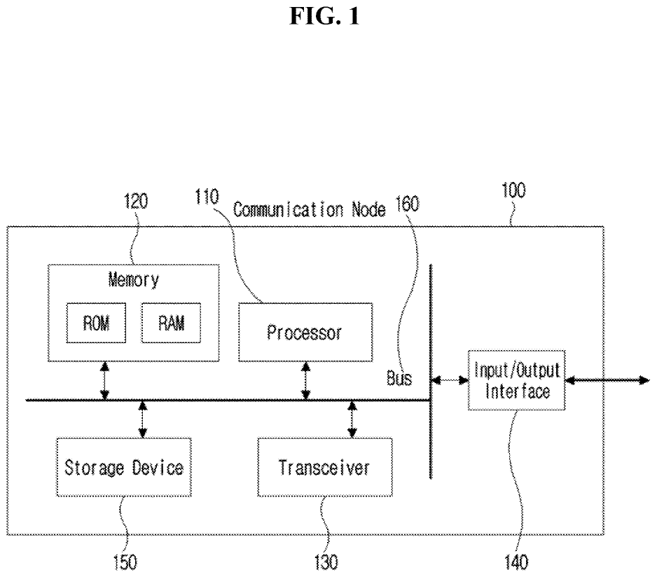

FIG. 1 is a diagram illustrating a communication node in a wireless LAN system to which the present disclosure is applied. Referring to FIG. 1, a communication node (100) may include at least one of a processor (110), a memory (120), a transceiver (130), an input/output interface (140), a storage device (150), and a bus (160). In an embodiment, the communication node (100) may be an access point (AP), a station (STA), an AP multi-link device (MLD), or a non-AP MLD. However, the communication node may not be limited thereto, and may be a node that communicates with other nodes or devices based on the aforementioned configuration. In an embodiment, an operating channel width supported by an AP may be 20 MHz (megahertz), 80 MHz, 160 MHz, or the like. An operating channel width supported by a station may be 20 MHz, 80 MHz, or the like. However, the present disclosure may not be limited thereto.

The processor (110) within the communication node (100) may control at least one of the memory (120), the transceiver (130), the input/output interface (140), and the storage device (150) as respective components within the communication node. The memory (120) within the communication node (100) may store information regarding instructions and directives executed by the processor (110), and the transceiver (130) may refer to a transceiver, a radio frequency (RF) unit, an RF module, or any other component that performs signal transmission and reception. The input/output interface (140) within the communication node (100) is an interface for input and output that may interoperate with other interfaces, and may further include a separate storage device (150). Each of the components within the communication node (100) may be connected via a bus (160) to communicate with one another.

However, in an embodiment, each of the components included in the communication node (100) may be connected not via a common bus (160), but via individual interfaces or individual buses centered around the processor (110). The processor (110) may be connected to at least one of the memory (120), the transceiver (130), the input/output interface (140), and the storage device (150) via a dedicated interface.

The processor (110) may execute program commands stored in at least one of the memory (120) or the storage device (150). The processor (110) may refer to a central processing unit (CPU), a graphics processing unit (GPU), or a dedicated processor on which methods according to embodiments of the present disclosure are performed. Each of the memory (120) and the storage device (150) may be configured as at least one of a volatile storage medium or a non-volatile storage medium. In an embodiment, the memory (120) may be configured as at least one of a read only memory (ROM) or a random access memory (RAM).

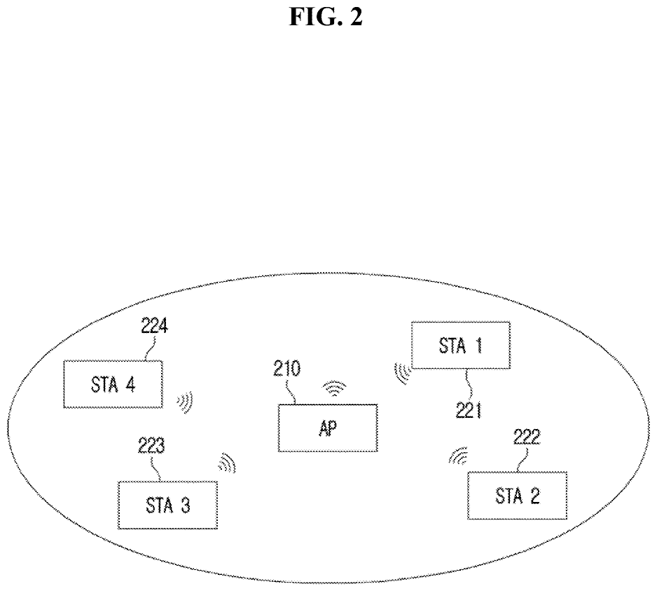

FIG. 2 is a diagram illustrating a wireless LAN system to which the present disclosure is applied. Referring to FIG. 2, a basic service set (BSS) of the wireless LAN system may include one AP (210) and a plurality of STAs (221, 222, 223, 224), and the plurality of STAs (221, 222, 223, 224) may be controlled by the AP (210). However, the wireless LAN system is not limited to a BSS, and an environment consisting only of STAs without a defined service set or AP may also be considered, and the wireless LAN system is not limited to any specific form. Each of the wireless devices within the wireless LAN system may include a medium access control (MAC) layer and a physical (PHY) layer, and communication between the wireless devices may be performed. In the following description, the AP and STA are primarily described for convenience of explanation, but the description may not be limited thereto. In an embodiment, the following may be equally applicable to other communication nodes or devices, and is not limited to any specific form.

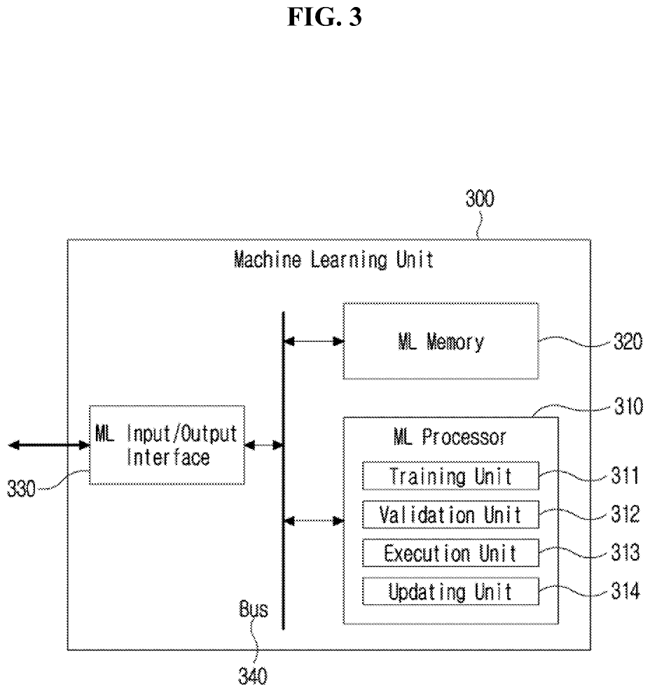

FIG. 3 is a diagram illustrating a machine learning unit to which the present disclosure is applied. Each of the wireless devices within the wireless LAN system may be connected to a machine learning unit (300). However, the present disclosure may not be limited thereto, and it may also be possible for a wireless device that is not connected to the machine learning unit (300) to operate.

In an embodiment, the processor (110) of the communication node (100) of FIG. 1 may be connected to the machine learning unit (300). The machine learning unit (300) may communicate with the processor (110) via the input/output interface (140) of the communication node (100). In another embodiment, the machine learning unit (300) may communicate with the processor (110) via the bus (160) of the communication node (100). In another embodiment, the machine learning unit (300) may be connected to and communicate with the processor (110) of the communication node (100) via an individual interface or a dedicated bus. The machine learning unit (300) may be connected to and communicate with the memory (120), the transceiver (130), and the storage device (150) via the input/output interface (140), the bus (160), or a dedicated bus of the communication node (100), but may not be limited to any specific form.

In an embodiment, the machine learning unit (300) may include at least one machine learning (ML) processor (310), an ML memory (320), an ML input/output interface (330), and ML buses (340). The ML processor (310), the ML memory (320), and the ML input/output interface (330) may be connected to and communicate with one another via the ML bus (340). In another embodiment, the ML processor (310) may be connected to and communicate with at least one of the ML memory (320) and the ML input/output interface (330) via a dedicated bus or interface. The ML processor (310) may be a central processing unit, a graphics processing unit, a dedicated processor on which methods according to embodiments of the present disclosure are performed, or a processor combining at least one of a central processing unit and a dedicated processor. The ML processor (310) may include at least one of a training unit (311), a validation unit (312), an execution unit (313), and an updating unit (313). The training unit (311), the validation unit (312), the execution unit (313), and the updating unit (313) may be logical entities implemented in software or hardware processing devices. In an embodiment, the ML processor (310) may perform at least one of training, validation, execution, and updating of a machine learning model. The machine learning model may be in the form of a plurality of matrices or vectors. As a specific embodiment, the machine learning model may include weights, transition matrices, and hyperparameters that implement and train single or multiple combined machine learning algorithms (In an embodiment, deep neural network (DNN), convolutional neural network (CNN), recurrent neural network (RNN), and deep reinforcement learning (DRL) algorithms). The machine learning model may include an input layer, at least one hidden layer, and an output layer to implement a DNN algorithm. Each of the input layer, the hidden layer, and the output layer may include at least one perceptron (In an embodiment, an artificial neuron). A perceptron includes an activation function, input weights, and a bias. A plurality of perceptrons may have their inputs and outputs connected to form the input layer, the hidden layer, and the output layer. The machine learning model may include a convolution algorithm and the DNN algorithm to implement a CNN algorithm. The convolution algorithm is an algorithm that applies a kernel matrix to input data in matrix form via convolution, and may be performed at least once on the input data. When the convolution algorithm is performed on the input data, the size of the data may increase through concatenation or decrease through pooling. Input data on which the convolution algorithm has been performed at least once is used as input data for the DNN algorithm. In an embodiment, the machine learning model may include a DNN algorithm and a cell structure to implement an RNN algorithm. The cell structure may be a structure that memorizes previous input data and feeds it back as input, and may be used in at least one perceptron of the DNN algorithm. The machine learning model may include an agent, an environment structure, and a DNN algorithm to implement a DRL algorithm. In the DRL algorithm, the agent may observe the environment and perform an optimal action based thereon. The environment may provide feedback to the agent in the form of a reward based on the action of the agent. Based on the foregoing, the agent may learn a policy for taking optimal actions. The agent may use a DNN algorithm to learn optimal actions.

In another embodiment, the machine learning unit (300) may be designed to additionally implement other machine learning algorithms beyond the aforementioned machine learning algorithms (In an embodiment, DNN, CNN, RNN, and DRL). To this end, the machine learning unit (300) may include additional components for implementing other machine learning algorithms. The ML memory (320) within the machine learning unit (300) may store machine learning models and machine learning algorithms. Implementation of a machine learning algorithm may be performed by the ML processor (310) based on the machine learning model.

In another embodiment, all or part of the functions of the machine learning unit (300) may be integrated into the processor (110) and the memory (120) of the communication node (100). That is, the processor (110) of the communication node (100) may perform some or all of the functions of the ML processor (310), and the memory (120) may perform all or some of the functions of the ML memory (320). When the processor (110) and the memory (120) of the communication node (100) perform all functions of the machine learning unit (300), the machine learning unit (300) may not be connected via the input/output interface (140), and the processor (110) and the memory (120) may operate as the machine learning unit (300).

In another embodiment, the machine learning unit (300) may not be connected via the input/output interface (140) of the communication node (100), but may be connected via the bus (160), or via a dedicated bus or interface centered around the processor (110) of the communication node (100), but the present disclosure may not be limited to such embodiments.

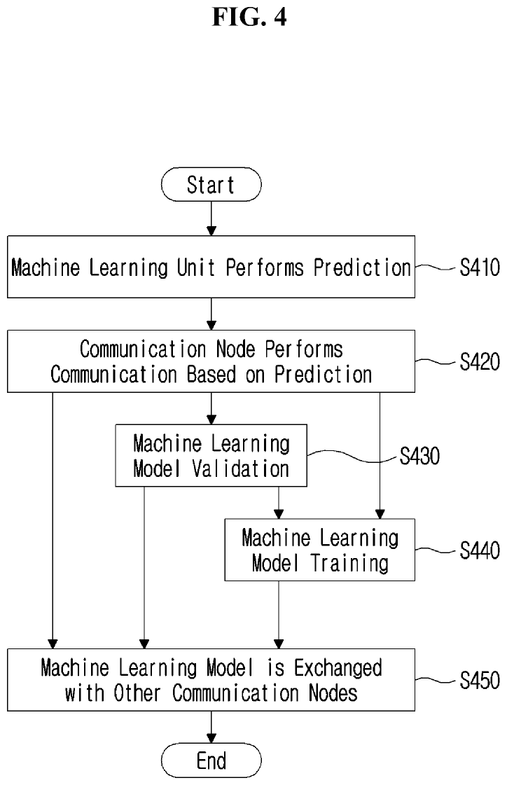

FIG. 4 is a flowchart illustrating a method of performing communication based on a machine learning unit to which the present disclosure is applied. Referring to FIG. 4, the machine learning unit (300) may be connected to the communication node (100) to collect communication data and perform prediction based on a machine learning model (S410). In an embodiment, the prediction may be performed by the execution unit (313) of the machine learning unit (300), but is not limited thereto. Here, the communication data collected by the machine learning unit (300) may include at least one of channel noise status, channel congestion, received signal strength, collision frequency, and other information obtained from the physical layer. In addition, the communication data may include information obtained from the MAC layer, and is not limited to any specific form. The communication data collected by the machine learning unit (300) may be provided as input to the machine learning model as-is. In another embodiment, the communication data collected by the machine learning unit (300) may be processed or pre-processed before being provided as input to the machine learning model. In an embodiment, the prediction result of the machine learning unit (300) may be at least one of physical layer and MAC parameters (In an embodiment, modulation and coding scheme (MCS) parameters, beamforming parameters, enhanced distributed channel access (EDCA) parameters, etc.). In another embodiment, the prediction result of the machine learning unit (300) may be information for packet scheduling, multi-AP operation scheduling, and other scheduling, but is not limited to any specific form. In another embodiment, the communication node (100) may receive all or part of a machine learning model from another communication node. All or part of the machine learning model may be collected by the machine learning unit (300), and is not limited to any specific form. In an embodiment, the communication node (100) may perform communication based on the prediction of the machine learning unit (300) (S420). In addition, the machine learning unit (300) may collect communication data based on the performed communication, and based thereon, machine learning model validation (S430) or machine learning model training (S440) may be performed. In addition, in an embodiment, the machine learning model may be exchanged with other communication nodes (S450), and the exchanged machine learning model information may be used for machine learning model validation or machine learning model training. In an embodiment, when machine learning model validation is performed, it may be verified whether the communication operation performed by the prediction of the machine learning unit (300) is appropriate. As a specific embodiment, machine learning model validation may be performed based on at least one of the frame collision frequency, transmission error frequency, and packet transmission delay of the communication node (100), and an operation of determining whether the communication performance of the communication node (100) has improved may be performed.

In addition, in an embodiment, when it is determined that training of the machine learning model is necessary (In an embodiment, when communication performance has not improved, or when the performance of the machine learning model of another communication node (In an embodiment, all or part of the machine learning model) is determined to be superior to the machine learning model of the current communication node (100)), the communication node (100) may perform machine learning model training. In another embodiment, the communication node (100) may exchange the machine learning model with other communication nodes without performing machine learning model validation or machine learning model training. In addition, in an embodiment, when it is determined that training of the machine learning model is not necessary, the communication node (100) may exchange the machine learning model with other communication nodes without performing machine learning model training.

Here, the training of the machine learning model may be performed based on at least one of the collected communication data and all or part of the machine learning model of another communication node. The training of the machine learning model may be performed by the training unit (311), and may be performed based on at least one of the collected communication data, the machine learning model of another communication node, and the output of the machine learning model of the communication node (100).

In another embodiment, all or part of the machine learning model of the communication node (1000) may be replaced with all or part of the machine learning model of another communication node by the updating unit (314) of the machine learning unit (300). In another embodiment, the machine learning model (In an embodiment, all or part of the machine learning model) of the communication node (100) may be shared with other communication nodes. Alternatively, it may also be possible for the communication node (100) to operate based solely on machine learning model validation and training without exchanging the machine learning model with other communication nodes, and the present disclosure is not limited to any specific form. In an embodiment, in the flowchart of the present disclosure, at least one of reordering of steps, addition or removal of steps, and repetition of specific steps may be performed. That is, the present flowchart is one embodiment illustrating the operation of the machine learning unit (300) of the wireless communication node (100), and the procedures and operations may be variously modified. In an embodiment, it may also be possible for the machine learning model validation step to be performed again after machine learning model training in order to validate the trained machine learning model, and the present disclosure may not be limited to any specific form.

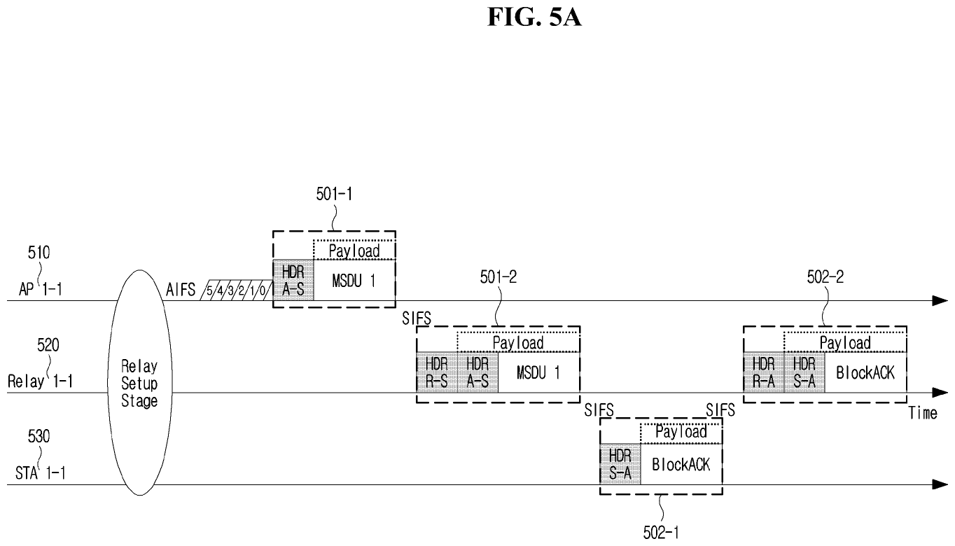

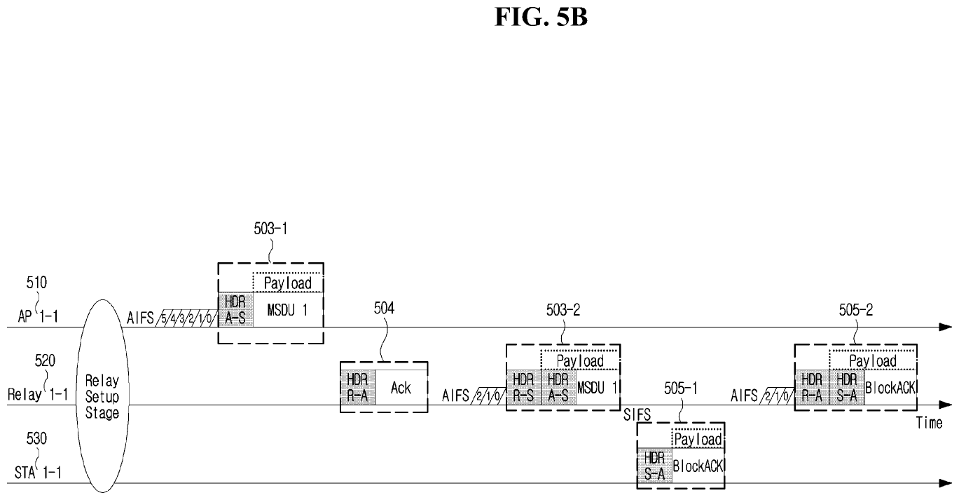

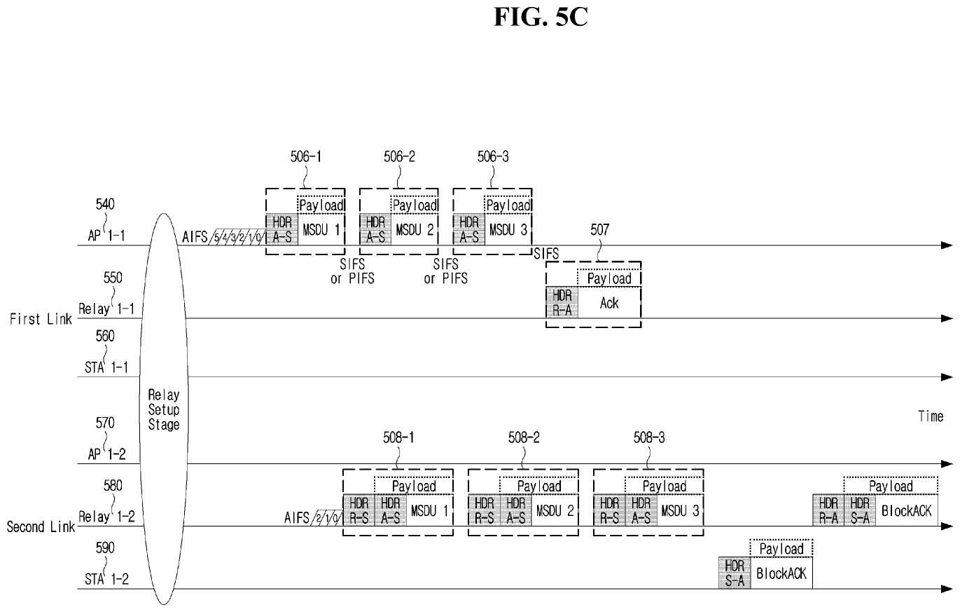

In the following description of FIG. 5A through FIG. 9, the case where a frame to be transmitted from an access point (AP) to a station (STA) is relayed through a relay is used as the reference. That is, the description is based on the case where transmission is performed from an AP to a STA, but this is for convenience of explanation only and is not limited to such an embodiment. In an embodiment, the following operations of the present disclosure may be equally applicable even when the entity and link direction differ. As a specific embodiment, the following disclosures may be equally applicable even in the case where a frame to be transmitted from a STA to an AP is relayed through a relay. In another embodiment, it may be apparent that the following disclosures are equally applicable in the case where a frame to be transmitted between APs as different entities is relayed through a relay, or in the case where a frame to be transmitted between STAs is relayed through a relay. Additionally, while the present disclosure is described based on the AP, the relay, and the STA, the present disclosure is not limited thereto, and each entity may be substituted with another entity. In one embodiment, the relay may be understood as an AP, and the described operations may pertain to a relationship among the AP, another AP, and the STA. As another embodiment, the relay may be understood as a STA, and the operations may pertain to a relationship among the AP, the STA, and another STA. Hereinafter, for convenience of description, operations are described based on the AP, the relay, and the STA. However, it is not limited thereto, and it will be apparent that the same may be equally applied to other entities having a relationship for forwarding or transferring data or frames. That is, the following may be operations for the convenience of explanation of relay communication to which the present disclosure is applied, and the present disclosure may not be limited to operating in such a manner.

FIG. 5A through FIG. 5C are diagrams illustrating a method of performing a relay communication operation to which the present disclosure is applied. Referring to FIG. 5A through FIG. 5C, wireless LAN terminals (In an embodiment, an access point (AP), a relay (Relay STA), and a station (STA)) may operate in a wireless LAN network. In an embodiment, the case where AP 1-1 (510), Relay 1-1 (520), and STA 1-1 (530) operate in a wireless LAN network may be considered in FIG. 5A and FIG. 5B, but this is for convenience of explanation only and may not be limited thereto. In addition, in FIG. 5C, the AP, relay, and STA may be multi-link devices (MLDs) supporting multi-link operation and may be referred to as an AP MLD, a relay MLD, and a STA MLD, respectively. An MLD may be a wireless LAN terminal that separately has a MAC layer (MLD lower MAC sublayer) and a PHY layer for each link (In an embodiment, a first link, a second link, etc.). Above the per-link MAC layer of the MLD, a MAC layer (MLD upper MAC sublayer) that integrates the per-link MAC layers may exist. Here, per-link APs or STAs may operate under the AP MLD, STA MLD, and relay MLD. In an embodiment, the AP of AP MLD 1 operating on the first link may be referred to as AP 1-1 of AP MLD 1, and the AP of AP MLD 1 operating on the second link may be referred to as AP 1-2 of AP MLD 1. In addition, the STA of STA MLD 1 operating on the first link may be referred to as STA 1-1 of STA MLD 1, and the STA of STA MLD 1 operating on the second link may be referred to as STA 1-2 of STA MLD 1. In addition, the relay of relay MLD 1 operating on the first link may be referred to as Relay 1-1 of relay MLD 1, and the relay of relay MLD 1 operating on the second link may be referred to as Relay 1-2 of relay MLD 1. The operations of the APs or STAs under the MLD may be operations of the MLD, and the operations of the MLD may be operations of the subordinate APs or STAs. FIG. 5C is merely an example for convenience of explanation and may not be limited to such operations.

Referring to FIG. 5A and FIG. 5B, AP 1-1 (510), Relay 1-1 (520), and STA 1-1 (530) may perform configuration for a relay communication operation in advance. That is, in FIG. 5A and FIG. 5B, AP 1-1 (510), Relay 1-1 (520), and STA 1-1 (530) may complete the configuration for a relay communication operation in advance. AP 1-1 (510), Relay 1-1 (520), and STA 1-1 (530) may be aware that a relay communication operation is to be performed through the aforementioned configuration.

In addition, referring to FIG. 5C, AP MLD 1, relay MLD 1, and STA MLD 1 may perform configuration for a relay communication operation in advance. That is, in FIG. 5C, AP MLD 1, relay MLD 1, and STA MLD 1 may complete the configuration for a relay communication operation in advance. AP MLD 1, relay MLD 1, and STA MLD 1 may be aware that a relay communication operation is to be performed through the aforementioned configuration. However, FIG. 5A through FIG. 5C are merely examples for convenience of explanation and are not limited to such embodiments, and may be equally applicable in other cases.

Referring to FIG. 5A, AP 1-1 (510) may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (530). The channel access operation may be an enhanced distributed channel access (EDCA) backoff operation and an EDCA transmission opportunity (TXOP) acquisition procedure. In the EDCA backoff operation, AP 1-1 (510) may decrement the backoff counter when the medium is detected as idle, and may transmit a frame at the slot boundary at which the backoff counter reaches 0. In another embodiment, AP 1-1 (510) may intend to transmit a frame to STA 1-1 (530) within an EDCA transmission opportunity (TXOP), which is a communication period during which a plurality of frames may be transmitted, having previously succeeded in the channel access operation. The duration of the MAC header corresponding to the TXOP established by AP 1-1 (510) may be set to a duration equal to or longer than the sum of the data frame transmission time from AP 1-1 (510) to Relay 1-1 (520), the encapsulated frame transmission time from Relay 1-1 (520) to STA 1-1 (530), the response frame (BlockAck) transmission time of STA 1-1 (530), the encapsulated response frame transmission time of Relay 1-1 (520), and the inter-frame interval (In an embodiment, SIFS duration) between each frame transmission.

The transmitter address of the MAC header included in the frame transmitted by AP 1-1 (510) may be set to the MAC address of AP 1-1 (510), and the receiver address may be set to the MAC address of STA 1-1 (530). The MAC header included in the frame transmitted by AP 1-1 (510) may include an indicator indicating that the frame is transmitted (In an embodiment, relayed) through Relay 1-1 (520). The indicator indicating that the frame is relayed through Relay 1-1 (520) may be the MAC address of the relay included in the address field of the MAC header (In an embodiment, the MAC address of Relay 1-1 (520) included in the Address 4 field). That is, when the MAC address of the relay is included in the address field of the MAC header, the frame may be indicated as being relayed through Relay 1-1 (520). Alternatively, the indicator indicating that the frame is relayed through Relay 1-1 (520) may be set as a separate subfield or bit (In an embodiment, an indicator included in the HT Control field), through which whether the frame is relayed through Relay 1-1 (520) may be indicated.

In another embodiment, since AP 1-1 (510), STA 1-1 (530), and Relay 1-1 (520) have configured the relay communication operation in advance, Relay 1-1 (520) may be aware that the frame transmitted by AP 1-1 (510) to STA 1-1 (530) is to be relayed. In consideration of the foregoing, the indicator indicating that the frame is to be relayed may be unnecessary, and the MAC header of the frame transmitted by AP 1-1 (510) may not include such an indicator.

Referring to FIG. 5A, the payload of the frame (501-1) transmitted by AP 1-1 (510) may be MSDU 1. Here, Relay 1-1 (520) may receive the frame (501-1) including MSDU 1 from AP 1-1 (510). Relay 1-1 (520) may add a MAC header, wherein the transmitter address is the MAC address of Relay 1-1 (520) and the receiver address is STA 1-1 (530), to the received frame (501-1). That is, the payload of the frame (501-2) generated by Relay 1-1 (520) may be the frame transmitted by AP 1-1 (510) (the entire frame including the MAC header, 501-1). In an embodiment, the operation in which Relay 1-1 (520) adds a MAC header to the frame (501-1) of AP 1-1 (510) is an encapsulation operation, and the frame to which Relay 1-1 (520) has added the MAC header may be referred to as an encapsulated frame (501-2), but may not be limited to such a designation.

Relay 1-1 (520) may transmit the encapsulated frame (501-2) to STA 1-1 (530) after a short interframe space (SIFS) duration from the completion of reception of the frame (501-1) transmitted by AP 1-1 (510). Since Relay 1-1 (520) transmits the encapsulated frame (501-2) after a SIFS duration, AP 1-1 (510) may regard the encapsulated frame (501-2) of Relay 1-1 (520) as an immediate response frame.

In an embodiment, Relay 1-1 (520) may not be able to transmit frames due to the network allocation vector (NAV) corresponding to the TXOP obtained by AP 1-1 (510). However, Relay 1-1 (520) may regard the encapsulated frame (501-2) as an immediate response frame to the frame (501-1) of AP 1-1 (510). Accordingly, Relay 1-1 (520) may transmit the encapsulated frame (501-2) to STA 1-1 (530) regardless of the NAV setting. Alternatively, Relay 1-1 (520) may not set the NAV upon receiving a frame wherein the receiver address is STA 1-1 (530). Here, AP 1-1 (510) may not update the BlockAck scoreboard of AP 1-1 (510) until it receives the response frame (In an embodiment, a BlockAck frame) from STA 1-1 (530). That is, AP 1-1 (510) does not determine that the receiver of the frame has received the frame.

In addition, in an embodiment, the MAC header added by Relay 1-1 (520) may include an indicator indicating that the frame is encapsulated. As a specific embodiment, the address 4 field of the MAC header added by Relay 1-1 (520) may include the MAC address of AP 1-1 (510) to indicate that the frame is encapsulated. Alternatively, the indicator indicating that the frame is encapsulated may be set as a separate subfield or bit (In an embodiment, an indicator included in the HT Control field) to indicate that the frame is encapsulated. In another embodiment, since AP 1-1 (510), STA 1-1 (530), and Relay 1-1 (520) have configured the relay communication operation in advance, STA 1-1 (530) may be aware that the frame transmitted by Relay 1-1 (520) to STA 1-1 (530) is encapsulated, and therefore a separate indicator may be unnecessary.

STA 1-1 (530) may receive the encapsulated frame (501-2) from Relay 1-1 (520). STA 1-1 (530) may recognize that the frame of Relay 1-1 (520) is encapsulated based on the indicator indicating that the frame is encapsulated or the configured relay communication operation. STA 1-1 (530) may receive the encapsulated frame (501-2) from Relay 1-1 (520) and decapsulate the encapsulated frame (501-2). STA 1-1 (530) may confirm (In an embodiment, receive, decode, and verify errors in) the frame (501-1) of AP 1-1 (510), which is the payload of the encapsulated frame (501-2), through decapsulation and receive (decode) MSDU 1. STA 1-1 (530) may transmit a response frame (502-1) to AP 1-1 (510) after a SIFS duration from the completion of reception of the encapsulated frame (501-2) of Relay 1-1 (520). The response frame (502-1) may be a BlockAck (BA) frame indicating the reception status of the frame transmitted by AP 1-1 (510). STA 1-1 (530) may set the transmitter address of the MAC header of the response frame (502-1) to the MAC address of STA 1-1 (530) and set the receiver address to the MAC address of AP 1-1 (510). The MAC header included in the response frame (502-1) transmitted by STA 1-1 (530) may include an indicator indicating that the frame is transmitted (In an embodiment, relayed) through Relay 1-1 (520). In an embodiment, the indicator indicating that the frame is relayed through Relay 1-1 (520) may be the MAC address of the relay included in the address field of the MAC header (In an embodiment, the MAC address of Relay 1-1 (520) included in the Address 4 field). That is, when the MAC address of the relay is included in the address field of the MAC header, the frame may be indicated as being relayed through Relay 1-1 (520). Alternatively, the indicator indicating that the frame is relayed through Relay 1-1 (520) may be set as a separate subfield or bit (In an embodiment, an indicator included in the HT Control field) to indicate whether the frame is to be relayed. In another embodiment, since AP 1-1 (510), STA 1-1 (530), and Relay 1-1 (520) have configured the relay communication operation in advance, Relay 1-1 (520) may be aware that the frame transmitted by STA 1-1 (530) to AP 1-1 (510) is to be relayed. In consideration of the foregoing, the indicator indicating that the frame is to be relayed may be unnecessary. Accordingly, the MAC header of the frame transmitted by STA 1-1 (530) may not include an indicator indicating that the frame is to be relayed.

Relay 1-1 (520) may receive a frame (response frame, BlockAck frame, 502-1) from STA 1-1 (530). Relay 1-1 (520) may add a MAC header, wherein the transmitter address is the MAC address of Relay 1-1 (520) and the receiver address is AP 1-1 (510), to the received frame (502-1). The payload of the frame (502-2) generated by Relay 1-1 (520) may be the response frame transmitted by STA 1-1 (530) (the entire frame including the MAC header, 502-1). That is, Relay 1-1 (520) may perform an encapsulation operation to encapsulate the response frame (502-1) of STA 1-1 (530). Relay 1-1 (520) may transmit the encapsulated response frame (502-2) to AP 1-1 (510) after a SIFS duration from the completion of reception of the frame (502-1) from STA 1-1 (530). The MAC header added by Relay 1-1 (520) may include an indicator indicating that the frame is encapsulated. In an embodiment, the address 4 field of the MAC header added by Relay 1-1 (520) may include the MAC address of STA 1-1 (530) to indicate that the frame is encapsulated. Alternatively, the indicator indicating that the frame is encapsulated may be set as a separate subfield or bit (In an embodiment, an indicator included in the HT Control field) to indicate encapsulation. In another embodiment, since AP 1-1 (510), STA 1-1 (530), and Relay 1-1 (520) have configured the relay communication operation in advance, AP 1-1 (510) may be aware that the frame transmitted by Relay 1-1 (520) to AP 1-1 (510) is encapsulated, and therefore a separate indicator may be unnecessary.

AP 1-1 (510) may receive the encapsulated frame (502-2) from Relay 1-1 (520). AP 1-1 (510) may recognize that the frame of Relay 1-1 (520) is encapsulated based on the indicator indicating that the frame is encapsulated or the configured relay communication operation. AP 1-1 (510) may decapsulate the encapsulated frame (502-2). AP 1-1 (510) may receive the frame (response frame, BlockAck frame) of STA 1-1 (530), which is the payload of the encapsulated frame (502-2), and AP 1-1 (510) may verify the reception status of the frame transmitted by AP 1-1 (510) to STA 1-1 (530). AP 1-1 (510) may update the BlockAck scoreboard based on the response frame (In an embodiment, BlockAck frame) from STA 1-1 (530), and may retransmit a frame if a frame whose transmission has failed exists.

In an embodiment, an error may exist in the frame received by Relay 1-1 (520) from AP 1-1 (510). When Relay 1-1 (520) receives a frame containing an error, Relay 1-1 (520) may not encapsulate the frame containing the error. Relay 1-1 (520) may not respond to AP 1-1 (510) or may transmit a frame requesting retransmission of the frame from AP 1-1 (510) (In an embodiment, an ACK frame indicating NACK, or a BlockAck frame). In this case, Relay 1-1 (520) may receive the retransmission of the erroneous frame from AP 1-1 (510) and transmit the frame to STA 1-1 (530) after receiving it without error, or may discard the erroneous frame if the retransmission of the erroneous frame is not received.

In another embodiment, STA 1-1 (530) may be able to receive (decode) the frame transmitted by AP 1-1 (510). However, when STA 1-1 (530), AP 1-1 (510), and Relay 1-1 (520) have performed relay communication operation configuration, STA 1-1 (530) may not directly respond to AP 1-1 (510) even when it receives the frame from AP 1-1 (510).

In another embodiment, instead of transmitting the encapsulated frame to STA 1-1 (530) after a SIFS duration from the completion of reception of the data frame from AP 1-1 (510), Relay 1-1 (520) may transmit the encapsulated frame to STA 1-1 (530) when the medium is in an idle state for a priority interframe space (PIFS) duration. Alternatively, Relay 1-1 (520) may transmit the encapsulated frame to STA 1-1 (530) when the medium is in an idle state for a PIFS duration+ ‘a’ from the completion of reception of the data frame from AP 1-1 (510). The aforementioned operation is to verify whether the frame transmitted by AP 1-1 (510) to STA 1-1 (530) is retransmitted. When a PIFS duration+ ‘a’ has elapsed from the completion of reception of the frame, Relay 1-1 (520) may consider that AP 1-1 (510) is not retransmitting the frame and is waiting for Relay 1-1 (520) to relay the frame. Here, the ‘a’ duration may be aSlotTime, or may be shorter or longer than aSlotTime, and may not be limited to any specific form.

In another embodiment, when AP 1-1 (510) performs transmission to STA 1-1 (530) through Relay 1-1 (520), AP 1-1 (510) may not perform a PIFS recovery operation. That is, even when AP 1-1 (510) transmits a frame and no response frame is received until after a PIFS duration, AP 1-1 (510) may not perform frame retransmission. The aforementioned operations may be operations for preventing transmission collisions with the encapsulated frame transmitted by Relay 1-1 (520) to STA 1-1 (530).

In another embodiment, the case where STA 1-1 (530) is able to receive (decode) the frame from AP 1-1 (510) may be considered. When STA 1-1 (530), AP 1-1 (510), and Relay 1-1 (520) have performed relay communication operation configuration, STA 1-1 (530) may store the received frame in a buffer upon receiving the frame from AP 1-1 (510) and may not directly respond to AP 1-1 (510). Here, STA 1-1 (530) may additionally receive a data frame transmitted through Relay 1-1 (520). STA 1-1 (530) may reconstruct the data frame using the data frame received from AP 1-1 (510) and the data frame received from Relay 1-1 (520). In an embodiment, when the received data frame is an A-MPDU, the erroneous MPDUs of the A-MPDU received from AP 1-1 (510) and the A-MPDU received from Relay 1-1 (520) may differ. STA 1-1 (530) may recover the data frame through the error-free MPDUs, and may generate a response frame (BlockAck) based on the recovered data frame and transmit it to AP 1-1 (510) through Relay 1-1 (520).

Referring to FIG. 5B, AP 1-1 (510) may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (530). The channel access operation may be an enhanced distributed channel access (EDCA) backoff operation and an EDCA transmission opportunity (TXOP) acquisition procedure. In the EDCA backoff operation, AP 1-1 (510) may decrement the backoff counter when the medium is detected as idle, and may transmit a frame at the slot boundary at which the backoff counter reaches 0. In another embodiment, AP 1-1 (510) may intend to transmit a frame to STA 1-1 (530) within an EDCA transmission opportunity (TXOP), which is a communication period during which a plurality of frames may be transmitted, having previously succeeded in the channel access operation. The duration of the MAC header corresponding to the TXOP established by AP 1-1 (510) may be set to a duration equal to or longer than the sum of the data frame transmission time from AP 1-1 (510) to Relay 1-1 (520), the response frame (BlockAck, ACK) transmission time of Relay 1-1 (520), and the inter-frame interval (In an embodiment, SIFS duration) between each frame transmission.

The transmitter address of the MAC header included in the frame (503-1) transmitted by AP 1-1 (510) may be set to the MAC address of AP 1-1 (510), and the receiver address may be set to the MAC address of STA 1-1 (530). The MAC header included in the frame (503-1) transmitted by AP 1-1 (510) may include an indicator indicating that the frame is transmitted (In an embodiment, relayed) through Relay 1-1 (520). The indicator indicating that the frame is relayed through Relay 1-1 (520) may be the MAC address of the relay included in the address field of the MAC header (In an embodiment, the MAC address of Relay 1-1 (520) included in the Address 4 field). That is, when the MAC address of the relay is included in the address field of the MAC header, the frame may be indicated as being relayed through Relay 1-1 (520). Alternatively, the indicator indicating that the frame is relayed through Relay 1-1 (520) may be set as a separate subfield or bit (In an embodiment, an indicator included in the HT Control field), through which whether the frame is relayed through Relay 1-1 (520) may be indicated.

In another embodiment, since AP 1-1 (510), STA 1-1 (530), and Relay 1-1 (520) have configured the relay communication operation in advance, Relay 1-1 (520) may be aware that the frame transmitted by AP 1-1 (510) to STA 1-1 (530) is to be relayed. In consideration of the foregoing, the indicator indicating that the frame is to be relayed may be unnecessary, and the MAC header of the frame transmitted by AP 1-1 (510) may not include such an indicator.

Referring to FIG. 5B, the payload of the frame (503-1) transmitted by AP 1-1 (510) may be MSDU 1. Here, Relay 1-1 (520) may receive the frame (503-1) including MSDU 1 from AP 1-1 (510). Relay 1-1 (520) may add a MAC header, wherein the transmitter address is the MAC address of Relay 1-1 (520) and the receiver address is STA 1-1 (530), to the received frame (503-1). That is, the payload of the frame (503-2) generated by Relay 1-1 (520) may be the frame transmitted by AP 1-1 (510) (the entire frame including the MAC header, 503-1). In an embodiment, the operation in which Relay 1-1 (520) adds a MAC header to the frame (503-1) of AP 1-1 (510) is an encapsulation operation, and the frame to which Relay 1-1 (520) has added the MAC header may be referred to as an encapsulated frame (503-2), but may not be limited to such a designation.

Relay 1-1 (520) may transmit an acknowledgement (ACK) frame (504) to AP 1-1 (510) after a short interframe space (SIFS) duration from the completion of reception of the frame (503-1) transmitted by AP 1-1 (510). Since Relay 1-1 (520) transmits the ACK frame (504) after a SIFS duration, AP 1-1 (510) may regard the ACK frame (504) of Relay 1-1 (520) as an immediate response frame. In an embodiment, Relay 1-1 (520) may not be able to transmit frames due to the NAV corresponding to the TXOP obtained by AP 1-1 (510). However, Relay 1-1 (520) may regard the ACK frame (504) as an immediate response frame to the frame of AP 1-1 (510). Accordingly, Relay 1-1 (520) may transmit the ACK frame (504) to AP 1-1 (510) regardless of the NAV setting. Alternatively, Relay 1-1 (520) may not set the NAV upon receiving a frame wherein the receiver address is STA 1-1 (530). Here, AP 1-1 (510) may not update the BlockAck scoreboard of AP 1-1 (510) until it receives the response frame (In an embodiment, a BlockAck frame) from STA 1-1 (530). That is, AP 1-1 (510) does not determine that the receiver of the frame has received the frame.

Relay 1-1 (520) may transmit the encapsulated frame (503-2) to STA 1-1 (530) based on a separate transmission opportunity (TXOP). The transmission of the frame by Relay 1-1 (520) based on a separate TXOP may be the transmission of the frame within a TXOP obtained through a new channel access operation performed by Relay 1-1 (520). The TXOP may be a communication period during which transmission of a plurality of frames is possible. Since Relay 1-1 (520) transmits the encapsulated frame (503-2) within a separate TXOP, Relay 1-1 (520) may perform a channel access operation (In an embodiment, an EDCA backoff operation). Relay 1-1 (520) may transmit the encapsulated frame (503-2) when it has successfully completed the channel access operation and occupied the channel.

In addition, in an embodiment, the MAC header added by Relay 1-1 (520) may include an indicator indicating that the frame is encapsulated. As a specific embodiment, the address 4 field of the MAC header added by Relay 1-1 (520) may include the MAC address of AP 1-1 (510) to indicate that the frame is encapsulated. Alternatively, the indicator indicating that the frame is encapsulated may be set as a separate subfield or bit (In an embodiment, an indicator included in the HT Control field) to indicate that the frame is encapsulated. In another embodiment, since AP 1-1 (510), STA 1-1 (530), and Relay 1-1 (520) have configured the relay communication operation in advance, STA 1-1 (530) may be aware that the frame transmitted by Relay 1-1 (520) to STA 1-1 (530) is encapsulated, and therefore a separate indicator may be unnecessary.

STA 1-1 (530) may receive the encapsulated frame (503-2) from Relay 1-1 (520). STA 1-1 (530) may recognize that the frame of Relay 1-1 (520) is encapsulated based on the indicator indicating that the frame is encapsulated or the configured relay communication operation. STA 1-1 (530) may receive the encapsulated frame (503-2) from Relay 1-1 (520) and decapsulate the encapsulated frame (503-2). STA 1-1 (530) may confirm (In an embodiment, receive, decode, and verify errors in) the frame (503-1) of AP 1-1 (510), which is the payload of the encapsulated frame (503-2), through decapsulation and receive (decode) MSDU 1. STA 1-1 (530) may transmit a response frame (505-1) to AP 1-1 (510) after a SIFS duration from the completion of reception of the encapsulated frame (503-2) of Relay 1-1 (520). The response frame (505-1) may be a BlockAck (BA) frame indicating the reception status of the frame transmitted by AP 1-1 (510). STA 1-1 (530) may set the transmitter address of the MAC header of the response frame (505-1) to the MAC address of STA 1-1 (530) and set the receiver address to the MAC address of AP 1-1 (510). The MAC header included in the response frame (505-1) transmitted by STA 1-1 (530) may include an indicator indicating that the frame is transmitted (In an embodiment, relayed) through Relay 1-1 (520). In an embodiment, the indicator indicating that the frame is relayed through Relay 1-1 (520) may be the MAC address of the relay included in the address field of the MAC header (In an embodiment, the MAC address of Relay 1-1 (520) included in the Address 4 field). That is, when the MAC address of the relay is included in the address field of the MAC header, the frame may be indicated as being relayed through Relay 1-1 (520). Alternatively, the indicator indicating that the frame is relayed through Relay 1-1 (520) may be set as a separate subfield or bit (In an embodiment, an indicator included in the HT Control field) to indicate whether the frame is to be relayed.

In another embodiment, since AP 1-1 (510), STA 1-1 (530), and Relay 1-1 (520) have configured the relay communication operation in advance, Relay 1-1 (520) may be aware that the frame transmitted by STA 1-1 (530) to AP 1-1 (510) is to be relayed. In consideration of the foregoing, the indicator indicating that the frame is to be relayed may be unnecessary. Accordingly, the MAC header of the frame transmitted by STA 1-1 (530) may not include an indicator indicating that the frame is to be relayed.

Relay 1-1 (520) may receive a frame (response frame, BlockAck frame, 505-1) from STA 1-1 (530). Relay 1-1 (520) may add a MAC header, wherein the transmitter address is the MAC address of Relay 1-1 (520) and the receiver address is AP 1-1 (510), to the received frame (505-1). The payload of the frame (505-2) generated by Relay 1-1 (520) may be the response frame transmitted by STA 1-1 (530) (the entire frame including the MAC header, 505-1). That is, Relay 1-1 (520) may perform an encapsulation operation to encapsulate the response frame of STA 1-1 (530).

After completing reception of the frame from STA 1-1 (530), Relay 1-1 (520) may transmit the frame within a separate TXOP. The transmission of the frame by Relay 1-1 (520) within a separate TXOP may be the transmission of the frame within a TXOP obtained through a new channel access operation performed by Relay 1-1 (520). When Relay 1-1 (520) has successfully completed the channel access operation (In an embodiment, an EDCA backoff operation) and occupied the channel, Relay 1-1 (520) may transmit the encapsulated response frame (505-2) to AP 1-1 (510). The MAC header added by Relay 1-1 (520) may include an indicator indicating that the frame is encapsulated (or relayed). In an embodiment, the address 4 field of the MAC header added by Relay 1-1 (520) may include the MAC address of STA 1-1 (530) to indicate that the frame is encapsulated. Alternatively, the indicator indicating that the frame is encapsulated may be set as a separate subfield or bit (In an embodiment, an indicator included in the HT Control field) to indicate encapsulation. In another embodiment, since AP 1-1 (510), STA 1-1 (530), and Relay 1-1 (520) have configured the relay communication operation in advance, AP 1-1 (510) may be aware that the frame transmitted by Relay 1-1 (520) to AP 1-1 (510) is encapsulated, and therefore a separate indicator may be unnecessary.

AP 1-1 (510) may receive the encapsulated frame (505-2) from Relay 1-1 (520). AP 1-1 (510) may recognize that the frame of Relay 1-1 (520) is encapsulated based on the indicator indicating that the frame is encapsulated or the configured relay communication operation. AP 1-1 (510) may decapsulate the encapsulated frame (505-2). AP 1-1 (510) may receive the frame (response frame, BlockAck frame, 505-1) of STA 1-1 (530), which is the payload of the encapsulated frame (505-2), and AP 1-1 (510) may verify the reception status of the frame transmitted by AP 1-1 (510) to STA 1-1 (530). AP 1-1 (510) may update the BlockAck scoreboard based on the response frame (In an embodiment, BlockAck frame) from STA 1-1 (530), and may retransmit a frame if a frame whose transmission has failed exists.

In an embodiment, an error may exist in the frame received by Relay 1-1 (520) from AP 1-1 (510). When Relay 1-1 (520) receives a frame containing an error, Relay 1-1 (520) may not encapsulate the frame containing the error. In an embodiment, Relay 1-1 (520) may not respond to AP 1-1 (510) or may transmit a frame requesting retransmission of the frame from AP 1-1 (510) (In an embodiment, an ACK frame indicating NACK, or a BlockAck frame). In this case, Relay 1-1 (520) may receive the retransmission of the erroneous frame from AP 1-1 (510) and transmit the frame to STA 1-1 (530) after receiving it without error, or may discard the erroneous frame if the retransmission of the erroneous frame is not received.

In another embodiment, STA 1-1 (530) may be able to receive (decode) the frame transmitted by AP 1-1 (510). When STA 1-1 (530), AP 1-1 (510), and Relay 1-1 (520) have performed relay communication operation configuration, STA 1-1 (530) may not directly respond to AP 1-1 (510) even when it receives the frame from AP 1-1 (510).

In another embodiment, Relay 1-1 (520) may detect a response frame transmitted by STA 1-1 (530) to AP 1-1 (510) while performing a channel access operation after completion of reception of the data frame from AP 1-1 (510). Here, Relay 1-1 (520) may perform any one of the operations listed in Table 1 below.

TABLE 1

Transmitting the encapsulated frame to STA 1-1
Not transmitting the encapsulated frame to STA 1-1

More specifically, Relay 1-1 (520) may transmit the encapsulated frame to STA 1-1 (530). That is, the frame destined for STA 1-1 (530) may be duplicated. Here, when the frame delivered to STA 1-1 (530) is duplicated, communication reliability may be improved. In another embodiment, Relay 1-1 (520) may not transmit the encapsulated frame to STA 1-1 (530). That is, Relay 1-1 (520) may avoid wasting unnecessary communication resources by not performing the encapsulated frame transmission.

In another embodiment, when AP 1-1 (510) performs transmission to STA 1-1 (530) through Relay 1-1 (520), AP 1-1 (510) may not perform a PIFS recovery operation. That is, even when AP 1-1 (510) transmits a frame and no response frame is received until after a PIFS duration, AP 1-1 (510) may not perform frame retransmission. The aforementioned operations may be operations for preventing transmission collisions with the encapsulated frame transmitted by Relay 1-1 (520) to STA 1-1 (530).

In another embodiment, the case where STA 1-1 (530) is able to receive (decode) the frame from AP 1-1 (510) may be considered. When STA 1-1 (530), AP 1-1 (510), and Relay 1-1 (520) have performed relay communication operation configuration, STA 1-1 (530) may store the received frame in a buffer upon receiving the frame from AP 1-1 (510) and may not directly respond to AP 1-1 (510). Here, STA 1-1 (530) may additionally receive a data frame transmitted through Relay 1-1 (520). STA 1-1 (530) may reconstruct the data frame using the data frame received from AP 1-1 (510) and the data frame received from Relay 1-1 (520). In an embodiment, when the received data frame is an A-MPDU, the erroneous MPDUs of the A-MPDU received from AP 1-1 (510) and the A-MPDU received from Relay 1-1 (520) may differ. STA 1-1 (530) may recover the data frame through the error-free MPDUs, and may generate a response frame (BlockAck) based on the recovered data frame and transmit it to AP 1-1 (510) through Relay 1-1 (520).

Referring to FIG. 5C, AP 1-1 (540) of AP MLD 1 operating on the first link may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (560) of STA MLD 1. The channel access operation may be an enhanced distributed channel access (EDCA) backoff operation and an EDCA transmission opportunity (TXOP) acquisition procedure. In the EDCA backoff operation, AP 1-1 (540) of AP MLD 1 may decrement the backoff counter when the medium is detected as idle, and may transmit a frame at the slot boundary at which the backoff counter reaches 0. In another embodiment, AP 1-1 (540) of AP MLD 1 may intend to transmit a frame to STA 1-1 (560) of the STA MLD within an EDCA transmission opportunity (TXOP), which is a communication period during which a plurality of frames may be transmitted, having previously succeeded in the channel access operation. The duration of the MAC header corresponding to the TXOP established by AP 1-1 (540) of AP MLD 1 may be set to a duration equal to or longer than the sum of the transmission time of one or more data frames transmitted from AP 1-1 (540) of AP MLD 1 to Relay 1-1 (550) of relay MLD 1, the response frame (BlockAck) transmission time of Relay 1-1 (550) of relay MLD 1, and the inter-frame interval (In an embodiment, SIFS duration) between each frame transmission.

The transmitter address of the MAC header included in the frame transmitted by AP 1-1 (540) of AP MLD 1 may be set to the MAC address of AP 1-1 (540) of AP MLD 1, and the receiver address may be set to the MAC address of STA 1-1 (560) of STA MLD 1. The MAC header included in the frame transmitted by AP 1-1 (540) of AP MLD 1 may include an indicator indicating that the frame is transmitted (In an embodiment, relayed) through relay MLD 1. The indicator indicating that the frame is relayed through relay MLD 1 may be the MAC address of the relay included in the address field of the MAC header (In an embodiment, the MAC address of at least one of relay MLD 1, Relay 1-1 of relay MLD 1, and Relay 1-2 of relay MLD 1 included in the Address 4 field). That is, when the MAC address of relay MLD 1 is included in the address field of the MAC header, the frame may be indicated as being relayed through relay MLD 1. Alternatively, the indicator indicating that the frame is relayed through relay MLD 1 may be set as a separate subfield or bit (In an embodiment, an indicator included in the HT Control field) to indicate whether the frame is relayed through relay MLD 1.

In another embodiment, since AP MLD 1, STA MLD 1, and relay MLD 1 have configured the relay communication operation in advance, Relay 1-1 (550) of relay MLD 1 may be aware that the frame transmitted by AP 1-1 (540) of AP MLD 1 to STA 1-1 (560) of STA MLD 1 is to be relayed. In consideration of the foregoing, the indicator indicating that the frame is to be relayed may be unnecessary, and the MAC header of the frame transmitted by AP 1-1 (540) of AP MLD 1 may not include such an indicator.

Referring to FIG. 5C, the payload of the frame transmitted by AP 1-1 (540) of AP MLD 1 may be MSDU 1. Here, Relay 1-1 (550) of relay MLD 1 may receive the frame including MSDU 1 from AP 1-1 (540) of AP MLD 1. Relay MLD 1 may intend to transmit the received frame to STA MLD 1 on the second link. That is, relay MLD 1 may intend to transmit the frame received on the first link to STA 1-2 (590) of STA MLD 1 through Relay 1-2 (580) of relay MLD 1 on the second link.

In another embodiment, the case where the first link is in a busy state after relay MLD 1 receives the frame transmitted from AP MLD 1 to STA MLD 1 on the first link may be considered. Among the first link and second link available to relay MLD 1, relay MLD 1 may be aware that the second link is in an idle state, or that the busy state of the second link ends sooner than that of the first link. Accordingly, relay MLD 1 may not be able to transmit the encapsulated frame from Relay 1-1 (550) of relay MLD 1 to STA 1-1 (560) of STA MLD lon the first link. In the aforementioned situation, relay MLD 1 may intend to transmit the encapsulated frame to STA 1-2 (590) of STA MLD 1 through Relay 1-2 (580) of relay MLD 1 on the second link, but may not be limited to such an embodiment.

When relay MLD 1 successfully decodes MSDU 1, Relay 1-2 (580) of relay MLD 1 may immediately perform a channel access operation (EDCA backoff operation, EDCA TXOP acquisition procedure) on the second link. When the channel access operation of Relay 1-2 (580) of relay MLD 1 is successful, an EDCA TXOP, which is a communication period on the second link, may be obtained. Alternatively, when relay MLD 1 detects a frame being transmitted on the first link, Relay 1-2 (580) of relay MLD 1 may immediately perform a channel access operation. Relay 1-2 (580) of relay MLD 1 may wait without transmitting a frame until the decoding of MSDU 1 is successfully completed. The duration of the MAC header corresponding to the TXOP established by Relay 1-2 (580) of relay MLD 1 may be set to a duration equal to or longer than the sum of the transmission time of one or more encapsulated data frames transmitted from Relay 1-2 (580) of relay MLD 1 to STA 1-2 (590) of STA MLD 1, the response frame (BlockAck) transmission time of STA 1-2 (590) of STA MLD 1, the transmission time of the response frame of STA 1-2 (590) of STA MLD 1 encapsulated by Relay 1-2 (580) of relay MLD 1, and the inter-frame interval (In an embodiment, SIFS duration) between each frame transmission. The EDCA TXOP of Relay 1-2 (580) of relay MLD 1 may be used by Relay 1-2 (580) of relay MLD 1 to transmit the frame of AP MLD 1 to STA MLD 1. Relay 1-2 (580) of relay MLD 1 may add a MAC header, wherein the transmitter address is the MAC address of Relay 1-2 of relay MLD 1 and the receiver address is STA 1-2 of STA MLD 1, to the frame received from AP 1-1 (540) of AP MLD 1. The payload of the frame generated by Relay 1-2 (580) of relay MLD 1 may be the frame transmitted by AP 1-1 (540) of AP MLD 1 (the entire frame including the MAC header). The operation in which Relay 1-2 (580) of relay MLD 1 adds a MAC header to the frame of AP 1-1 (540) of AP MLD 1 is an encapsulation operation, and the frame to which Relay 1-2 (580) of relay MLD 1 has added the MAC header may be an encapsulated frame, but may not be limited to such a designation.

When relay MLD 1 completes reception of the frame transmitted by AP 1-1 (540) of AP MLD 1 on the first link, relay MLD 1 may transmit the encapsulated frame to STA 1-2 (590) of STA MLD 1 within the TXOP on the second link. The MAC header added by Relay 1-2 (580) of relay MLD 1 may include an indicator indicating that the frame is encapsulated (or relayed). In an embodiment, the address 4 field of the MAC header added by Relay 1-2 (580) of relay MLD 1 may include the MAC address of at least one of AP MLD 1, AP 1-1 of AP MLD 1, and AP 1-2 of AP MLD 1. That is, when the address 4 field of the MAC header added by Relay 1-2 (580) of relay MLD 1 includes the MAC address of at least one of AP MLD 1, AP 1-1 of AP MLD 1, and AP 1-2 of AP MLD 1, the frame may be indicated as being encapsulated. Alternatively, the indicator indicating that the frame is encapsulated may be set as a separate subfield or bit (In an embodiment, an indicator included in the HT Control field).

In another embodiment, since AP MLD 1, STA MLD 1, and relay MLD 1 have configured the relay communication operation in advance, STA 1-2 (590) of STA MLD 1 may be aware that the frame transmitted by Relay 1-2 (580) of relay MLD 1 to STA 1-2 (590) of STA MLD 1 is encapsulated. Accordingly, a separate indicator may be unnecessary.

STA 1-2 (590) of STA MLD 1 may receive the encapsulated frame from Relay 1-2 (580) of relay MLD 1. STA 1-2 (590) of STA MLD 1 may recognize that the frame of Relay 1-2 (580) of relay MLD 1 is encapsulated based on the indicator indicating that the frame is encapsulated or the configured relay communication operation. STA 1-2 (590) of STA MLD 1 may decapsulate the encapsulated frame. STA 1-2 (590) of STA MLD 1 may confirm (In an embodiment, receive, decode, and verify errors in) the frame of AP 1-1 (540) of AP MLD 1, which is the payload of the encapsulated frame, and receive (decode) MSDU 1, which is the payload of the frame of AP 1-1 (540) of AP MLD 1.

In an embodiment, AP 1-1 (540) of AP MLD 1 on the first link may transmit a single frame or a plurality of frames at predetermined time intervals within the TXOP as shown in Table 2 below.

TABLE 2

Transmitting a single frame
Transmitting a plurality of frames at predetermined intervals
(In an embodiment, SIFS or PIFS intervals)

When AP 1-1 (540) of AP MLD 1 transmits a single frame, Relay 1-1 (550) of relay MLD 1 may receive the frame (a frame wherein the receiver address is STA 1-1 of STA MLD 1) from AP 1-1 (540) of AP MLD 1. In response to the frame transmitted by AP 1-1 (540) of AP MLD 1 to STA 1-1 (560) of STA MLD 1, Relay 1-1 (550) of relay MLD 1 may transmit an ACK frame to AP 1-1 (540) of AP MLD 1. AP 1-1 (540) of AP MLD 1 may regard the ACK frame of Relay 1-1 (550) of relay MLD 1 as an immediate response frame, but may not update the BlockAck scoreboard. That is, AP 1-1 (540) does not determine that the receiver of the frame has received the frame. In an embodiment, Relay 1-1 (550) of relay MLD 1 may not be able to transmit frames due to the NAV corresponding to the TXOP obtained by AP 1-1 (540) of AP MLD 1. However, Relay 1-1 (550) of relay MLD may regard the ACK frame as an immediate response frame to the frame of AP 1-1 (540) of AP MLD 1. Accordingly, Relay 1-1 (550) of relay MLD may transmit the ACK frame to AP 1-1 (540) of AP MLD 1 regardless of the NAV setting. Alternatively, Relay 1-1 (550) of relay MLD may not set the NAV upon receiving a frame wherein the receiver address is STA 1-2 (590) of STA MLD 1.

Relay 1-2 (580) of relay MLD 1 may encapsulate the frame transmitted by AP 1-1 (540) of AP MLD 1 and transmit it to STA 1-2 (590) of STA MLD 1. STA 1-2 (590) of STA MLD 1 may decapsulate the encapsulated frame and receive the payload (In an embodiment, MSDU 1). STA 1-2 (590) of STA MLD 1 may transmit a response frame (In an embodiment, a BlockAck frame) to Relay 1-2 (580) of relay MLD 1.

In another embodiment, the case where AP 1-1 (540) of AP MLD 1 transmits a plurality of frames at predetermined intervals may be considered. Relay 1-1 (550) of relay MLD 1 may receive a plurality of frames (506-1, 506-2, 506-3), wherein the receiver address is STA 1-1 (560) of STA MLD 1, from AP MLD 1 at predetermined time intervals. Relay 1-1 (550) of relay MLD 1 may encapsulate the plurality of frames (506-1, 506-2, 506-3) received from AP 1-1 (540) of AP MLD 1. When the frames of AP 1-1 (540) of AP MLD 1 are transmitted at PIFS intervals, which are longer than SIFS by aSlotTime, Relay 1-1 (550) of relay MLD 1 may transmit an ACK frame to AP 1-1 (540) of AP MLD 1 after a SIFS duration from the completion of frame reception. Alternatively, the method of transmitting the response frame from Relay 1-1 (550) of relay MLD 1 to AP 1-1 (540) of AP MLD 1 may differ depending on the Ack Policy setting of the frame transmitted by AP MLD 1 to Relay 1-1 (550) of relay MLD 1. The Ack Policy of frames other than the last frame transmitted by AP 1-1 (540) of AP MLD 1 to Relay 1-1 (550) of relay MLD 1 may be set to BlockAck, which does not require immediate transmission of a response frame, or may be set to No Ack Policy or the like. The interval between frames other than the last frame transmitted by AP 1-1 (540) of AP MLD 1 to Relay 1-1 (550) of relay MLD 1 may be SIFS. The Ack Policy of the last frame transmitted by AP 1-1 (540) of AP MLD 1 to Relay 1-1 (550) of relay MLD 1 may be set to Implicit BAR. When Relay 1-1 (550) of relay MLD 1 receives the last frame from AP 1-1 (540) of AP MLD 1, Relay 1-1 (550) of relay MLD 1 transmits a response frame (BlockAck frame, ACK frame) to AP 1-1 (540) of AP MLD 1 after a SIFS duration.

In another embodiment, referring to FIG. 5C, AP 1-1 (540) of AP MLD 1 may include an indicator indicating the last frame in the last transmitted frame (506-3) among the plurality of frames (506-1, 506-2, 506-3). The indicator indicating the last frame may be setting the value of the More Data subfield of the Frame Control field to 0. Upon receiving the frame containing the indicator indicating the last frame, Relay 1-1 (550) of relay MLD 1 may transmit an ACK frame (507) to AP 1-1 (540) of AP MLD 1 after a SIFS duration from the completion of reception of the last frame (506-3). AP 1-1 (540) of AP MLD 1 may regard the ACK frame of Relay 1-1 (550) of relay MLD 1 as an immediate response frame, but may not update the BlockAck scoreboard. That is, AP 1-1 (540) does not determine that the receiver of the frame has received the frame.

Here, Relay 1-1 (550) of relay MLD 1 may not be able to transmit frames due to the NAV corresponding to the TXOP obtained by AP 1-1 (540) of AP MLD 1. However, the ACK frame transmitted by Relay 1-1 (550) of relay MLD 1 may be regarded as an immediate response frame to the frame of AP 1-1 (540) of AP MLD 1. Accordingly, Relay 1-1 (550) of relay MLD 1 may transmit the ACK frame regardless of the NAV setting.

Referring to FIG. 5C, Relay 1-2 (580) of relay MLD 1 on the second link may transmit encapsulated frames (508-1, 508-2, 508-3) to STA 1-2 (590) of STA MLD 1. In an embodiment, STA 1-2 (590) of STA MLD 1 may individually transmit a response frame (In an embodiment, a BlockAck frame) for each of the encapsulated frames (508-1, 508-2, 508-3) transmitted by Relay 1-2 (580) of relay MLD 1. The Ack Policy of each of the encapsulated frames (508-1, 508-2, 508-3) may be set to Implicit BAR requesting a BlockAck frame. In another embodiment, after Relay 1-2 (580) of relay MLD 1 transmits the plurality of encapsulated frames (508-1, 508-2, 508-3), STA 1-2 (590) of STA MLD 1 may transmit a single response frame for the plurality of encapsulated frames (508-1, 508-2, 508-3). The Ack Policy of some of the encapsulated frames (508-1, 508-2) may be set to BlockAck, which does not immediately require a BlockAck frame, and the Ack Policy of the last encapsulated frame 508-3 may be set to Implicit BAR requesting a BlockAck frame.

Based on the operations of Table 2 described above, STA 1-2 (590) of STA MLD 1 may transmit a response frame to Relay 1-2 (580) of relay MLD 1. The response frame may be a BlockAck (BA) frame indicating the reception status of the frame transmitted by AP 1-1 (540) of AP MLD 1. STA 1-2 (590) of STA MLD 1 may set the transmitter address of the MAC header of the response frame to the MAC address of STA 1-2 (590) of STA MLD 1, and may set the receiver address to the MAC address of at least one of AP 1-1 (540) of AP MLD 1, AP 1-2 of AP MLD 1, and AP MLD 1. The MAC header included in the response frame transmitted by STA 1-2 (590) of STA MLD 1 may include an indicator indicating that the frame is transmitted (In an embodiment, relayed) through Relay 1-2 (580) of relay MLD 1 (i.e., relay MLD 1). The indicator indicating that the frame is relayed through relay MLD 1 may be the MAC address of the relay included in the address field of the MAC header (In an embodiment, the MAC address of at least one of relay MLD 1, Relay 1-1 of relay MLD 1, and Relay 1-2 of relay MLD 1 included in the Address 4 field). Alternatively, the indicator indicating that the frame is relayed through relay MLD 1 may be set as a separate subfield or bit (In an embodiment, an indicator included in the HT Control field).

In another embodiment, since AP MLD 1, STA MLD 1, and relay MLD 1 have configured the relay communication operation in advance, relay MLD 1 may be aware that the frame transmitted by STA MLD 1 to AP MLD 1 is to be relayed. Accordingly, the indicator indicating that the frame is to be relayed may be unnecessary. As a result, the MAC header transmitted by STA 1-2 (590) of STA MLD 1 may not include an indicator indicating that the frame is to be relayed. Relay 1-2 (580) of relay MLD 1 may receive a frame (response frame, BlockAck frame) from STA 1-2 (590) of STA MLD 1. Relay MLD 1 may transmit the response frame of STA 1-2 (590) of STA MLD 1 to AP 1-1 (540) of AP MLD 1 using Relay 1-1 (550) of relay MLD 1 on the first link. Alternatively, relay MLD 1 may transmit the response frame to AP 1-2 (570) of AP MLD 1 through Relay 1-2 (580) of relay MLD 1 on the second link. When the response frame of STA 1-2 (590) of STA MLD 1 is transmitted by Relay 1-1 (550) of relay MLD 1 on the first link, Relay 1-1 (550) of relay MLD 1 may add a MAC header, wherein the transmitter address is the MAC address of Relay 1-1 (550) of relay MLD 1 and the receiver address is the MAC address of AP 1-1 (540) of AP MLD 1, to the received frame. The payload of the frame generated by Relay 1-1 (550) of relay MLD 1 may be the response frame transmitted by STA 1-2 (590) of STA MLD 1 (the entire frame including the MAC header). That is, Relay 1-1 (550) of relay MLD 1 may perform an encapsulation operation to encapsulate the response frame of STA 1-2 (590) of STA MLD 1. After completing reception of the frame from STA 1-2 (590) of STA MLD 1, Relay 1-1 (550) of relay MLD 1 may perform a channel access operation (EDCA backoff operation, EDCA TXOP acquisition procedure) on the first link. When the channel access operation is completed, Relay 1-1 (550) of relay MLD 1 may transmit the encapsulated response frame to AP 1-1 (540) of AP MLD 1.

In another embodiment, when the response frame of STA 1-2 (590) of STA MLD 1 is transmitted by Relay 1-2 (580) of relay MLD 1 on the second link, Relay 1-2 (580) of relay MLD 1 may add a MAC header, wherein the transmitter address is the MAC address of Relay 1-2 (580) of relay MLD 1 and the receiver address is the MAC address of AP 1-2 of AP MLD 1, to the received frame. The payload of the frame generated by Relay 1-2 (580) of relay MLD 1 may be the response frame transmitted by STA 1-2 (590) of STA MLD 1 (the entire frame including the MAC header). That is, Relay 1-2 (580) of relay MLD 1 may perform an encapsulation operation to encapsulate the response frame of STA 1-2 (590) of STA MLD 1. After completing reception of the frame from STA 1-2 (590) of STA MLD 1, Relay 1-2 (580) of relay MLD 1 may transmit the encapsulated response frame to AP 1-2 (570) of AP MLD 1 after a SIFS duration. Alternatively, Relay 1-2 (580) of relay MLD 1 may perform a channel access operation (EDCA backoff operation, EDCA TXOP acquisition procedure) on the second link, and when the channel access operation is completed, may transmit the encapsulated response frame to AP 1-2 (570) of AP MLD 1.

The MAC header added by relay MLD 1 (i.e., Relay 1-1 (550) of relay MLD 1 and Relay 1-2 (580) of relay MLD 1) may include an indicator indicating that the frame is encapsulated. In an embodiment, the address 4 field of the MAC header added by relay MLD 1 may include the MAC address of STA 1-2 (590) of STA MLD 1, through which the frame may be indicated as being encapsulated. Alternatively, the indicator indicating that the frame is encapsulated may be set as a separate subfield or bit (In an embodiment, an indicator included in the HT Control field).

In another embodiment, since AP MLD 1, STA MLD 1, and relay MLD 1 have configured the relay communication operation in advance, AP MLD 1 may be aware that the frame transmitted by relay MLD 1 to AP MLD 1 is encapsulated, and therefore a separate indicator may be unnecessary.

AP MLD 1 may receive the encapsulated frame from relay MLD 1. AP MLD 1 may recognize that the frame of relay MLD 1 is encapsulated based on the indicator indicating that the frame is encapsulated or the configured relay communication operation. AP MLD 1 may decapsulate the encapsulated frame. AP MLD 1 may receive the frame (response frame, BlockAck frame) of STA 1-2 (590) of STA MLD 1 (i.e., STA MLD 1), which is the payload of the encapsulated frame, and AP MLD 1 may verify the reception status of the frame transmitted by AP MLD 1 to STA MLD 1. AP MLD 1 may update the BlockAck scoreboard based on the response frame (In an embodiment, BlockAck frame) from STA MLD 1, and may retransmit a frame if a frame whose transmission has failed exists.

In addition, in an embodiment, an error may exist in the frame received by relay MLD 1 (i.e., Relay 1-1 (550) of relay MLD 1) from AP MLD 1 (i.e., AP 1-1 (540) of AP MLD 1). Relay MLD 1 may not encapsulate the frame containing the error, and may not respond to AP MLD 1 or may transmit a frame requesting retransmission of the frame from AP MLD 1 (In an embodiment, an ACK frame indicating NACK, or a BlockAck frame). In this case, relay MLD 1 may receive the retransmission of the erroneous frame from AP 1-1 (540) of AP MLD 1 and transmit the frame to STA MLD 1 after receiving it without error, or may discard the erroneous frame if the retransmission of the erroneous frame is not received.

STA MLD 1 (i.e., STA 1-1 (560) of STA MLD 1) may be able to receive (decode) the frame from AP MLD 1 (i.e., AP 1-1 (540) of AP MLD 1). When STA MLD 1, AP MLD 1, and relay MLD 1 have performed relay communication operation configuration, STA 1-1 (560) of STA MLD 1 may not directly respond to AP 1-1 (540) of AP MLD 1 even when it receives the frame from AP 1-1 (540) of AP MLD 1.

In another embodiment, STA 1-1 (560) of STA MLD 1 (i.e., STA MLD 1) may be able to receive (decode) the frame from AP 1-1 (540) of AP MLD 1 (i.e., AP MLD 1). When STA MLD 1, AP MLD 1, and relay MLD 1 have performed relay communication operation configuration, STA 1-1 (560) of STA MLD 1 may store the received frame in a buffer upon receiving the frame from AP 1-1 (540) of AP MLD 1 and may not directly respond to AP MLD 1. STA 1-1 (560) of STA MLD 1 may additionally receive a data frame transmitted through relay MLD 1. STA MLD 1 may reconstruct the data frame using the data frame received from AP 1-1 (540) of AP MLD 1 and the data frame received from Relay 1-2 (580) of relay MLD 1 of relay MLD 1. Here, when the received data frame is an A-MPDU, the erroneous MPDUs of the A-MPDU received from AP 1-1 (540) of AP MLD 1 and the A-MPDU received from Relay 1-2 (580) of relay MLD 1 may differ. STA MLD 1 may recover the data frame through the error-free MPDUs, and may generate a response frame (BlockAck) based on the recovered data frame and transmit it to AP MLD 1 through relay MLD 1.

In FIG. 5A through FIG. 5C, the operation in which a relay (In an embodiment, Relay 1-1 (550) of relay MLD 1) encapsulates a frame from an AP (In an embodiment, AP 1-1 (540) of AP MLD 1) and transmits it to a STA (In an embodiment, STA 1-1 (560) of STA MLD), or in which a relay encapsulates a frame from a STA and transmits it to an AP, may be referred to as a tunneling operation, but may not be limited to such a designation. In addition, while FIG. 5A through FIG. 5C have been described with reference to an AP, a relay, and a STA, the present disclosure may not be limited thereto. In an embodiment, the same may be equally applicable to the case where frame transmission is relayed through a relay in communication between STAs. In another embodiment, the same may be equally applicable to the case where frame transmission is relayed through a relay in communication between APs. In another embodiment, the same may be equally applicable to the case where a STA performs uplink transmission to an AP through a relay, and the present disclosure may not be limited to any specific form.

In FIG. 5A through FIG. 5C, the configuration of the relay communication operation by AP 1-1 (540) of AP MLD 1 (or AP MLD 1, AP), STA 1-1 of STA MLD 1 (or STA MLD 1, STA), and Relay 1-1 (550) of relay MLD 1 of relay MLD 1 (or relay MLD 1, STA) may be performed based on the determination of the machine learning unit described in FIG. 1 through FIG. 4. In an embodiment, the machine learning unit may determine that at least one of the AP, the relay, and the STA requires a relay communication operation, and the procedure of determining the relay that performs the relay communication operation may be performed by the machine learning unit. In another embodiment, when a plurality of relays exist in a wireless LAN network, the machine learning unit of the AP or STA may determine that a relay communication operation is required using signal strength and the like as input. When it is determined that a relay communication operation is required, the machine learning unit may select the most suitable relay for the relay communication operation using the signal strengths of the plurality of relays as input. After configuring the relay communication operation with the most suitable relay, the relay communication operation(s) described in FIG. 5A through FIG. 5C may be performed.

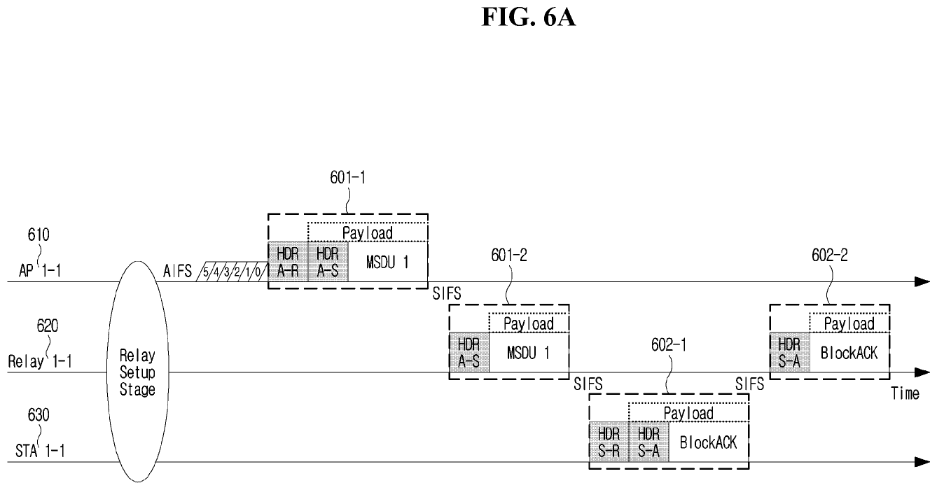

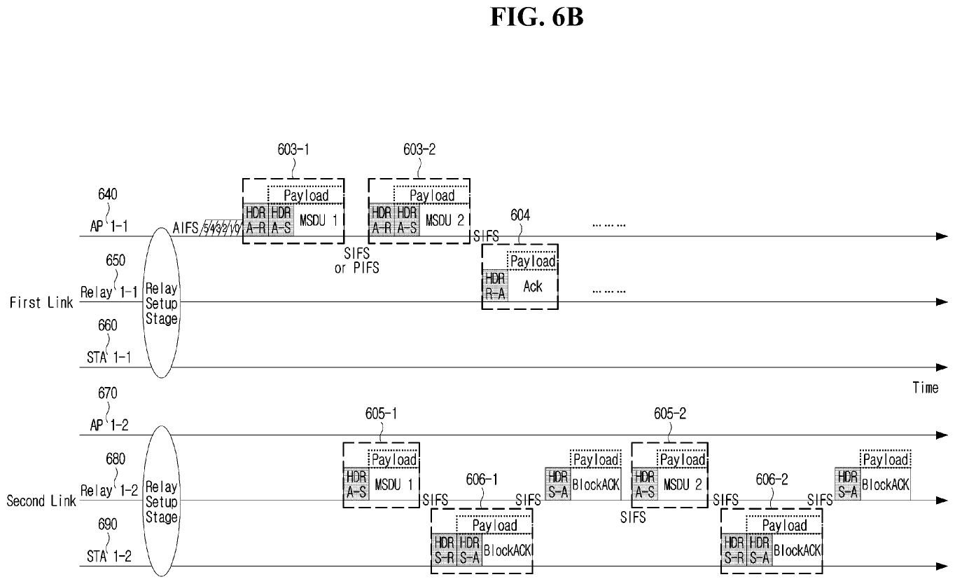

FIG. 6A and FIG. 6B are diagrams illustrating a method of performing a relay communication operation to which the present disclosure is applied.

Referring to FIG. 6A and FIG. 6B, wireless LAN terminals (In an embodiment, an access point (AP), a relay (Relay STA), and a station (STA)) may operate in a wireless LAN network. In an embodiment, the case where AP 1-1 (610), Relay 1-1 (620), and STA 1-1 (630) operate in a wireless LAN network may be considered in FIG. 6A, but this is for convenience of explanation only and may not be limited thereto. In addition, in FIG. 6B, the AP, relay, and STA may be multi-link devices (MLDs) supporting multi-link operation and may be referred to as an AP MLD, a relay MLD, and a STA MLD, respectively. An MLD may be a wireless LAN terminal that separately has a MAC layer (MLD lower MAC sublayer) and a PHY layer for each link (In an embodiment, a first link, a second link, etc.). Above the per-link MAC layer of the MLD, a MAC layer (MLD upper MAC sublayer) that integrates the per-link MAC layers may exist. Here, per-link APs or STAs may operate under the AP MLD, STA MLD, and relay MLD. In an embodiment, the AP of AP MLD 1 operating on the first link may be referred to as AP 1-1 of AP MLD 1, and the AP of AP MLD 1 operating on the second link may be referred to as AP 1-2 of AP MLD 1. In addition, the STA of STA MLD 1 operating on the first link may be referred to as STA 1-1 of STA MLD 1, and the STA of STA MLD 1 operating on the second link may be referred to as STA 1-2 of STA MLD 1. In addition, the relay of relay MLD 1 operating on the first link may be referred to as Relay 1-1 of relay MLD 1, and the relay of relay MLD 1 operating on the second link may be referred to as Relay 1-2 of relay MLD 1. The operations of the APs or STAs under the MLD may be operations of the MLD, and the operations of the MLD may be operations of the subordinate APs or STAs. FIG. 6B is merely an example for convenience of explanation and may not be limited to such operations.

Referring to FIG. 6A, AP 1-1 (610), Relay 1-1 (620), and STA 1-1 (630) may perform configuration for a relay communication operation in advance. That is, in FIG. 6A, AP 1-1 (610), Relay 1-1 (620), and STA 1-1 (630) may complete the configuration for a relay communication operation in advance. AP 1-1 (610), Relay 1-1 (620), and STA 1-1 (630) may be aware that a relay communication operation is to be performed through the aforementioned configuration. In addition, referring to FIG. 6B, AP MLD 1, relay MLD 1, and STA MLD 1 may perform configuration for a relay communication operation in advance. That is, in FIG. 6B, AP MLD 1, relay MLD 1, and STA MLD 1 may complete the configuration for a relay communication operation in advance. AP MLD 1, relay MLD 1, and STA MLD 1 may be aware that a relay communication operation is to be performed through the aforementioned configuration. However, FIG. 6A and FIG. 6B are merely examples for convenience of explanation and are not limited to such embodiments, and may be equally applicable in other cases.

Referring to FIG. 6A, AP 1-1 (610) may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (630). The channel access operation may be an enhanced distributed channel access (EDCA) backoff operation and an EDCA transmission opportunity (TXOP) acquisition procedure. In the EDCA backoff operation, AP 1-1 (610) may decrement the backoff counter when the medium is detected as idle, and may transmit a frame at the slot boundary at which the backoff counter reaches 0. In another embodiment, AP 1-1 (610) may intend to transmit a frame to STA 1-1 (630) within an EDCA transmission opportunity (TXOP), which is a communication period during which a plurality of frames may be transmitted, having previously succeeded in the channel access operation. The duration of the MAC header corresponding to the TXOP established by AP 1-1 (610) may be set to a duration equal to or longer than the sum of the encapsulated data frame transmission time from AP 1-1 (610) to Relay 1-1 (620), the frame transmission time from Relay 1-1 (620) to STA 1-1 (630), the encapsulated response frame (BlockAck) transmission time of STA 1-1 (630), the response frame transmission time of Relay 1-1 (620), and the inter-frame interval (In an embodiment, SIFS duration) between each frame transmission.

The transmitter address of the MAC header included in the original frame transmitted by AP 1-1 (610) may be set to the MAC address of AP 1-1 (610), and the receiver address may be set to the MAC address of STA 1-1 (630). That is, AP 1-1 (610) may intend to transmit an original frame wherein the MSDU (In an embodiment, MSDU 1), for which STA 1-1 (630) is the recipient, is the payload. Here, AP 1-1 (610) may not transmit the original frame as-is, but may add a new MAC header to the frame. The transmitter address of the new MAC header may be set to the MAC address of AP 1-1 (610), and the receiver address may be set to the MAC address of Relay 1-1 (620). That is, AP 1-1 (610) may encapsulate the frame to generate an encapsulated frame (601-1). The payload of the encapsulated frame (601-1) is the original frame of AP 1-1 (610). The encapsulation of the frame by AP 1-1 (610) may be an operation performed to relay the frame to STA 1-1 (630) through Relay 1-1 (620).

The new MAC header of the encapsulated frame (601-1) transmitted by AP 1-1 (610) may include an indicator indicating that the frame is transmitted (In an embodiment, relayed) through Relay 1-1 (620). The indicator indicating that the frame is relayed through Relay 1-1 (620) may be the MAC address of the STA (In an embodiment, the MAC address of STA 1-1 (630) included in the Address 4 field) included in the address field of the MAC header. That is, when the MAC address of the STA is included in the address field of the MAC header, the frame may be indicated as being relayed to STA 1-1 through Relay 1-1 (620). Alternatively, the indicator indicating that the frame is relayed through Relay 1-1 (620) may be set as a separate subfield or bit (In an embodiment, an indicator included in the HT Control field) to indicate whether the frame is relayed through Relay 1-1 (620).

In another embodiment, since AP 1-1 (610), STA 1-1 (630), and Relay 1-1 (620) have configured the relay communication operation in advance, Relay 1-1 (620) may be aware that the frame transmitted by AP 1-1 (610) is to be relayed to STA 1-1 (630). In consideration of the foregoing, the indicator indicating that the frame is to be relayed may be unnecessary, and the MAC header of the frame transmitted by AP 1-1 (610) may not include such an indicator.

Relay 1-1 (620) may receive the frame (601-1) from AP 1-1 (610). Relay 1-1 (620) may remove the MAC header added by AP 1-1 (610) and transmit the original frame (601-2) of AP 1-1 (610) (i.e., the payload of the encapsulated frame) after a SIFS duration from the completion of reception of the frame transmitted by AP 1-1 (610). The operation in which Relay 1-1 (620) removes the MAC header added by AP 1-1 (610) may be a decapsulation operation. In an embodiment, Relay 1-1 (620) may remove the MAC header added by AP 1-1 (610) and modify the MAC header of the original frame (601-2) of AP 1-1 (610) to include an indicator indicating that the frame is being transmitted after being relayed by Relay 1-1 (620). Since Relay 1-1 (620) transmits the decapsulated frame (601-2) after a SIFS duration, AP 1-1 (610) may regard the decapsulated frame (601-2) of Relay 1-1 (620) as an immediate response frame. In an embodiment, Relay 1-1 (620) may not be able to transmit frames due to the NAV corresponding to the TXOP obtained by AP 1-1 (610). However, Relay 1-1 (620) may regard the decapsulated frame (601-2) as an immediate response frame to the frame of AP 1-1 (610). Alternatively, since Relay 1-1 (620) is the receiver of the frame transmitted by AP 1-1 (610), it may not be necessary for Relay 1-1 (620) to set the NAV. That is, Relay 1-1 (620) may be a TXOP responder. Accordingly, Relay 1-1 (620) may transmit the decapsulated frame (601-2) to STA 1-1 (630) regardless of the NAV setting. AP 1-1 (610) may not update the BlockAck scoreboard of AP 1-1 (610) until it receives the response frame (In an embodiment, a BlockAck frame) from STA 1-1 (630). That is, AP 1-1 (610) does not determine that the receiver of the frame has received the frame.

STA 1-1 (630) may receive the original frame (601-2) of AP 1-1 (610) from Relay 1-1 (620). STA 1-1 (630) may recognize that the frame is received from AP 1-1 (610) through Relay 1-1 (620) based on the indicator indicating that the frame is relayed and transmitted, or based on the configured relay communication operation. STA 1-1 (630) may transmit a response frame (In an embodiment, a BlockAck frame) after a SIFS duration from the completion of reception of the frame from Relay 1-1 (620). The response frame transmitted by STA 1-1 (630) may be encapsulated similarly to the frame transmitted by AP 1-1 (610). In an embodiment, the transmitter address of the original BlockAck frame transmitted by STA 1-1 (630) may be set to the MAC address of STA 1-1 (630), and the receiver address may be set to the MAC address of AP 1-1 (610). STA 1-1 (630) may add a new MAC header to the original BlockAck frame. The transmitter address of the MAC header added by STA 1-1 (630) may be set to STA 1-1 (630), and the receiver address may be set to Relay 1-1 (620). That is, STA 1-1 (630) may encapsulate the response frame, and the payload of the encapsulated response frame (602-1) may be the original BlockAck frame. The new MAC header of the encapsulated response frame (602-1) of STA 1-1 (630) may include an indicator indicating that the response frame is transmitted (In an embodiment, relayed) through Relay 1-1 (620). The indicator indicating that the frame is relayed through Relay 1-1 (620) may be the MAC address of the AP (In an embodiment, the MAC address of AP 1-1 included in the Address 4 field) included in the address field of the MAC header. That is, when the MAC address of the AP is included in the address field of the MAC header, the frame may be indicated as being relayed through Relay 1-1 (620). Alternatively, the indicator indicating that the frame is relayed through Relay 1-1 (620) may be set as a separate subfield or bit (In an embodiment, an indicator included in the HT Control field) to indicate whether the frame is to be relayed.

In another embodiment, since AP 1-1 (610), STA 1-1 (630), and Relay 1-1 (620) have configured the relay communication operation in advance, Relay 1-1 (620) may be aware that the response frame transmitted by STA 1-1 (630) is to be relayed to AP 1-1 (610). In consideration of the foregoing, the indicator indicating that the frame is to be relayed may be unnecessary. Accordingly, the MAC header of the frame transmitted by STA 1-1 (630) may not include an indicator indicating that the frame is to be relayed.

Relay 1-1 (620) may receive the encapsulated response frame (602-1) of STA 1-1 (630) and remove the MAC header added by STA 1-1 (630) from the encapsulated response frame (602-1) transmitted by STA 1-1 (630). Relay 1-1 (620) may transmit the original frame (602-2) of STA 1-1 (630) (i.e., the payload of the encapsulated frame) after a SIFS duration from the completion of reception of the frame transmitted by STA 1-1 (630). The operation in which Relay 1-1 (620) removes the MAC header added by STA 1-1 (630) may be a decapsulation operation. Relay 1-1 (620) may remove the MAC header added by STA 1-1 (630) and modify the MAC header of the original response frame of STA 1-1 (630) to include an indicator indicating that the response frame is being transmitted after being relayed by Relay 1-1 (620). AP 1-1 (610) may receive the response frame (602-2) of STA 1-1 (630) through Relay 1-1 (620). AP 1-1 (610) may verify the reception status of the frame transmitted by AP 1-1 (610) to STA 1-1 (630) and update the BlockAck scoreboard based on the response frame (In an embodiment, a BlockAck frame) from STA 1-1 (630). In addition, AP 1-1 (610) may retransmit a frame if a frame whose transmission has failed exists.

In an embodiment, an error may exist in the frame received by Relay 1-1 (620) from AP 1-1 (610). Relay 1-1 (620) may not transmit the frame containing the error to STA 1-1 (630), and may not respond to AP 1-1 (610) or may transmit a frame requesting retransmission of the frame from AP 1-1 (610) (In an embodiment, an ACK frame indicating NACK, or a BlockAck frame). In this case, Relay 1-1 (620) may receive the retransmission of the erroneous frame from AP 1-1 (610) and transmit the frame to STA 1-1 (630) after receiving it without error, or may discard the erroneous frame if the retransmission of the erroneous frame is not received.

In another embodiment, STA 1-1 (630) may be able to receive (decode) the frame transmitted by AP 1-1 (610). However, since the receiver address in the MAC header of the frame transmitted by AP 1-1 (610) is Relay 1-1 (620), STA 1-1 (630) may not respond to the frame transmitted by AP 1-1 (610).

In another embodiment, STA 1-1 (630) may be able to receive (decode) the frame transmitted by AP 1-1 (610). When STA 1-1 (630), AP 1-1 (610), and Relay 1-1 (620) have performed relay communication operation configuration, STA 1-1 (630) may store the received frame in a buffer upon receiving the frame from AP 1-1 (610) and may not directly respond to AP 1-1 (610). STA 1-1 (630) may additionally receive a data frame transmitted through Relay 1-1 (620). STA 1-1 (630) may reconstruct the data frame using the data frame received from AP 1-1 (610) and the data frame received from Relay 1-1 (620). In an embodiment, when the received data frame is an A-MPDU, the erroneous MPDUs of the A-MPDU received from AP 1-1 (610) and the A-MPDU received from Relay 1-1 (620) may differ. STA 1-1 (630) may recover the data frame through the error-free MPDUs, and may generate a response frame (BlockAck) based on the recovered data frame and transmit it to AP 1-1 (610) through Relay 1-1 (620).

Referring to FIG. 6B, AP MLD 1, relay MLD 1, and STA MLD 1 may perform configuration for a relay communication operation in advance. AP MLD 1, relay MLD 1, and STA MLD 1 may be aware in advance that a relay communication operation is to be performed through the configuration for the relay communication operation.

AP 1-1 (640) of AP MLD 1 operating on the first link may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (660) of STA MLD 1. The channel access operation may be an enhanced distributed channel access (EDCA) backoff operation and an EDCA transmission opportunity (TXOP) acquisition procedure. In the EDCA backoff operation, AP 1-1 (640) of AP MLD 1 may decrement the backoff counter when the medium is detected as idle, and may transmit a frame at the slot boundary at which the backoff counter reaches 0. In another embodiment, AP 1-1 (640) of AP MLD 1 may intend to transmit a frame to STA 1-1 (660) of the STA MLD within an EDCA transmission opportunity (TXOP), which is a communication period during which a plurality of frames may be transmitted, having previously succeeded in the channel access operation. The duration of the MAC header corresponding to the TXOP established by AP 1-1 (640) of AP MLD 1 may be set to a duration equal to or longer than the sum of the transmission time of one or more data frames transmitted from AP 1-1 (640) of AP MLD 1 to Relay 1-1 (650) of relay MLD, the response frame (BlockAck) transmission time of Relay 1-1 (650), and the inter-frame interval (In an embodiment, SIFS duration) between each frame transmission.

The transmitter address of the MAC header included in the original frame to be transmitted by AP 1-1 (640) of AP MLD 1 may be set to the MAC address of AP 1-1 (640) of AP MLD 1, and the receiver address may be set to the MAC address of STA 1-1 (660) of STA MLD 1. The payload included in the original frame to be transmitted by AP 1-1 (640) of AP MLD 1 may be the MSDU for which STA 1-1 (660) of STA MLD 1 is the recipient. AP 1-1 (640) of AP MLD 1 may not transmit the original frame as-is, but may add a new MAC header to the frame. The transmitter address of the new MAC header may be set to the MAC address of AP 1-1 (640) of AP MLD 1, and the receiver address may be set to the MAC address of Relay 1-1 (650) of relay MLD 1. That is, AP 1-1 (640) of AP MLD 1 may encapsulate the frame to generate an encapsulated frame. The payload of the encapsulated frame is the original frame of AP 1-1 (640) of AP MLD 1. The encapsulation of the frame by AP 1-1 (640) of AP MLD 1 (i.e., AP MLD 1) may be an operation performed to relay the frame through Relay 1-1 (650) of relay MLD 1 (i.e., relay MLD 1). The new MAC header of the encapsulated frame of AP 1-1 (640) of AP MLD 1 may include an indicator indicating that the frame is transmitted (In an embodiment, relayed) through relay MLD 1. The indicator indicating that the frame is relayed through relay MLD 1 may be the MAC address of the STA (In an embodiment, STA MLD 1 and subordinate STAs) included in the address field of the MAC header (In an embodiment, the MAC address of at least one of STA MLD 1, STA 1-1 (660) of STA MLD 1, and STA 1-2 (690) of STA MLD 1 included in the Address 4 field). That is, when the MAC address of STA MLD 1 is included in the address field of the MAC header, the frame may be indicated as being relayed to STA MLD 1 through relay MLD 1. Alternatively, the indicator indicating that the frame is relayed through relay MLD 1 may be set as a separate subfield or bit (In an embodiment, an indicator included in the HT Control field).

In another embodiment, since AP MLD 1, STA MLD 1, and relay MLD 1 have configured the relay communication operation in advance, relay MLD 1 may be aware that the frame transmitted by AP MLD 1 is to be relayed to STA MLD 1. Accordingly, the indicator indicating that the frame is to be relayed may be unnecessary in the MAC header of the frame transmitted by AP 1-1 (640) of AP MLD 1.

Relay 1-1 (650) of relay MLD 1 may receive the frame from AP 1-1 (640) of AP MLD 1. Relay MLD 1 may intend to transmit the received frame to STA MLD 1 on the second link. That is, relay MLD 1 may intend to transmit the frame received on the first link to STA 1-2 (690) of STA MLD 1 through Relay 1-2 of relay MLD 1 on the second link. In another embodiment, the case where the first link is in a busy state after relay MLD 1 receives the frame transmitted from AP MLD 1 to STA MLD 1 on the first link may be considered. Among the first link and second link available to relay MLD 1, relay MLD 1 may be aware that the second link is in an idle state, or that the busy state of the second link ends sooner than that of the first link. Accordingly, relay MLD 1 may not be able to transmit the encapsulated frame from Relay 1-1 (650) of relay MLD 1 to STA 1-1 (660) of STA MLD 1 on the first link. In the aforementioned situation, relay MLD 1 may intend to transmit the encapsulated frame to STA 1-2 (690) of STA MLD 1 through Relay 1-2 (680) of relay MLD 1 on the second link, but may not be limited to such an embodiment.

When relay MLD 1 successfully decodes MSDU 1, Relay 1-2 (680) of relay MLD 1 may immediately perform a channel access operation (EDCA backoff operation, EDCA TXOP acquisition procedure) on the second link. When the channel access operation of Relay 1-2 (680) of relay MLD 1 is successful, an EDCA TXOP, which is a communication period on the second link, may be obtained. Alternatively, when relay MLD 1 detects a frame being transmitted on the first link, Relay 1-2 (680) of relay MLD 1 may immediately perform a channel access operation. Relay 1-2 (680) of relay MLD 1 may wait without transmitting a frame until the decoding of MSDU 1 is successfully completed. The duration of the MAC header corresponding to the TXOP established by Relay 1-2 (680) of relay MLD 1 may be set to a duration equal to or longer than the sum of the transmission time of one or more data frames transmitted from Relay 1-2 (680) of relay MLD 1 to STA 1-2 (690) of STA MLD 1, the encapsulated response frame (BlockAck) transmission time of STA 1-2 (690) of STA MLD 1, the time for Relay 1-2 (680) of relay MLD 1 to transmit the response frame of STA 1-2 (690) of STA MLD 1, and the inter-frame interval (In an embodiment, SIFS duration) between each frame transmission.

The EDCA TXOP of Relay 1-2 (680) of relay MLD 1 may be used by Relay 1-2 (680) of relay MLD 1 to transmit the frame of AP MLD 1 to STA MLD 1. Relay MLD 1 may remove the MAC header added by AP 1-1 (640) of AP MLD 1 from the frame received from AP 1-1 (640) of AP MLD 1. That is, relay MLD 1 may decapsulate the frame. After completing reception of the frame transmitted by AP 1-1 (640) of AP MLD 1 on the first link and decapsulating it, relay MLD 1 may transmit the original frame of AP 1-1 (640) of AP MLD 1 to STA 1-2 (690) of STA MLD 1 within the TXOP on the second link. Relay 1-2 (680) of relay MLD 1 may further perform an operation of decapsulating the frame and adding an indicator indicating that the frame is encapsulated to the MAC header of the original frame transmitted by AP 1-1 (640) of AP MLD 1.

In another embodiment, since AP MLD 1, STA MLD 1, and relay MLD 1 have configured the relay communication operation in advance, STA 1-2 (690) of STA MLD 1 may be aware that the frame transmitted by Relay 1-2 (680) of relay MLD 1 to STA 1-2 (690) of STA MLD 1 is encapsulated, and therefore a separate indicator may be unnecessary.

STA 1-2 (690) of STA MLD 1 may receive the frame from Relay 1-2 (680) of relay MLD 1. STA 1-2 (690) of STA MLD 1 may recognize that the frame has been transmitted from AP 1-1 (640) of AP MLD 1 through relay MLD 1 based on the configured relay communication operation. STA 1-2 (690) of STA MLD 1 may receive (decode) MSDU 1, which is the payload of the frame of AP 1-1 (640) of AP MLD 1.

In addition, in an embodiment, AP 1-1 (640) of AP MLD 1 may perform any one of the operations listed in Table 3 below within the TXOP on the first link.

TABLE 3

Transmitting a single frame
Transmitting a plurality of frames at predetermined intervals
(In an embodiment, SIFS or PIFS intervals)

When AP 1-1 (640) of AP MLD 1 transmits a single frame, Relay 1-1 (650) of relay MLD 1 may receive the encapsulated frame from AP 1-1 (640) of AP MLD 1 (a frame wherein the receiver address is Relay 1-1 (650) of relay MLD 1 and the receiver address in the MAC header of the payload is the address of STA MLD 1 or subordinate STAs). In response to the frame transmitted by AP 1-1 (640) of AP MLD 1 to STA 1-1 (660) of STA MLD 1, Relay 1-1 (650) of relay MLD 1 may transmit an ACK frame to AP 1-1 (640) of AP MLD 1. AP 1-1 (640) of AP MLD 1 may regard the ACK frame of Relay 1-1 (650) of relay MLD 1 as an immediate response frame, but may not update the BlockAck scoreboard. That is, AP 1-1 (640) does not determine that the receiver of the frame has received the frame. In an embodiment, Relay 1-1 (650) of relay MLD 1 may not be able to transmit frames due to the NAV corresponding to the TXOP obtained by AP 1-1 (640) of AP MLD 1. However, Relay 1-1 (650) of relay MLD 1 may regard the ACK frame as an immediate response frame to the frame of AP 1-1 (640) of AP MLD 1. Accordingly, Relay 1-1 (650) of relay MLD 1 may transmit the ACK frame to AP 1-1 (640) of AP MLD 1 regardless of the NAV setting. Alternatively, since Relay 1-1 (650) is the receiver of the frame transmitted from AP 1-1 (640), it may not be necessary for Relay 1-1 (650) to set the NAV. That is, Relay 1-1 (650) may be a TXOP responder. Relay 1-2 (680) of relay MLD 1 may decapsulate the frame transmitted by AP 1-1 (640) of AP MLD 1 and transmit the frame to STA 1-2 (690) of STA MLD 1. STA 1-2 (690) of STA MLD 1 may receive the frame from AP 1-1 (640) of AP MLD 1 and receive the payload (In an embodiment, MSDU 1). STA 1-2 (690) of STA MLD 1 may encapsulate and transmit a response frame (In an embodiment, a BlockAck frame) to Relay 1-2 (680) of relay MLD 1.

On the other hand, AP 1-1 (640) of AP MLD 1 may transmit a plurality of frames at predetermined time intervals. When AP 1-1 (640) of AP MLD 1 transmits a plurality of frames at predetermined time intervals, Relay 1-1 (650) of relay MLD 1 may receive the encapsulated frames from AP MLD 1 (frames wherein the receiver address is Relay 1-1 (650) of relay MLD 1 and the receiver address in the MAC header of the payload is the address of STA MLD 1 or subordinate STAs). Relay 1-1 (650) of relay MLD 1 may decapsulate the plurality of frames (603-1, 603-2) received from AP 1-1 (640) of AP MLD 1. When the frames of AP 1-1 (640) of AP MLD 1 are transmitted at PIFS intervals, which are longer than SIFS by aSlotTime, Relay 1-1 (650) of relay MLD 1 may transmit an ACK frame to AP 1-1 (640) of AP MLD 1 after a SIFS duration from the completion of frame reception. Alternatively, the method of transmitting the response frame from Relay 1-1 (650) of relay MLD 1 to AP 1-1 (640) of AP MLD 1 may differ depending on the Ack Policy setting of the frame transmitted by AP MLD 1 to Relay 1-1 (650) of relay MLD 1. The Ack Policy of frames other than the last frame transmitted by AP 1-1 (640) of AP MLD 1 to Relay 1-1 (650) of relay MLD 1 may be set to BlockAck, which does not require immediate transmission of a response frame, or may be set to No Ack Policy or the like. The interval between frames other than the last frame transmitted by AP 1-1 (640) of AP MLD 1 to Relay 1-1 (650) of relay MLD 1 may be SIFS. The Ack Policy of the last frame transmitted by AP 1-1 (640) of AP MLD 1 to Relay 1-1 (650) of relay MLD 1 may be set to Implicit BAR. When Relay 1-1 (650) of relay MLD 1 receives the last frame received from AP 1-1 (640) of AP MLD 1, Relay 1-1 (650) of relay MLD 1 transmits a response frame (BlockAck frame, ACK frame) to AP 1-1 after a SIFS duration. That is, the above-described operation may be the following operation. Specifically, the original frame of the AP 1-1 (640) of the AP MLD 1 may be transmitted from the AP MLD 1 to a Relay MLD 1. That is, based on the original frame of the AP 1-1 (640), at least one of a traffic identifier (TID) associated with downlink data that the AP MLD 1 intends to transmit to an STA MLD 1, a packet number (PN) associated with the TID, and a sequence number (SN) associated with the TID may be transferred from the AP MLD 1 to the Relay MLD 1. In other words, the Relay MLD may recognize the TID and the PN associated with the TID which are related to the downlink data that the AP MLD 1 intends to transmit to the STA MLD 1. Thus, the Relay MLD may receive the downlink data from the AP MLD 1 to transfer the downlink data to the STA MLD 1.

In another embodiment, referring to FIG. 6B, AP 1-1 (640) of AP MLD 1 may include an indicator indicating the last frame in the last transmitted frame among the plurality of frames (603-1, 603-2). The indicator indicating the last frame may be setting the value of the More Data subfield of the Frame Control field to 0. Upon receiving the frame containing the indicator indicating the last frame, Relay 1-1 (650) of relay MLD 1 may transmit an ACK frame (604) to AP 1-1 (640) of AP MLD 1 after a SIFS duration from the completion of frame reception. AP 1-1 (640) of AP MLD 1 may regard the ACK frame (604) of Relay 1-1 (650) of relay MLD 1 as an immediate response frame, but may not update the BlockAck scoreboard. That is, AP 1-1 (640) does not determine that the receiver of the frame has received the frame. In an embodiment, Relay 1-1 (650) of relay MLD 1 may not be able to transmit frames due to the NAV corresponding to the TXOP obtained by AP 1-1 (640) of AP MLD 1. However, Relay 1-1 (650) of relay MLD 1 may regard the ACK frame as an immediate response frame to the frame of AP 1-1 (640) of AP MLD 1. Accordingly, Relay 1-1 (650) of relay MLD 1 may transmit the ACK frame to AP 1-1 (640) of AP MLD 1 regardless of the NAV setting. Alternatively, since Relay 1-1 (650) is the receiver of the frame transmitted from AP 1-1 (640), it may not be necessary for Relay 1-1 (650) to set the NAV. That is, Relay 1-1 (650) may be a TXOP responder.

Relay 1-2 (680) of relay MLD 1 may transmit decapsulated frames (605-1, 605-2) to STA 1-2 (690) of STA MLD 1 on the second link. In an embodiment, STA 1-2 (690) of STA MLD 1 may individually transmit a response frame (In an embodiment, BlockAck frames, 606-1, 606-2) for each of the frames transmitted by Relay 1-2 (680) of relay MLD 1. The Ack Policy of each of the encapsulated frames (605-1, 605-2) may be set to Implicit BAR requesting a BlockAck frame. In another embodiment, after Relay 1-2 (680) of relay MLD 1 transmits a plurality of frames, STA 1-2 (690) of STA MLD 1 may transmit a single response frame for the plurality of frames, and the present disclosure may not be limited to any specific form. The Ack Policy of some of the encapsulated frames (605-1) may be set to BlockAck, which does not immediately require a BlockAck frame, and the Ack Policy of the last encapsulated frame 605-2 may be set to Implicit BAR requesting a BlockAck frame.

Based on at least one of the operations of Table 3 described above, STA 1-2 (690) of STA MLD 1 may transmit a response frame to Relay 1-2 (680) of relay MLD 1. The response frame may be a BlockAck (BA) frame indicating the reception status of the frame transmitted by AP 1-1 (640) of AP MLD 1 (i.e., AP MLD 1). The response frame transmitted by STA 1-2 (690) of STA MLD 1 may be encapsulated similarly to the frame transmitted by AP 1-1 (640) of AP MLD 1. In an embodiment, the transmitter address of the original BlockAck frame transmitted by STA 1-2 (690) of STA MLD 1 may be set to the MAC address of STA 1-2 (690) of STA MLD 1, and the receiver address may indicate the MAC address of AP MLD or subordinate APs of AP MLD (In an embodiment, at least one of AP 1-1 (640) of AP MLD 1 and AP 1-2 (670) of AP MLD 1). STA 1-2 (690) of STA MLD 1 may add a new MAC header to the original BlockAck frame. The transmitter address of the MAC header added by STA 1-2 (690) of STA MLD 1 may be set to STA 1-2 (690) of STA MLD 1, and the receiver address may be set to Relay 1-2 (680) of relay MLD 1. That is, STA 1-2 (690) of STA MLD 1 may encapsulate the response frame, and the payload of the encapsulated response frame may be the original BlockAck frame. The new MAC header of the encapsulated response frame of STA 1-2 (690) of STA MLD 1 may include an indicator indicating that the response frame is transmitted (In an embodiment, relayed) through Relay 1-2 (680) of relay MLD 1 (i.e., relay MLD 1). The indicator indicating that the frame is relayed through relay MLD 1 may be the MAC address (In an embodiment, the MAC address included in the Address 4 field) of the AP (In an embodiment, at least one of AP MLD 1, AP 1-1 (640) of AP MLD 1, and AP 1-2 (670) of AP MLD 1) included in the address field of the MAC header. Alternatively, the indicator indicating that the frame is relayed through relay MLD 1 may be set as a separate subfield or bit (In an embodiment, an indicator included in the HT Control field). In another embodiment, since AP MLD 1, STA MLD 1, and relay MLD 1 have configured the relay communication operation in advance, relay MLD 1 may be aware that the response frame transmitted by STA MLD 1 (i.e., STA 1-2) is to be relayed to AP MLD 1. Accordingly, the indicator indicating that the frame is to be relayed may be unnecessary in the MAC header transmitted by STA 1-2 (690) of STA MLD 1. Relay 1-2 (680) of relay MLD 1 may receive the response frame of STA 1-2 (690) of STA MLD 1 and remove the MAC header added by STA 1-2 (690) of STA MLD 1 from the encapsulated response frame transmitted by STA 1-2 (690) of STA MLD 1. Relay MLD 1 may transmit the response frame of STA 1-2 (690) of STA MLD 1 to AP 1-1 (640) of AP MLD 1 through Relay 1-1 (650) of relay MLD 1 on the first link. In another embodiment, relay MLD 1 may transmit the response frame of STA 1-2 (690) of STA MLD 1 to AP 1-2 (670) of AP MLD 1 through Relay 1-2 (680) of relay MLD 1 on the second link.

The operation in which relay MLD 1 removes the MAC header added by STA 1-2 (690) of STA MLD 1 may be a decapsulation operation. Relay MLD 1 may remove the MAC header added by STA 1-2 (690) of STA MLD 1 and modify the MAC header of the original response frame of STA 1-2 (690) of STA MLD 1 to include an indicator indicating that the response frame is being transmitted after being relayed by relay MLD 1. Relay MLD 1 may transmit the original response frame to AP 1-2 (670) of AP MLD 1 after a SIFS duration from the completion of reception of the frame from STA 1-2 (690) of STA MLD 1. In another embodiment, relay MLD 1 may perform a channel access operation (EDCA backoff operation, EDCA TXOP acquisition procedure) on the second link, and when the channel access operation is completed, may transmit the original response frame to AP 1-2 (670) of AP MLD 1.

AP MLD 1 may receive the response frame of STA MLD 1 through relay MLD 1. AP MLD 1 may verify the reception status of the frame transmitted to STA MLD 1. AP MLD 1 may update the BlockAck scoreboard based on the response frame (In an embodiment, a BlockAck frame) from STA MLD 1, and may retransmit a frame if a frame whose transmission has failed exists.

In addition, in an embodiment, an error may exist in the frame received by relay MLD 1 (i.e., Relay 1-1 (650) of relay MLD 1) from AP MLD 1 (i.e., AP 1-1 (540) of AP MLD 1). Relay MLD 1 may not transmit the frame containing the error to STA MLD 1. Relay MLD 1 may not respond to AP MLD 1 or may transmit a frame requesting retransmission of the frame from AP MLD 1 (In an embodiment, an ACK frame indicating NACK, or a BlockAck frame). In this case, relay MLD 1 may receive the retransmission of the erroneous frame from AP 1-1 (640) of AP MLD 1 and transmit the frame to STA MLD 1 after receiving it without error, or may discard the erroneous frame if the retransmission of the erroneous frame is not received.

STA MLD 1 (i.e., STA 1-1 (660) of STA MLD 1) may be able to receive (decode) the frame from AP MLD 1 (i.e., AP 1-1 (640) of AP MLD 1). When STA MLD 1, AP MLD 1, and relay MLD 1 have performed relay communication operation configuration, STA 1-1 (660) of STA MLD 1 may not directly respond to AP 1-1 (640) of AP MLD 1 even when it receives the frame from AP 1-1 (640) of AP MLD 1.

In another embodiment, STA 1-1 (660) of STA MLD 1 (i.e., STA MLD 1) may be able to receive (decode) the frame from AP 1-1 (640) of AP MLD 1 (i.e., AP MLD 1). When STA MLD 1, AP MLD 1, and relay MLD 1 have performed relay communication operation configuration, STA 1-1 (660) of STA MLD 1 may store the received frame in a buffer upon receiving the frame from AP 1-1 (640) of AP MLD 1 and may not directly respond to AP MLD 1. STA 1-1 (660) of STA MLD 1 may additionally receive a data frame transmitted through relay MLD 1. STA MLD 1 may reconstruct the data frame using the data frame received from AP 1-1 (640) of AP MLD 1 and the data frame received from Relay 1-2 (680) of relay MLD 1 of relay MLD 1. Here, when the received data frame is an A-MPDU, the erroneous MPDUs of the A-MPDU received from AP 1-1 (540) of AP MLD 1 and the A-MPDU received from Relay 1-2 (580) of relay MLD 1 may differ. STA MLD 1 may recover the data frame through the error-free MPDUs, and may generate a response frame (BlockAck) based on the recovered data frame and transmit it to AP MLD 1 through relay MLD 1.

In FIG. 6A and FIG. 6B, the operation in which an AP (In an embodiment, AP 1-1 (640) of AP MLD 1) encapsulates a frame and transmits it to a STA (In an embodiment, STA 1-1 (560) of STA MLD) through a relay (In an embodiment, Relay 1-1 (650) of relay MLD 1), or in which a STA encapsulates a frame and transmits it to an AP through a relay, may be referred to as a tunneling operation, but may not be limited to such a designation. In addition, while FIG. 6A and FIG. 6B have been described with reference to an AP, a relay, and a STA, the present disclosure may not be limited thereto. In an embodiment, the same may be equally applicable to the case where frame transmission is relayed through a relay in communication between STAs. In another embodiment, the same may be equally applicable to the case where frame transmission is relayed through a relay in communication between APs. In another embodiment, the same may be equally applicable to the case where a STA performs uplink transmission to an AP through a relay, and the present disclosure may not be limited to any specific form.

In FIG. 6A and FIG. 6B, the configuration of the relay communication operation by AP 1-1 (640) of AP MLD 1 (or AP MLD 1, AP), STA 1-1 of STA MLD 1 (or STA MLD 1, STA), and Relay 1-1 (650) of relay MLD 1 of relay MLD 1 (or relay MLD 1, STA) may be performed based on the determination of the machine learning unit described in FIG. 1 through FIG. 4. In an embodiment, the machine learning unit may determine that at least one of the AP, the relay, and the STA requires a relay communication operation, and the procedure of determining the relay that performs the relay communication operation may be performed by the machine learning unit. In another embodiment, when a plurality of relays exist in a wireless LAN network, the machine learning unit of the AP or STA may determine that a relay communication operation is required using signal strength and the like as input. When it is determined that a relay communication operation is required, the machine learning unit may select the most suitable relay for the relay communication operation using the signal strengths of the plurality of relays as input. After configuring the relay communication operation with the most suitable relay, the relay communication operation(s) described in FIG. 6A and FIG. 6B may be performed.

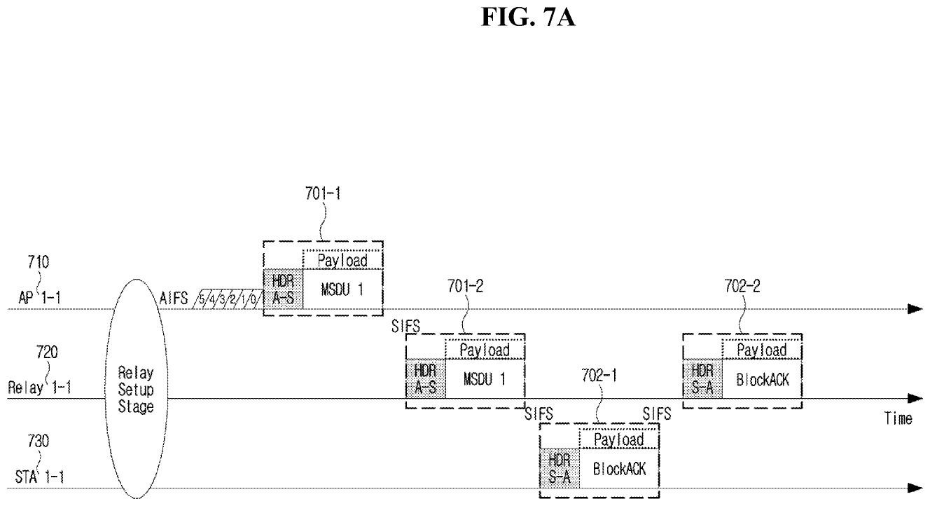

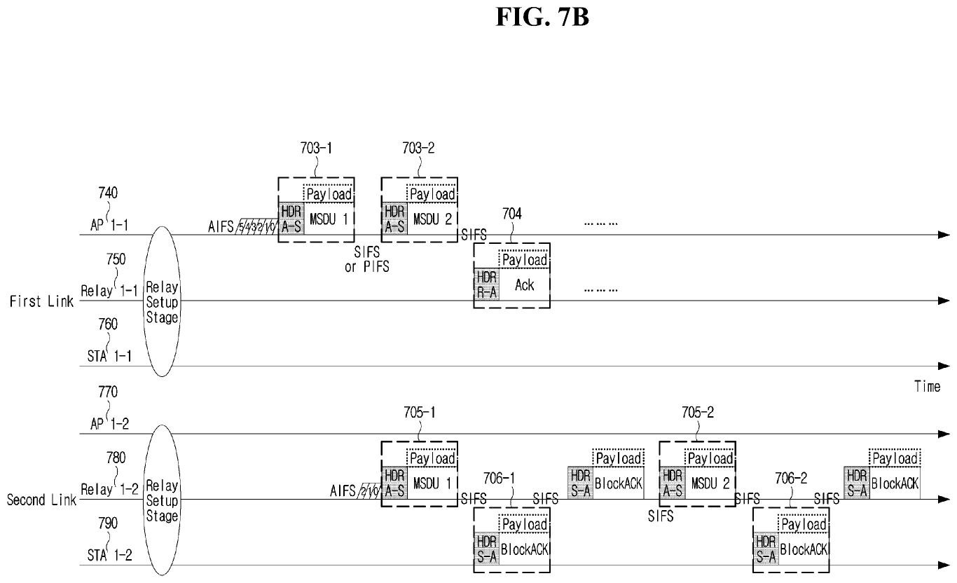

FIG. 7A and FIG. 7B are diagrams illustrating a method of performing a relay communication operation to which the present disclosure is applied. Referring to FIG. 7A and FIG. 7B, wireless LAN terminals (In an embodiment, an access point (AP), a relay (Relay STA), and a station (STA)) may operate in a wireless LAN network. In an embodiment, the case where AP 1-1 (710), Relay 1-1 (720), and STA 1-1 (730) operate in a wireless LAN network may be considered in FIG. 7A, but this is for convenience of explanation only and may not be limited thereto. In addition, in FIG. 7B, the AP, relay, and STA may be multi-link devices (MLDs) supporting multi-link operation and may be referred to as an AP MLD, a relay MLD, and a STA MLD, respectively. An MLD may be a wireless LAN terminal that separately has a MAC layer (MLD lower MAC sublayer) and a PHY layer for each link (In an embodiment, a first link, a second link, etc.). Above the per-link MAC layer of the MLD, a MAC layer (MLD upper MAC sublayer) that integrates the per-link MAC layers may exist. Here, per-link APs or STAs may operate under the AP MLD, STA MLD, and relay MLD. In an embodiment, the AP of AP MLD 1 operating on the first link may be referred to as AP 1-1 of AP MLD 1, and the AP of AP MLD 1 operating on the second link may be referred to as AP 1-2 of AP MLD 1. In addition, the STA of STA MLD 1 operating on the first link may be referred to as STA 1-1 of STA MLD 1, and the STA of STA MLD 1 operating on the second link may be referred to as STA 1-2 of STA MLD 1. In addition, the relay of relay MLD 1 operating on the first link may be referred to as Relay 1-1 of relay MLD 1, and the relay of relay MLD 1 operating on the second link may be referred to as Relay 1-2 of relay MLD 1. The operations of the APs or STAs under the MLD may be operations of the MLD, and the operations of the MLD may be operations of the subordinate APs or STAs. FIG. 7B is merely an example for convenience of explanation and may not be limited to such operations.

Referring to FIG. 7A, AP 1-1 (710), Relay 1-1 (720), and STA 1-1 (730) may perform configuration for a relay communication operation in advance. That is, in FIG. 7A, AP 1-1 (710), Relay 1-1 (720), and STA 1-1 (730) may complete the configuration for a relay communication operation in advance. AP 1-1 (710), Relay 1-1 (720), and STA 1-1 (730) may be aware that a relay communication operation is to be performed through the aforementioned configuration. AP 1-1 (710) may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (730). The channel access operation may be an enhanced distributed channel access (EDCA) backoff operation and an EDCA transmission opportunity (TXOP) acquisition procedure. In the EDCA backoff operation, AP 1-1 (710) may decrement the backoff counter when the medium is detected as idle, and may transmit a frame at the slot boundary at which the backoff counter reaches 0. In another embodiment, AP 1-1 (710) may intend to transmit a frame to STA 1-1 (730) within an EDCA transmission opportunity (TXOP), which is a communication period during which a plurality of frames may be transmitted, having previously succeeded in the channel access operation. The duration of the MAC header corresponding to the TXOP established by AP 1-1 (710) may be set to a duration equal to or longer than the sum of the data frame transmission time from AP 1-1 (710) to Relay 1-1 (720), the frame transmission time from Relay 1-1 (720) to STA 1-1 (730), the response frame (BlockAck) transmission time of STA 1-1 (730), the response frame transmission time of Relay 1-1 (720), and the inter-frame interval (In an embodiment, SIFS duration) between each frame transmission.

The transmitter address of the MAC header included in the frame transmitted by AP 1-1 (710) may be set to the MAC address of AP 1-1 (710), and the receiver address may be set to the MAC address of STA 1-1 (730). AP 1-1 (710) may transmit a frame wherein the MSDU (In an embodiment, MSDU 1), for which STA 1-1 (730) is the recipient, is the payload.

The MAC header included in the frame transmitted by AP 1-1 (710) may include an indicator indicating that the frame is transmitted (In an embodiment, relayed) through Relay 1-1 (720). The indicator indicating that the frame is relayed through Relay 1-1 (720) may be the MAC address of the relay included in the address field of the MAC header (In an embodiment, the MAC address of Relay 1-1 (720) included in the Address 4 field). That is, when the MAC address of the relay is included in the address field of the MAC header, the frame may be indicated as being relayed through Relay 1-1 (720). Alternatively, the indicator indicating that the frame is relayed through Relay 1-1 (720) may be set as a separate subfield or bit (In an embodiment, an indicator included in the HT Control field) to indicate whether the frame is relayed through Relay 1-1 (720).

In another embodiment, since AP 1-1 (710), STA 1-1 (730), and Relay 1-1 (720) have configured the relay communication operation in advance, Relay 1-1 (720) may be aware that the frame transmitted by AP 1-1 (710) to STA 1-1 (730) is to be relayed. In consideration of the foregoing, the indicator indicating that the frame is to be relayed may be unnecessary, and the MAC header of the frame transmitted by AP 1-1 (710) may not include such an indicator.

Referring to FIG. 7A, Relay 1-1 (720) may receive the frame (701-1) from AP 1-1 (710). Relay 1-1 (720) may transmit the same frame (701-2) of AP 1-1 (710) after a SIFS duration from the completion of reception of the frame transmitted by AP 1-1 (710). The transmission of the same frame of AP 1-1 (710) by Relay 1-1 (720) may mean transmitting identically the bits obtained based on the result of decoding and error correction of the frame of AP 1-1 (710) by Relay 1-1 (720). Alternatively, it may mean that Relay 1-1 (720) duplicates the frame of AP 1-1 (710), but may not be limited thereto. Since Relay 1-1 (720) transmits the frame after a SIFS duration, AP 1-1 (710) may regard the frame of Relay 1-1 (720) as an immediate response frame. In an embodiment, Relay 1-1 (720) may not be able to transmit frames due to the network allocation vector (NAV) corresponding to the TXOP obtained by AP 1-1 (710). However, Relay 1-1 (720) may regard the frame as an immediate response frame to the frame of AP 1-1 (710). Alternatively, Relay 1-1 (720) may not set the NAV for a frame wherein the receiver address is STA 1-1 (730). Accordingly, Relay 1-1 (720) may transmit the frame (701-2) to STA 1-1 (730) regardless of the NAV setting. Here, AP 1-1 (710) may not update the BlockAck scoreboard of AP 1-1 (710) until it receives the response frame (In an embodiment, a BlockAck frame) from STA 1-1 (730). That is, AP 1-1 (710) does not determine that the receiver of the frame has received the frame.

STA 1-1 (730) may receive the frame (701-2) from Relay 1-1 (720). STA 1-1 (730) may recognize that the frame is received through Relay 1-1 (720) based on the indicator indicating that the frame is relayed and transmitted, or based on the configured relay communication operation. STA 1-1 (730) may transmit a response frame (702-1) to AP 1-1 (710) after a SIFS duration from the completion of reception of the frame (701-2) of Relay 1-1 (720). The response frame (702-1) may be a BlockAck (BA) frame indicating the reception status of the frame transmitted by AP 1-1 (710). STA 1-1 (730) may set the transmitter address of the MAC header of the original response frame (702-1) to the MAC address of STA 1-1 (730) and set the receiver address to the MAC address of AP 1-1 (710). The MAC header included in the original response frame (702-1) transmitted by STA 1-1 (730) may include an indicator indicating that the frame is transmitted (In an embodiment, relayed) through Relay 1-1 (720). In an embodiment, the indicator indicating that the frame is relayed through Relay 1-1 (720) may be the MAC address of the relay included in the address field of the MAC header (In an embodiment, the MAC address of Relay 1-1 (720) included in the Address 4 field). That is, when the MAC address of the relay is included in the address field of the MAC header, the frame may be indicated as being relayed through Relay 1-1 (720). Alternatively, the indicator indicating that the frame is relayed through Relay 1-1 (720) may be set as a separate subfield or bit (In an embodiment, an indicator included in the HT Control field) to indicate whether the frame is to be relayed. In another embodiment, since AP 1-1 (710), STA 1-1 (730), and Relay 1-1 (720) have configured the relay communication operation in advance, Relay 1-1 (720) may be aware that the frame transmitted by STA 1-1 (730) to AP 1-1 (710) is to be relayed. In consideration of the foregoing, the indicator indicating that the frame is to be relayed may be unnecessary. Accordingly, the MAC header of the frame transmitted by STA 1-1 (730) may not include an indicator indicating that the frame is to be relayed.

Relay 1-1 (720) may receive a frame (response frame, BlockAck frame, 702-1) from STA 1-1 (730). Relay 1-1 (720) may transmit the same response frame (702-2) to AP 1-1 (710) after a SIFS duration from the completion of reception of the frame (702-1) from STA 1-1 (730).

Relay 1-1 (720) may also perform an operation of modifying the MAC header of the original response frame of STA 1-1 (730) to include an indicator indicating that the response frame is being transmitted after being relayed by Relay 1-1 (720). AP 1-1 (710) may receive the response frame of STA 1-1 (730) through Relay 1-1 (720). AP 1-1 (710) may verify the reception status of the frame transmitted by AP 1-1 (710) to STA 1-1 (730). AP 1-1 (710) may update the BlockAck scoreboard based on the response frame (In an embodiment, a BlockAck frame) from STA 1-1 (730), and may retransmit a frame if a frame whose transmission has failed exists.

In an embodiment, an error may exist in the frame received by Relay 1-1 (720) from AP 1-1 (710). Relay 1-1 (720) may not transmit the frame containing the error to STA 1-1 (730), and may not respond to AP 1-1 (710) or may transmit a frame requesting retransmission of the frame from AP 1-1 (710) (In an embodiment, an ACK frame indicating NACK, or a BlockAck frame). In this case, Relay 1-1 (720) may receive the retransmission of the erroneous frame from AP 1-1 (710) and transmit the frame to STA 1-1 (730) after receiving it without error, or may discard the erroneous frame if the retransmission of the erroneous frame is not received.

In another embodiment, STA 1-1 (730) may be able to receive (decode) the frame transmitted by AP 1-1 (710). When STA 1-1 (730), AP 1-1 (710), and Relay 1-1 (720) have performed relay communication operation configuration, STA 1-1 (730) may not directly respond to AP 1-1 (710) even when it receives the frame from AP 1-1 (710).

In another embodiment, instead of transmitting the same frame to STA 1-1 (730) after a SIFS duration from the completion of reception of the data frame from AP 1-1 (710), Relay 1-1 (720) may transmit the frame to STA 1-1 (730) when the medium is in an idle state for a priority interframe space (PIFS) duration. Alternatively, Relay 1-1 (720) may transmit the frame to STA 1-1 (730) when the medium is in an idle state for a PIFS duration+ ‘a’ from the completion of reception of the data frame from AP 1-1 (710). The aforementioned operation is to verify whether the frame transmitted by AP 1-1 (710) to STA 1-1 (730) is retransmitted. When a PIFS duration+ ‘a’ has elapsed from the completion of reception of the frame, Relay 1-1 (720) may consider that AP 1-1 (710) is not retransmitting the frame and is waiting for Relay 1-1 (720) to relay the frame. Here, the ‘a’ duration may be aSlotTime, or may be shorter or longer than aSlotTime, and may not be limited to any specific form.

In another embodiment, when AP 1-1 (710) performs transmission to STA 1-1 (730) through Relay 1-1 (720), AP 1-1 (710) may not perform a PIFS recovery operation. That is, even when AP 1-1 (710) transmits a frame and no response frame is received until after a PIFS duration, AP 1-1 (710) may not perform frame retransmission. The aforementioned operations may be operations for preventing transmission collisions with the frame transmitted by Relay 1-1 (720) to STA 1-1 (730).

In another embodiment, the case where STA 1-1 (730) is able to receive (decode) the frame from AP 1-1 (710) may be considered. When STA 1-1 (730), AP 1-1 (710), and Relay 1-1 (720) have performed relay communication operation configuration, STA 1-1 (730) may store the received frame in a buffer upon receiving the frame from AP 1-1 (710) and may not directly respond to AP 1-1 (710). Here, STA 1-1 (730) may additionally receive a data frame transmitted through Relay 1-1 (720). STA 1-1 (730) may reconstruct the data frame using the data frame received from AP 1-1 (710) and the data frame received from Relay 1-1 (720). In an embodiment, when the received data frame is an A-MPDU, the erroneous MPDUs of the A-MPDU received from AP 1-1 (710) and the A-MPDU received from Relay 1-1 (720) may differ. STA 1-1 (730) may recover the data frame through the error-free MPDUs, and may generate a response frame (BlockAck) based on the recovered data frame and transmit it to AP 1-1 (710) through Relay 1-1 (720).

Referring to FIG. 7B, AP MLD 1, relay MLD 1, and STA MLD 1 may perform configuration for a relay communication operation in advance. Through this, AP MLD 1, relay MLD 1, and STA MLD 1 may be aware that a relay communication operation is to be performed. AP 1-1 (740) of AP MLD 1 operating on the first link may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (760) of STA MLD 1. The channel access operation may be an enhanced distributed channel access (EDCA) backoff operation and an EDCA transmission opportunity (TXOP) acquisition procedure. In the EDCA backoff operation, AP 1-1 (740) of AP MLD 1 may decrement the backoff counter when the medium is detected as idle, and may transmit a frame at the slot boundary at which the backoff counter reaches 0. In another embodiment, AP 1-1 (740) of AP MLD 1 may intend to transmit a frame to STA 1-1 (760) of the STA MLD within an EDCA transmission opportunity (TXOP), which is a communication period during which a plurality of frames may be transmitted, having previously succeeded in the channel access operation. The duration of the MAC header corresponding to the TXOP established by AP 1-1 (740) of AP MLD 1 may be set to a duration equal to or longer than the sum of the transmission time of one or more data frames transmitted from AP 1-1 (740) of AP MLD 1 to Relay 1-1 (750) of relay MLD, the response frame (BlockAck) transmission time of Relay 1-1 (750) of relay MLD, and the inter-frame interval (In an embodiment, SIFS duration) between each frame transmission.

The transmitter address of the MAC header included in the frame transmitted by AP 1-1 (740) of AP MLD 1 may be set to the MAC address of AP 1-1 (740) of AP MLD 1, and the receiver address may be set to the MAC address of STA 1-1 (760) of STA MLD 1. The payload included in the original frame to be transmitted by AP 1-1 (740) of AP MLD 1 may be the MSDU for which STA 1-1 (760) of STA MLD 1 is the recipient.

AP 1-1 (740) of AP MLD 1 may transmit the frame. The MAC header included in the frame transmitted by AP 1-1 (740) of AP MLD 1 may include an indicator indicating that the frame is transmitted (In an embodiment, relayed) through relay MLD 1. The indicator indicating that the frame is relayed through relay MLD 1 may be the MAC address of the relay included in the address field of the MAC header (In an embodiment, the MAC address of at least one of relay MLD 1, Relay 1-1 of relay MLD 1, and Relay 1-2 of relay MLD 1 included in the Address 4 field). That is, when the MAC address of relay MLD 1 is included in the address field of the MAC header, the frame may be indicated as being relayed through relay MLD 1. Alternatively, the indicator indicating that the frame is relayed through relay MLD 1 may be set as a separate subfield or bit (In an embodiment, an indicator included in the HT Control field) to indicate whether the frame is relayed through relay MLD 1. In another embodiment, since AP MLD 1, STA MLD 1, and relay MLD 1 have configured the relay communication operation in advance, Relay 1-1 (750) of relay MLD 1 may be aware that the frame transmitted by AP 1-1 (740) of AP MLD 1 to STA 1-1 (760) of STA MLD 1 is to be relayed. In consideration of the foregoing, the indicator indicating that the frame is to be relayed may be unnecessary, and the MAC header of the frame transmitted by AP 1-1 (740) of AP MLD 1 may not include such an indicator.

Relay 1-1 (750) of relay MLD 1 may receive the frame from AP 1-1 (740) of AP MLD 1. Relay MLD 1 may intend to transmit the received frame to STA MLD 1 on the second link. That is, relay MLD 1 may intend to transmit the frame received on the first link to STA 1-2 (790) of STA MLD 1 through Relay 1-2 (780) of relay MLD 1 on the second link. In another embodiment, the case where the first link is in a busy state after relay MLD 1 receives the frame transmitted from AP MLD 1 to STA MLD 1 on the first link may be considered. Among the first link and second link available to relay MLD 1, relay MLD 1 may be aware that the second link is in an idle state, or that the busy state of the second link ends sooner than that of the first link. Accordingly, relay MLD 1 may not be able to transmit the frame from Relay 1-1 (750) of relay MLD 1 to STA 1-1 (760) of STA MLD 1 on the first link. In the aforementioned situation, relay MLD 1 may intend to transmit the frame to STA 1-2 (790) of STA MLD 1 through Relay 1-2 (780) of relay MLD 1 on the second link, but may not be limited to such an embodiment.

When relay MLD 1 successfully decodes MSDU 1, Relay 1-2 (780) of relay MLD 1 may immediately perform a channel access operation (EDCA backoff operation, EDCA TXOP acquisition procedure) on the second link. When the channel access operation of Relay 1-2 (780) of relay MLD 1 is successful, an EDCA TXOP, which is a communication period on the second link, may be obtained. Alternatively, when relay MLD 1 detects a frame being transmitted on the first link, Relay 1-2 (780) of relay MLD 1 may immediately perform a channel access operation. Relay 1-2 (780) of relay MLD 1 may wait without transmitting a frame until the decoding of MSDU 1 is successfully completed. The duration of the MAC header corresponding to the TXOP established by Relay 1-2 (780) of relay MLD 1 may be set to a duration equal to or longer than the sum of the transmission time of one or more data frames transmitted from Relay 1-2 (780) of relay MLD 1 to STA 1-2 (790) of STA MLD 1, the response frame (BlockAck) transmission time of STA 1-2 (790) of STA MLD 1, the time for Relay 1-2 (780) of relay MLD 1 to transmit the response frame of STA 1-2 (790) of STA MLD 1, and the inter-frame interval (In an embodiment, SIFS duration) between each frame transmission.

The EDCA TXOP of Relay 1-2 (780) of relay MLD 1 may be used by Relay 1-2 (780) of relay MLD 1 to transmit the frame of AP MLD 1 to STA MLD 1. Relay MLD 1 may transmit the same frame as the frame received from AP 1-1 (740) of AP MLD 1. This may mean that relay MLD 1 performs decoding and error correction on the frame of AP MLD 1 and identically transmits the bits obtained through the result. After completing reception of the frame transmitted by AP 1-1 (740) of AP MLD 1 on the first link, relay MLD 1 may transmit a frame identical to the frame of AP 1-1 (740) of AP MLD 1 to STA 1-2 (790) of STA MLD 1 within the TXOP on the second link. Relay MLD 1 may further perform an operation of adding an indicator to the MAC header of the original frame transmitted by AP 1-1 (740) of AP MLD 1 to indicate that the frame has been relayed and transmitted. In another embodiment, since AP MLD 1, STA MLD 1, and relay MLD 1 have configured the relay communication operation in advance, STA 1-2 (790) of STA MLD 1 may be aware of the frame transmitted by Relay 1-2 (780) of relay MLD 1 to STA 1-2 (790) of STA MLD 1. Accordingly, a separate indicator may be unnecessary.

STA 1-2 (790) of STA MLD 1 may receive the frame from Relay 1-2 (780) of relay MLD 1. STA 1-2 (790) of STA MLD 1 may recognize that the frame of Relay 1-2 (780) of relay MLD 1 has been relayed based on the indicator indicating that the frame has been relayed or the configured relay communication operation. STA 1-2 (790) of STA MLD 1 may receive (decode) MSDU 1, which is the payload of the frame of AP 1-1 (740) of AP MLD 1.

In an embodiment, AP 1-1 (740) of AP MLD 1 on the first link may transmit a single frame or a plurality of frames at predetermined time intervals within the TXOP as shown in Table 4 below.

TABLE 4

Transmitting a single frame
Transmitting a plurality of frames at predetermined intervals
(In an embodiment, SIFS or PIFS intervals)

When AP 1-1 (740) of AP MLD 1 transmits a single frame, Relay 1-1 (750) of relay MLD 1 may receive the frame (a frame wherein the receiver address is STA 1-1 of STA MLD 1) from AP 1-1 (740) of AP MLD 1. In response to the frame transmitted by AP 1-1 (740) of AP MLD 1 to STA 1-1 (760) of STA MLD 1, Relay 1-1 (750) of relay MLD 1 may transmit an ACK frame to AP 1-1 (740) of AP MLD 1. AP 1-1 (740) of AP MLD 1 may regard the ACK frame of Relay 1-1 (750) of relay MLD 1 as an immediate response frame, but may not update the BlockAck scoreboard. That is, AP 1-1 (740) does not determine that the receiver of the frame has received the frame. In an embodiment, Relay 1-1 (750) of relay MLD 1 may not be able to transmit frames due to the NAV corresponding to the TXOP obtained by AP 1-1 (740) of AP MLD 1. However, Relay 1-1 (750) of relay MLD may regard the ACK frame as an immediate response frame to the frame of AP 1-1 (740) of AP MLD 1. Accordingly, Relay 1-1 (750) of relay MLD may transmit the ACK frame to AP 1-1 (740) of AP MLD 1 regardless of the NAV setting.

Relay 1-2 (780) of relay MLD 1 may decode the frame transmitted by AP 1-1 (740) of AP MLD 1 and transmit the same frame to STA 1-2 (790) of STA MLD 1. STA 1-2 (790) of STA MLD 1 may receive the frame from AP 1-1 (740) of AP MLD 1 and receive the payload (In an embodiment, MSDU 1). STA 1-2 (790) of STA MLD 1 may transmit a response frame (In an embodiment, a BlockAck frame) to Relay 1-2 (780) of relay MLD 1.

In another embodiment, the case where AP 1-1 (740) of AP MLD 1 transmits a plurality of frames (703-1, 703-2) at predetermined intervals may be considered. Relay 1-1 (750) of relay MLD 1 may receive a plurality of frames (703-1, 703-2), wherein the receiver address is STA 1-1 (760) of STA MLD 1, from AP MLD 1 at predetermined time intervals. Relay 1-1 (750) of relay MLD 1 may decode the plurality of frames (703-1, 703-2) received from AP 1-1 (740) of AP MLD 1. When the frames of AP 1-1 (740) of AP MLD 1 are transmitted at PIFS intervals, which are longer than SIFS by aSlotTime, Relay 1-1 (750) of relay MLD 1 may transmit an ACK frame to AP 1-1 (740) of AP MLD 1 after a SIFS duration from the completion of frame reception. Alternatively, the method of transmitting the response frame from Relay 1-1 (750) of relay MLD 1 to AP 1-1 (740) of AP MLD 1 may differ depending on the Ack Policy setting of the frame transmitted by AP MLD 1 to Relay 1-1 (750) of relay MLD 1. The Ack Policy of frames other than the last frame transmitted by AP 1-1 (740) of AP MLD 1 to Relay 1-1 (750) of relay MLD 1 may be set to BlockAck, which does not require immediate transmission of a response frame, or may be set to No Ack Policy or the like. The interval between frames other than the last frame transmitted by AP 1-1 (740) of AP MLD 1 to Relay 1-1 (750) of relay MLD 1 may be SIFS. The Ack Policy of the last frame transmitted by AP 1-1 (740) of AP MLD 1 to Relay 1-1 (750) of relay MLD 1 may be set to Implicit BAR. When Relay 1-1 (750) of relay MLD 1 receives the last frame received from AP 1-1 (740) of AP MLD 1, Relay 1-1 transmits a response frame (BlockAck frame, ACK frame) to AP 1-1 (740) of AP MLD 1 after a SIFS duration. In another embodiment, referring to FIG. 7B, AP 1-1 (740) of AP MLD 1 may include an indicator indicating the last frame in the last transmitted frame (706-3) among the plurality of frames (703-1, 703-2). The indicator indicating the last frame may be setting the value of the More Data subfield of the Frame Control field to 0. Upon receiving the frame containing the indicator indicating the last frame, Relay 1-1 (750) of relay MLD 1 may transmit an ACK frame (704) to AP 1-1 (740) of AP MLD 1 after a SIFS duration from the completion of reception of the last frame (703-2). AP 1-1 (740) of AP MLD 1 may regard the ACK frame (704) of Relay 1-1 (750) of relay MLD 1 as an immediate response frame, but may not update the BlockAck scoreboard. That is, AP 1-1 (740) does not determine that the receiver of the frame has received the frame.

In an embodiment, Relay 1-1 (750) of relay MLD 1 may not be able to transmit frames due to the NAV corresponding to the TXOP obtained by AP 1-1 (740) of AP MLD 1. However, the ACK frame (704) transmitted by Relay 1-1 (750) of relay MLD 1 may be regarded as an immediate response frame to the frame of AP 1-1 (740) of AP MLD 1. Accordingly, Relay 1-1 (750) of relay MLD 1 may transmit the ACK frame (704) regardless of the NAV setting. Referring to FIG. 7B, Relay 1-2 (780) of relay MLD 1 on the second link may transmit the frames decoded by Relay 1-1 (750) of relay MLD 1 to STA 1-2 (790) of STA MLD 1. In an embodiment, STA 1-2 (790) of STA MLD 1 may individually transmit a response frame (In an embodiment, BlockAck frames, 706-1, 706-2) for each of the frames (705-1, 705-2) transmitted by Relay 1-2 (780) of relay MLD 1. The Ack Policy of each of the encapsulated frames (705-1, 705-2, 705-3) may be set to Implicit BAR requesting a BlockAck frame. In another embodiment, after Relay 1-2 (780) of relay MLD 1 transmits a plurality of frames (705-1, 705-2), STA 1-2 (790) of STA MLD 1 may transmit a single response frame for the plurality of frames (705-1, 705-2). The Ack Policy of some of the encapsulated frames (705-1, 705-2) may be set to BlockAck, which does not immediately require a BlockAck frame, and the Ack Policy of the last encapsulated frame (705-3) may be set to Implicit BAR requesting a BlockAck frame.

Based on the operations of Table 4 described above, STA 1-2 (790) of STA MLD 1 may transmit a response frame to Relay 1-2 (780) of relay MLD 1. The response frame may be a BlockAck (BA) frame indicating the reception status of the frame transmitted by AP 1-1 (740) of AP MLD 1. STA 1-2 (790) of STA MLD 1 may set the transmitter address of the MAC header of the response frame to the MAC address of STA 1-2 (790) of STA MLD 1, and may set the receiver address to the MAC address of at least one of AP 1-1 (740) of AP MLD 1, AP 1-2 of AP MLD 1, and AP MLD 1. The MAC header included in the response frame transmitted by STA 1-2 (790) of STA MLD 1 may include an indicator indicating that the frame is transmitted (In an embodiment, relayed) through Relay 1-2 (780) of relay MLD 1 (i.e., relay MLD 1). The indicator indicating that the frame is relayed through relay MLD 1 may be the MAC address of the relay included in the address field of the MAC header (In an embodiment, the MAC address of at least one of relay MLD 1, Relay 1-1 of relay MLD 1, and Relay 1-2 of relay MLD 1 included in the Address 4 field). Alternatively, the indicator indicating that the frame is relayed through relay MLD 1 may be set as a separate subfield or bit (In an embodiment, an indicator included in the HT Control field). In another embodiment, since AP MLD 1, STA MLD 1, and relay MLD 1 have configured the relay communication operation in advance, relay MLD 1 may be aware that the frame transmitted by STA MLD 1 to AP MLD 1 is to be relayed. Accordingly, the indicator indicating that the frame is to be relayed may be unnecessary. As a result, the MAC header transmitted by STA 1-2 (790) of STA MLD 1 may not include an indicator indicating that the frame is to be relayed. Relay 1-2 (780) of relay MLD 1 may receive a frame (response frame, BlockAck frame) from STA 1-2 (790) of STA MLD 1. Relay MLD 1 may transmit the response frame of STA 1-2 (790) of STA MLD 1 to AP 1-1 (740) of AP MLD 1 using Relay 1-1 (750) of relay MLD 1 on the first link. Alternatively, relay MLD 1 may transmit the response frame to AP 1-2 (770) of AP MLD 1 through Relay 1-2 (780) of relay MLD 1 on the second link.

Relay 1-2 (780) of relay MLD 1 may perform an operation of modifying the MAC header of the response frame of STA 1-2 (790) of STA MLD 1 to include an indicator indicating that the response frame is being transmitted after being relayed by relay MLD 1. After completing reception of the frame from STA 1-2 (790) of STA MLD 1, relay MLD 1 may transmit a response frame identical to the frame transmitted by STA 1-2 (790) of STA MLD 1 to AP 1-2 (770) of AP MLD 1 after a SIFS duration. Alternatively, Relay 1-2 (780) of relay MLD 1 may perform a channel access operation (EDCA backoff operation, EDCA TXOP acquisition procedure) on the second link, and when the channel access operation is completed, may transmit a response frame identical to the frame transmitted by STA 1-2 (790) of STA MLD 1 to AP 1-2 (770) of AP MLD 1. AP MLD 1 may receive the response frame of STA MLD 1 through relay MLD 1. AP MLD 1 may verify the reception status of the frame transmitted to STA MLD 1. AP MLD 1 may update the BlockAck scoreboard based on the response frame (In an embodiment, a BlockAck frame) from STA MLD 1, and may retransmit a frame if a frame whose transmission has failed exists.

In addition, in an embodiment, an error may exist in the frame received by relay MLD 1 (i.e., Relay 1-1 (750) of relay MLD 1) from AP MLD 1 (i.e., AP 1-1 (740) of AP MLD 1). Relay MLD 1 may not transmit the frame containing the error to STA MLD 1. Relay MLD 1 may not respond to AP MLD 1 or may transmit a frame requesting retransmission of the frame from AP MLD 1 (In an embodiment, an ACK frame indicating NACK, or a BlockAck frame). In this case, relay MLD 1 may receive the retransmission of the erroneous frame from AP 1-1 (740) of AP MLD 1 and transmit the frame to STA MLD 1 after receiving it without error, or may discard the erroneous frame if the retransmission of the erroneous frame is not received.

STA MLD 1 (i.e., STA 1-1 (760) of STA MLD 1) may be able to receive (decode) the frame from AP MLD 1 (i.e., AP 1-1 (740) of AP MLD 1). When STA MLD 1, AP MLD 1, and relay MLD 1 have performed relay communication operation configuration, STA 1-1 (760) of STA MLD 1 may not directly respond to AP 1-1 (740) of AP MLD 1 even when it receives the frame from AP 1-1 (740) of AP MLD 1.

In another embodiment, STA 1-1 (760) of STA MLD 1 (i.e., STA MLD 1) may be able to receive (decode) the frame from AP 1-1 (740) of AP MLD 1 (i.e., AP MLD 1). When STA MLD 1, AP MLD 1, and relay MLD 1 have performed relay communication operation configuration, STA 1-1 (760) of STA MLD 1 may store the received frame in a buffer upon receiving the frame from AP 1-1 (740) of AP MLD 1 and may not directly respond to AP MLD 1. STA 1-1 (760) of STA MLD 1 may additionally receive a data frame transmitted through relay MLD 1. STA MLD 1 may reconstruct the data frame using the data frame received from AP 1-1 (740) of AP MLD 1 and the data frame received from Relay 1-2 (780) of relay MLD 1 of relay MLD 1. Here, when the received data frame is an A-MPDU, the erroneous MPDUs of the A-MPDU received from AP 1-1 (740) of AP MLD 1 and the A-MPDU received from Relay 1-2 (780) of relay MLD 1 may differ. STA MLD 1 may recover the data frame through the error-free MPDUs, and may generate a response frame (BlockAck) based on the recovered data frame and transmit it to AP MLD 1 through relay MLD 1.

In FIG. 7A and FIG. 7B, the configuration of the relay communication operation by AP 1-1 (740) of AP MLD 1 (or AP MLD 1, AP), STA 1-1 of STA MLD 1 (or STA MLD 1, STA), and Relay 1-1 (750) of relay MLD 1 of relay MLD 1 (or relay MLD 1, STA) may be performed based on the determination of the machine learning unit described in FIG. 1 through FIG. 4. In an embodiment, the machine learning unit may determine that at least one of the AP, the relay, and the STA requires a relay communication operation, and the procedure of determining the relay that performs the relay communication operation may be performed by the machine learning unit. In another embodiment, when a plurality of relays exist in a wireless LAN network, the machine learning unit of the AP or STA may determine that a relay communication operation is required using signal strength and the like as input. When it is determined that a relay communication operation is required, the machine learning unit may select the most suitable relay for the relay communication operation using the signal strengths of the plurality of relays as input. After configuring the relay communication operation with the most suitable relay, the relay communication operation(s) described in FIG. 7A and FIG. 7B may be performed.

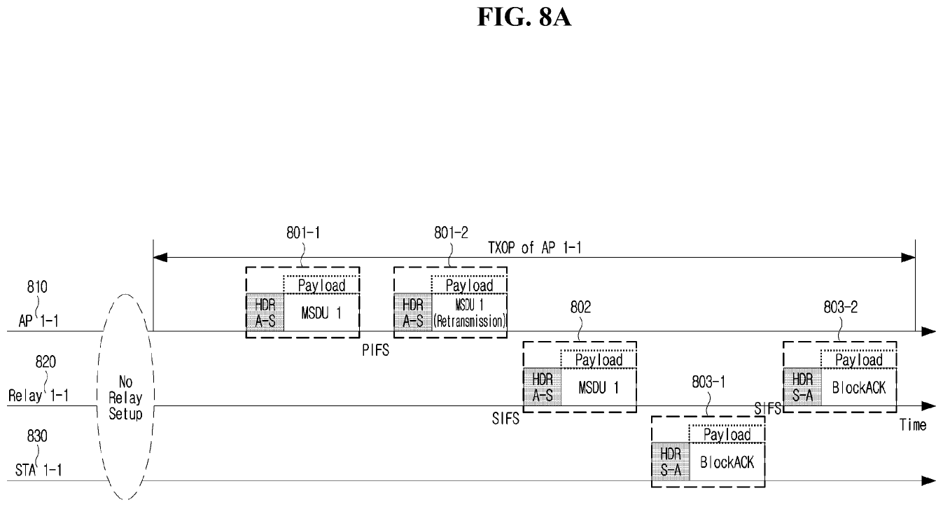

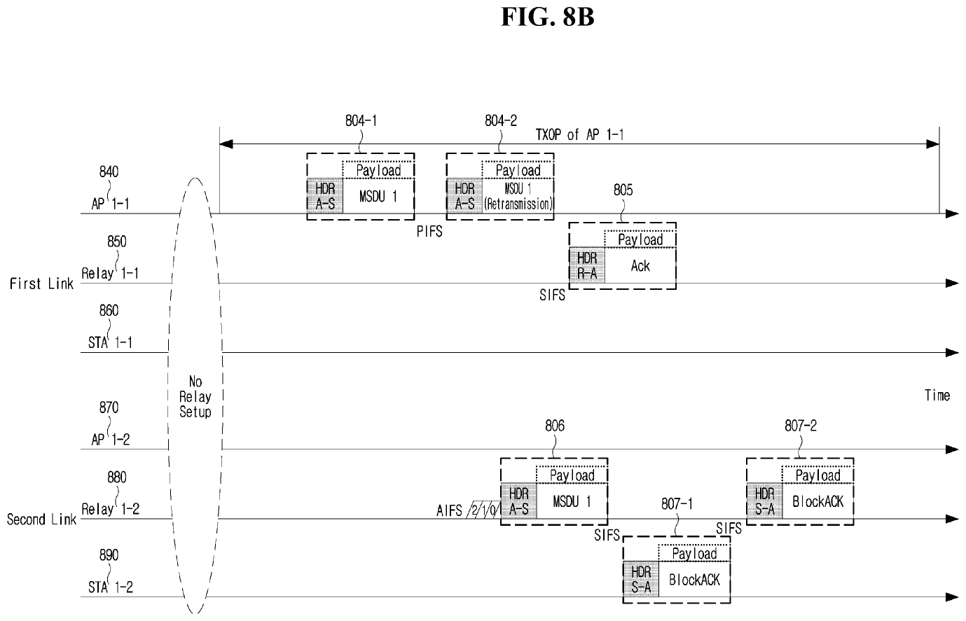

FIG. 8A and FIG. 8B are diagrams illustrating a method of performing a relay communication operation to which the present disclosure is applied. Referring to FIG. 8A and FIG. 8B, wireless LAN terminals (In an embodiment, an access point (AP), a relay (Relay STA), and a station (STA)) may operate in a wireless LAN network. In an embodiment, the case where AP 1-1 (810), Relay 1-1 (820), and STA 1-1 (830) operate in a wireless LAN network may be considered in FIG. 8A, but this is for convenience of explanation only and may not be limited thereto. In addition, in FIG. 8B, the AP, relay, and STA may be multi-link devices (MLDs) supporting multi-link operation and may be referred to as an AP MLD, a relay MLD, and a STA MLD, respectively. An MLD may be a wireless LAN terminal that separately has a MAC layer (MLD lower MAC sublayer) and a PHY layer for each link (In an embodiment, a first link, a second link, etc.). Above the per-link MAC layer of the MLD, a MAC layer (MLD upper MAC sublayer) that integrates the per-link MAC layers may exist. Here, per-link APs or STAs may operate under the AP MLD, STA MLD, and relay MLD. In an embodiment, the AP of AP MLD 1 operating on the first link may be referred to as AP 1-1 of AP MLD 1, and the AP of AP MLD 1 operating on the second link may be referred to as AP 1-2 of AP MLD 1. In addition, the STA of STA MLD 1 operating on the first link may be referred to as STA 1-1 of STA MLD 1, and the STA of STA MLD 1 operating on the second link may be referred to as STA 1-2 of STA MLD 1. In addition, the relay of relay MLD 1 operating on the first link may be referred to as Relay 1-1 of relay MLD 1, and the relay of relay MLD 1 operating on the second link may be referred to as Relay 1-2 of relay MLD 1. The operations of the APs or STAs under the MLD may be operations of the MLD, and the operations of the MLD may be operations of the subordinate APs or STAs. FIG. 8B is merely an example for convenience of explanation and may not be limited to such operations.

Referring to FIG. 8A, AP 1-1 (810), Relay 1-1 (820), and STA 1-1 (830) may not perform configuration for a relay communication operation in advance. Relay 1-1 (820) may recognize that communication with AP 1-1 (810) and STA 1-1 (830) is possible since it is able to receive frames from AP 1-1 (810) and STA 1-1 (830). AP 1-1 (810) may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (830) and may acquire an EDCA TXOP. AP 1-1 (810) may intend to transmit a frame to STA 1-1 (830). In an embodiment, AP 1-1 (810) may successfully transmit at least one frame to another STA before transmitting the frame to STA 1-1 (830). Thereafter, AP 1-1 (810) may intend to transmit the frame to STA 1-1 (830) within the EDCA transmission opportunity (TXOP).

The transmitter address of the MAC header of the frame to be transmitted by AP 1-1 (810) may be set to the MAC address of AP 1-1 (810), and the receiver address may be set to the MAC address of STA 1-1 (830). AP 1-1 (810) may transmit a frame wherein the MSDU (In an embodiment, MSDU 1), for which STA 1-1 (830) is the recipient, is the payload. Here, STA 1-1 (830) may not be able to receive the frame from AP 1-1 (810), and Relay 1-1 (820) may receive the frame from AP 1-1 (810). After receiving the frame from AP 1-1 (810), Relay 1-1 (820) may recognize that the destination is STA 1-1 (830). However, Relay 1-1 (820) may not transmit the frame of AP 1-1 (810) to STA 1-1 (830) until AP 1-1 (810) retransmits the frame. The retransmission of the frame may be performed after a PIFS duration following the initial frame transmission.

In an embodiment, referring to FIG. 8A, when STA 1-1 (830) does not respond to the frame (801-1) of AP 1-1 (810), AP 1-1 (810) may retransmit the frame (801-2) after a PIFS duration from the completion of transmission of the frame (801-1). When AP 1-1 (810) retransmits the frame (801-2) after a PIFS duration, Relay 1-1 (820) may transmit the same frame (802) of AP 1-1 (810) to STA 1-1 (830) after a SIFS duration from the completion of transmission of the retransmitted frame of AP 1-1 (810). The transmission of the same frame (802) of AP 1-1 (810) by Relay 1-1 (820) may mean transmitting identically the bits obtained as a result of decoding and error correction of the frame of AP 1-1 (810) by Relay 1-1 (820). In an embodiment, it may mean that Relay 1-1 (820) duplicates the frame of AP 1-1 (810), but may not be limited to such an embodiment.

Relay 1-1 (820) may further include an indicator in the MAC header of the frame (802) of AP 1-1 (810) indicating that the frame is being relayed and transmitted. Since Relay 1-1 (820) transmits the frame after a SIFS duration, AP 1-1 (810) may regard the frame (802) of Relay 1-1 (820) as an immediate response frame. However, AP 1-1 (810) may not update the BlockAck scoreboard of AP 1-1 (810) until it receives the response frame (In an embodiment, a BlockAck frame) from STA 1-1 (830). That is, AP 1-1 (810) does not determine that the receiver of the frame has received the frame.

In an embodiment, Relay 1-1 (820) may not be able to transmit frames due to the network allocation vector (NAV) corresponding to the TXOP obtained by AP 1-1 (810). However, Relay 1-1 (820) may regard the frame (801-2) as an immediate response frame to the frame (801-1) of AP 1-1 (810). Accordingly, Relay 1-1 (820) may transmit the frame (802) to STA 1-1 (830) regardless of the NAV setting. Alternatively, Relay 1-1 (820) may not set the NAV upon receiving a frame wherein the receiver address is STA 1-1 (830).

STA 1-1 (830) may receive the frame (802) from Relay 1-1 (820). STA 1-1 (830) may recognize that the frame is received from AP 1-1 (810) through Relay 1-1 (820) based on the indicator indicating that the frame is relayed and transmitted. Alternatively, STA 1-1 (830) may not be aware of the existence of Relay 1-1 (820) and may recognize the frame (802) of Relay 1-1 (820) as being received from AP 1-1 (810). STA 1-1 (830) may transmit a response frame (In an embodiment, a BlockAck frame) after a SIFS duration from the completion of reception of the frame from Relay 1-1 (820). The transmitter address of the BlockAck frame transmitted by STA 1-1 (830) may be set to the MAC address of STA 1-1 (830), and the receiver address may be set to the MAC address of AP 1-1 (810). Since Relay 1-1 (820) relayed the frame, for which AP 1-1 (810) is the transmitter and STA 1-1 (830) is the destination, to STA 1-1 (830), Relay 1-1 (820) may be aware that the response frame transmitted by STA 1-1 (830) is to be relayed to AP 1-1 (810). Relay 1-1 (820) may receive the response frame (803-1) of STA 1-1 (830) and transmit the same frame (803-2) after a SIFS duration from the completion of reception of the response frame of STA 1-1 (830). Relay 1-1 (820) may also perform an operation of modifying the MAC header of the original response frame of STA 1-1 (830) to include an indicator indicating that the response frame is being transmitted after being relayed by Relay 1-1 (820). AP 1-1 (810) may receive the response frame (803-2) of STA 1-1 (830) through Relay 1-1 (820). AP 1-1 (810) may verify the reception status of the frame transmitted by AP 1-1 to STA 1-1 (830). AP 1-1 may update the BlockAck scoreboard based on the response frame (In an embodiment, a BlockAck frame) from STA 1-1 (830), and may retransmit a frame if a frame whose transmission has failed exists.

In an embodiment, an error may exist in the frame received by Relay 1-1 (820) from AP 1-1 (810). Relay 1-1 (820) may not transmit the frame containing the error to STA 1-1 (830). Relay 1-1 (820) may not respond to AP 1-1 (810) or may transmit a frame requesting retransmission of the frame from AP 1-1 (810) (In an embodiment, an ACK frame indicating NACK, or a BlockAck frame). In this case, Relay 1-1 (820) may receive the retransmission of the erroneous frame from AP 1-1 (810) and transmit the frame to STA 1-1 (830) after receiving it without error, or may discard the erroneous frame if the retransmission of the erroneous frame is not received.

In another embodiment, STA 1-1 (830) may be able to receive (decode) the frame transmitted by AP 1-1 (810). When STA 1-1 (830), AP 1-1 (810), and Relay 1-1 (820) have performed relay communication operation configuration, STA 1-1 (830) may not directly respond to AP 1-1 (810) even when it receives the frame from AP 1-1 (810).

In another embodiment, the case where STA 1-1 (830) is able to receive (decode) the frame from AP 1-1 (810) may be considered. When STA 1-1 (830), AP 1-1 (810), and Relay 1-1 (820) have performed relay communication operation configuration, STA 1-1 (830) may store the received frame in a buffer upon receiving the frame from AP 1-1 (810) and may not directly respond to AP 1-1 (810). Here, STA 1-1 (830) may additionally receive a data frame transmitted through Relay 1-1 (820). STA 1-1 (830) may reconstruct the data frame using the data frame received from AP 1-1 (810) and the data frame received from Relay 1-1 (820). In an embodiment, when the received data frame is an A-MPDU, the erroneous MPDUs of the A-MPDU received from AP 1-1 (810) and the A-MPDU received from Relay 1-1 (820) may differ. STA 1-1 (830) may recover the data frame through the error-free MPDUs, and may generate a response frame (BlockAck) based on the recovered data frame and transmit it to AP 1-1 (810) through Relay 1-1 (820).

Referring to FIG. 8B, AP MLD 1, relay MLD 1, and STA MLD 1 may not perform configuration for a relay communication operation. Here, relay MLD 1 may recognize that communication with AP MLD 1 and STA MLD 1 is possible since it is able to receive frames from AP MLD 1 and STA MLD 1. AP 1-1 (840) of AP MLD 1 operating on the first link may perform a channel access operation to transmit a frame (In an embodiment, a packet, a physical layer protocol data unit (PPDU), a MAC layer protocol data unit (MPDU), an aggregated MPDU (A-MPDU), a MAC service data unit (MSDU), or an aggregated MSDU (A-MSDU)) to STA 1-1 (860) of STA MLD 1. The channel access operation may be an enhanced distributed channel access (EDCA) backoff operation and an EDCA transmission opportunity (TXOP) acquisition procedure. In the EDCA backoff operation, AP 1-1 (840) of AP MLD 1 may decrement the backoff counter when the medium is detected as idle, and may transmit a frame at the slot boundary at which the backoff counter reaches 0. That is, AP 1-1 (840) of AP MLD 1 may acquire an EDCA transmission opportunity (TXOP), which is a communication period during which a plurality of frames may be transmitted. AP 1-1 (840) of AP MLD 1 may have successfully transmitted at least one frame to another STA within the EDCA TXOP.

AP 1-1 (840) of AP MLD 1 may intend to transmit a frame to STA 1-1 (860) of STA MLD 1 within the EDCA TXOP. The transmitter address of the MAC header of the frame to be transmitted by AP 1-1 (840) of AP MLD 1 may be set to the MAC address of AP 1-1 (840) of AP MLD 1, and the receiver address may be set to the MAC address of STA 1-1 (860) of STA MLD 1. The payload included in the frame to be transmitted by AP 1-1 (840) of AP MLD 1 may be the MSDU for which STA 1-1 (860) of STA MLD 1 is the recipient.

Referring to FIG. 8B, AP 1-1 (840) of AP MLD 1 may transmit the frame (804-1). Here, the case where STA 1-1 (860) of STA MLD 1 is unable to receive the frame (804-1) may be considered. AP MLD 1 may retransmit the frame (804-2) to STA 1-1 (860) of STA MLD 1 after a PIFS duration. Relay 1-1 (850) of relay MLD 1 may receive the frame transmitted by AP 1-1 (840) of AP MLD 1 to STA 1-1 (860) of STA MLD 1. However, Relay 1-1 (850) of relay MLD 1 may not transmit a response frame (In an embodiment, ACK frame, 805) to AP 1-1 (840) of AP MLD 1 until AP 1-1 (840) of AP MLD 1 retransmits the frame. When STA 1-1 (860) of STA MLD 1 does not respond, AP 1-1 (840) of AP MLD 1 may retransmit the frame (804-2) to STA 1-1 (860) of STA MLD 1 after a PIFS duration from the completion of frame transmission. When AP 1-1 (840) of AP MLD 1 retransmits the frame (804-2) after a PIFS duration, relay MLD 1 may transmit an ACK frame (805) to AP 1-1 (840) of AP MLD 1 (i.e., AP MLD 1) after a SIFS duration following the completion of transmission of the retransmitted frame of AP 1-1 (840) of AP MLD 1. In addition, relay MLD 1 may transmit the same frame (806) of AP 1-1 (840) of AP MLD 1 to STA 1-2 (890) of STA MLD 1 through Relay 1-2 (880) of relay MLD 1 on the second link. In an embodiment, the transmission of the same frame of AP MLD 1 by relay MLD 1 may mean transmitting identically the bits obtained as a result of decoding and error correction of the frame of AP 1-1 (840) of AP MLD 1 by relay MLD 1. Alternatively, it may mean that relay MLD 1 duplicates the frame of AP MLD 1, but may not be limited thereto.

Relay MLD 1 may further include an indicator in the MAC header of the frame of AP 1-1 (840) of AP MLD 1 indicating that the frame is being relayed and transmitted, and may transmit the frame (806) on the second link. Relay 1-2 (880) of relay MLD 1 may perform a channel access procedure on the second link. Since Relay 1-1 (850) of relay MLD 1 transmits the ACK frame (805) after a SIFS duration, AP 1-1 (840) of AP MLD 1 (i.e., AP MLD 1) may regard the frame of Relay 1-1 (850) of relay MLD 1 as an immediate response frame. However, AP MLD 1 may not update the BlockAck scoreboard of AP MLD 1 until it receives the response frame (In an embodiment, a BlockAck frame) from STA 1-1 (860) of STA MLD 1 (i.e., STA MLD 1). That is, AP MLD 1 does not determine that the receiver of the frame has received the frame.

In an embodiment, Relay 1-1 (850) of relay MLD 1 may not be able to transmit frames due to the NAV corresponding to the TXOP obtained by AP 1-1 (840) of AP MLD 1. However, Relay 1-1 (850) of relay MLD 1 may regard the ACK frame (805) as an immediate response frame to the frame of AP 1-1 (840) of AP MLD 1. Alternatively, Relay 1-1 (850) may not set the NAV for a frame wherein the receiver address is STA 1-1 (860). Accordingly, Relay 1-1 (850) of relay MLD 1 may transmit the ACK frame (805) to AP 1-1 (840) of AP MLD 1 regardless of the NAV setting.

When Relay 1-2 (880) of relay MLD 1 completes the channel access procedure on the second link, Relay 1-2 (880) of relay MLD 1 may transmit the frame (806) received from AP 1-1 (840) of AP MLD 1 to STA 1-2 (890) of STA MLD 1. Here, Relay 1-2 (880) of relay MLD 1 may acquire an EDCA TXOP. The duration of the MAC header corresponding to the TXOP established by Relay 1-2 (880) of relay MLD 1 may be set to a duration equal to or longer than the sum of the transmission time of one or more data frames transmitted from Relay 1-2 (880) of relay MLD 1 to STA 1-2 (890) of STA MLD 1, the response frame (BlockAck) transmission time of STA 1-2 (890) of STA MLD 1, the time for Relay 1-2 (880) of relay MLD 1 to transmit the response frame of STA 1-2 (890) of STA MLD 1, and the inter-frame interval (In an embodiment, SIFS duration) between each frame transmission.

STA 1-2 (890) of STA MLD 1 may receive the frame (806) from Relay 1-2 (880) of relay MLD 1. STA 1-2 (890) of STA MLD 1 may recognize that the frame is received from AP MLD 1 through relay MLD 1 based on the indicator indicating that the frame is relayed and transmitted. Alternatively, since the transmitter in the MAC header of the frame transmitted by Relay 1-2 (880) of relay MLD 1 is the MAC address of AP 1-1 (840) of AP MLD 1 rather than AP 1-2, Relay 1-2 (880) of relay MLD 1 may recognize that the frame is received through relay MLD 1. Alternatively, STA 1-2 (890) of STA MLD 1 may not be aware of the existence of relay MLD 1 and may recognize the frame of relay MLD 1 as being received from AP MLD 1. STA 1-2 (890) of STA MLD 1 may transmit a response frame (In an embodiment, a BlockAck frame, 807-1) after a SIFS duration from the completion of reception of the frame from Relay 1-2 (880) of relay MLD 1. The transmitter address of the BlockAck frame transmitted by STA 1-2 (890) of STA MLD 1 may be set to the MAC address of STA 1-2 (890) of STA MLD 1, and the receiver address may indicate the MAC address of AP MLD 1 or a subordinate AP of AP MLD 1 (In an embodiment, AP 1-2 of AP MLD 1). Since relay MLD 1 relayed the frame, for which a subordinate AP of AP MLD 1 is the transmitter and a subordinate STA of STA MLD 1 is the destination, to STA MLD 1, relay MLD 1 may be aware that the response frame transmitted by STA 1-2 (890) of STA MLD 1 is to be relayed to AP MLD 1.

Relay MLD 1 may receive the response frame (807-1) of STA 1-2 (890) of STA MLD 1 on the second link, and may transmit the same frame (807-2) to AP 1-2 (870) of AP MLD 1 after a SIFS duration from the completion of reception of the response frame of STA 1-2 (890) of STA MLD 1 on the second link. Alternatively, relay MLD 1 may receive the response frame (807-1) of STA 1-2 (890) of STA MLD 1 on the second link, perform a channel access procedure on the first link, and when the channel access procedure is completed, transmit the response frame of STA MLD 1 to AP 1-1 (840) of AP MLD 1.

AP MLD 1 may receive the response frame of STA MLD 1 through relay MLD 1. AP MLD 1 may verify the reception status of the frame transmitted by AP MLD 1 to STA MLD 1. AP MLD 1 may update the BlockAck scoreboard based on the response frame (In an embodiment, a BlockAck frame) from STA MLD 1, and may retransmit a frame if a frame whose transmission has failed exists.

In addition, in an embodiment, an error may exist in the frame received by relay MLD 1 (i.e., Relay 1-1 (850) of relay MLD 1) from AP MLD 1 (i.e., AP 1-1 (840) of AP MLD 1). Relay MLD 1 may not transmit the frame containing the error to STA MLD 1, and may not respond to AP MLD 1 or may transmit a frame requesting retransmission of the frame from AP MLD 1 (In an embodiment, an ACK frame indicating NACK, or a BlockAck frame). In this case, relay MLD 1 may receive the retransmission of the erroneous frame from AP 1-1 (840) of AP MLD 1 and transmit the frame to STA MLD 1 after receiving it without error, or may discard the erroneous frame if the retransmission of the erroneous frame is not received.

STA MLD 1 (i.e., STA 1-1 (860) of STA MLD 1) may be able to receive (decode) the frame from AP MLD 1 (i.e., AP 1-1 (840) of AP MLD 1). When STA MLD 1, AP MLD 1, and relay MLD 1 have performed relay communication operation configuration, STA 1-1 (860) of STA MLD 1 may not directly respond to AP 1-1 (840) of AP MLD 1 even when it receives the frame from AP 1-1 (840) of AP MLD 1.

In another embodiment, STA 1-1 (860) of STA MLD 1 (i.e., STA MLD 1) may be able to receive (decode) the frame from AP 1-1 (840) of AP MLD 1 (i.e., AP MLD 1). When STA MLD 1, AP MLD 1, and relay MLD 1 have performed relay communication operation configuration, STA 1-1 (860) of STA MLD 1 may store the received frame in a buffer upon receiving the frame from AP 1-1 (840) of AP MLD 1 and may not directly respond to AP MLD 1. STA 1-1 (860) of STA MLD 1 may additionally receive a data frame transmitted through relay MLD 1. STA MLD 1 may reconstruct the data frame using the data frame received from AP 1-1 (840) of AP MLD 1 and the data frame received from Relay 1-2 (880) of relay MLD 1 of relay MLD 1. Here, when the received data frame is an A-MPDU, the erroneous MPDUs of the A-MPDU received from AP 1-1 (840) of AP MLD 1 and the A-MPDU received from Relay 1-2 (880) of relay MLD 1 may differ. STA MLD 1 may recover the data frame through the error-free MPDUs, and may generate a response frame (BlockAck) based on the recovered data frame and transmit it to AP MLD 1 through relay MLD 1.

In FIG. 8A and FIG. 8B, the configuration of the relay communication operation by AP 1-1 (840) of AP MLD 1 (or AP MLD 1, AP), STA 1-1 of STA MLD 1 (or STA MLD 1, STA), and Relay 1-1 (850) of relay MLD 1 of relay MLD 1 (or relay MLD 1, STA) may be performed based on the determination of the machine learning unit described in FIG. 1 through FIG. 4. In an embodiment, the machine learning unit may determine that at least one of the AP, the relay, and the STA requires a relay communication operation, and the procedure of determining the relay that performs the relay communication operation may be performed by the machine learning unit. In another embodiment, when a plurality of relays exist in a wireless LAN network, the machine learning unit of the AP or STA may determine that a relay communication operation is required using signal strength and the like as input. When it is determined that a relay communication operation is required, the machine learning unit may select the most suitable relay for the relay communication operation using the signal strengths of the plurality of relays as input. After configuring the relay communication operation with the most suitable relay, the relay communication operation(s) described in FIG. 8A and FIG. 8B may be performed.

Based on the foregoing, the following operations may be performed. More specifically, the following operations may be performed in view of the above-described FIG. 5A to FIG. 8B. and may correspond to the relevant paragraphs, but are not limited thereto. The first AP MLD performs one or more negotiations with at least one of a second AP MLD or a non-AP MLD. The first AP MLD generates a first downlink frame including downlink data to be transmitted to the non-AP MLD and transfers the downlink data for the non-AP MLD to the second AP MLD based on the one or more negotiations. At this point, the downlink data for the non-AP MLD is configured to be transferred to the non-AP MLD through a second downlink frame configured for transmission from the second AP MLD to the non-AP MLD, and the second downlink frame is a frame based on transmission context information of the downlink data. At this point, medium access control (MAC) service data unit (MSDU) or an aggregated MAC service data unit (A-MSDU) included in the first downlink frame is identical to an MSDU or A-MSDU included in the second downlink frame. The second downlink frame is configured for transmission from the second AP MLD to the non-AP MLD based on the transmission context information, and the second downlink frame is configured to be decoded at the non-AP MLD based on the transmission context information to complete the transmission of the downlink data from the first AP MLD to the non-AP MLD. Additionally, the second downlink frame is configured based on the transmission context information available at the second AP MLD. Also, transferring the downlink data to the second AP MLD by the first AP MLD comprises transferring, to the second AP MLD, the first downlink frame generated by the first AP MLD to transmit the downlink data to the non-AP MLD, and the second downlink frame includes the first downlink frame as a payload or is configurable from the first downlink frame. At this point, the first AP MLD transfers the downlink data to the second AP MLD through a channel occupied by the first AP MLD. Also, the first AP MLD transfers transmission context information for the first downlink frame and the second downlink frame to the second AP MLD. At this point, the transmission context information transferred from the first AP MLD to the second AP MLD comprises traffic identifier (TID) information, a sequence number (SN) associated with the TID information and a packet number (PN) associated with the TID information. The one or more negotiations are for the non-AP MLD to receive, through the second AP MLD, the downlink data to be transmitted by the first AP MLD to the non-AP MLD. The first AP MLD comprises a transceiver configured to transmit and receive wireless signals, a memory storing instructions and a processor operatively coupled to the transceiver and the memory. The processor is configured to execute the instructions to perform operations above.

The first AP MLD performs one or more negotiations with a second AP MLD. The first AP MLD receives downlink data to be transmitted to a non-AP MLD from the second AP MLD. At this point, the downlink data corresponds to a first downlink frame that the second AP MLD intends to transmit to the non-AP MLD, and the first AP MLD receives, from the second AP MLD based on the one or more negotiations. The downlink data intended to be transmitted from the second AP MLD to the non-AP MLD. The first AP MLD transfers the downlink data for the non-AP MLD to the non-AP MLD through a second downlink frame transmitted from the first AP MLD to the non-AP MLD. At this point, the second downlink frame is a frame based on transmission context information of the downlink data. At this point, a medium access control (MAC) service data unit (MSDU) or an aggregated MAC service data unit (A-MSDU) included in the first downlink frame is identical to an MSDU or A-MSDU included in the second downlink frame. Additionally, the second downlink frame is configured to be decoded at the non-AP MLD based on the transmission context information to complete the transmission of the downlink data from the second AP MLD to the non-AP MLD. Also, the second downlink frame is a frame configured by the first AP MLD based on the transmission context information. At this point, receiving the downlink data from the second AP MLD by the first AP MLD comprises receiving, by the first AP MLD from the second AP MLD, the first downlink frame generated by the second AP MLD to transmit to the non-AP MLD, and the second downlink frame includes the first downlink frame as a payload or is configured from the first downlink frame. The first AP MLD receives the downlink data from the second AP MLD through a channel occupied by the second AP MLD. The first AP MLD receives transmission context information for the first downlink frame and the second downlink frame from the second AP MLD. At this point, the transmission context information transferred to the first AP MLD comprises traffic identifier (TID) information, a sequence number (SN) associated with the TID information and a packet number (PN) associated with the TID information. The one or more negotiations are for the non-AP MLD to receive, through the first AP MLD, the downlink data to be received by the non-AP MLD from the second AP MLD. Also, the first AP MLD comprises a transceiver configured to transmit and receive wireless signals, a memory storing instructions and a processor operatively coupled to the transceiver and the memory. The processor is configured to execute the instructions to perform specific operations above.

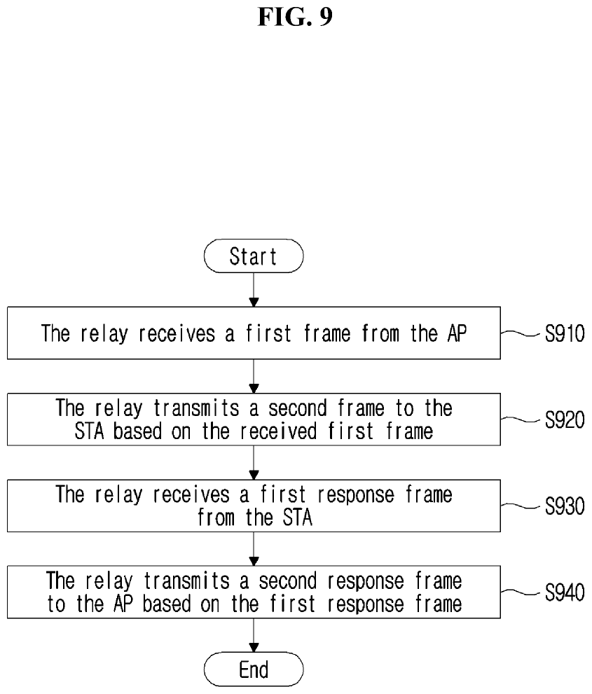

FIG. 9 is a flowchart illustrating a method of performing a relay communication operation to which the present disclosure is applied. Referring to FIG. 9, the relay may receive a first frame from an AP (S910). Here, the first frame may be a frame delivered from the AP to the STA through the relay, and may not be limited to any specific form. In an embodiment, the MAC header of the first frame may include a first indicator indicating that the first frame is transferred through the relay. Thereafter, the relay may transmit a second frame to the STA based on the received first frame (S920). In an embodiment, the second frame may be a frame generated through the frame received by the relay from the AP, and may not be limited to any specific form.

Thereafter, the relay may receive, from the STA, a first response frame generated by the STA based on the first frame (S930). Here, the MAC header of the first response frame may include a second indicator indicating that the first response frame is transferred through the relay. Thereafter, the relay may transmit a second response frame to the AP based on the first response frame (S940). In an embodiment, the relay may comprise at least one transceiver configured to transmit and receive signals, at least one processor configured to control the at least one transceiver, and a memory storing instructions that cause the relay to perform specific operations by the at least one processor, wherein the specific operations may be as described above.

The relay may perform a relay operation configuration procedure with the AP and the STA before transmitting the first frame. In an embodiment, when the relay performs the relay operation configuration procedure with the AP and the STA to configure the relay operation, an indicator indicating the relay may not be necessary. Accordingly, the MAC header of the first frame may not include the first indicator, and the MAC header of the first response frame may not include the second indicator.

In an embodiment, the first indicator indicating that the first frame is transferred through the relay may be a relay address in an address field included in the MAC header of the first frame, or a subfield or bit included in the MAC header of the first frame. In addition, the second indicator indicating that the first response frame is transferred through the relay may be a relay address in an address field included in the MAC header of the first response frame, or a subfield or bit included in the MAC header of the first response frame, as described above.

In addition, the transmitter address of the first frame may be the address of the AP, and the receiver address of the first frame may be the address of the STA. The relay may receive the first frame and generate the second frame, wherein the payload of the second frame may include the first frame. That is, the relay may encapsulate the received first frame to generate the second frame, as shown in FIG. 5A through FIG. 5C. In an embodiment, the MAC header of the second frame may include a third indicator indicating that the first frame is encapsulated.

In addition, the transmitter address of the first response frame may be the address of the STA, and the receiver address of the first response frame may be the address of the AP. The relay may receive the first response frame and generate the second response frame, wherein the payload of the second response frame may include the first response frame. That is, the relay may encapsulate the received first response frame to generate the second response frame, as shown in FIG. 5A through FIG. 5C. In an embodiment, the MAC header of the second response frame may include a fourth indicator indicating that the first response frame is encapsulated. In addition, the relay may transmit the second frame after a preset period of time from the time of receiving the first frame. In addition, in an embodiment, upon receiving the first frame, the relay may transmit a response frame to the first frame to the AP after a preset period of time from the time of receiving the first frame. The relay may perform a channel access operation after transmitting the response frame to the first frame and transmit the second frame within the allocated transmission opportunity (TXOP), as described above.

In addition, the relay may be a relay MLD comprising a first relay associated with a first link and a second relay associated with a second link, as shown in FIG. 5C, FIG. 6B, FIG. 7B, and FIG. 8B. The relay MLD may receive the first frame from an AP MLD on the first link for the first relay (Relay 1-1 of relay MLD), and the relay MLD may transmit the second frame to a STA MLD on the second link for the second relay (Relay 1-2 of relay MLD), as described above. In an embodiment, when the relay MLD successfully decodes the first frame or the relay MLD detects transmission of the first frame on the first link for the first relay, the relay MLD may perform a channel access operation on the second link for the second relay and transmit the second frame within the allocated TXOP. Here, the TXOP allocated on the second link may be set to a duration equal to or longer than the sum of the time for the relay MLD to transmit one or more second frames, the time for receiving the first response frame from the STA MLD, the time for transmitting the second response frame to the AP MLD, and the inter-frame interval durations, as described above.

In addition, in an embodiment, the transmitter address of the first frame received by the relay may be the address of the AP, and the receiver address of the first frame may be the address of the relay. That is, the relay may receive the frame encapsulated by the AP. The relay may receive the first frame and generate the second frame, which may be the aforementioned decapsulation. Here, the transmitter address of the second frame may be the address of the AP, and the receiver address of the second frame may be the address of the STA. The relay may generate the second frame through the original frame of the AP included in the payload of the first frame. Here, the second frame is a frame in which the MAC header is modified from the original frame of the AP, and the MAC header of the second frame may include a fifth indicator indicating that the original frame of the AP is transferred through the relay.

In addition, the transmitter address of the first response frame received by the relay may be the address of the STA, and the receiver address of the first frame may be the address of the relay. That is, the relay may receive the response frame encapsulated by the STA. The relay may receive the first response frame and generate the second response frame, which may be the aforementioned decapsulation. The transmitter address of the second response frame may be the address of the STA, and the receiver address of the second frame may be the address of the AP. Here, the relay may generate the second response frame through the original response frame of the STA included in the payload of the first response frame. In an embodiment, the second response frame is a frame in which the MAC header is modified from the original response frame of the STA, and the MAC header of the second response frame may include a sixth indicator indicating that the original response frame of the STA is transferred through the relay.

In addition, the relay may receive the first frame, generate a second frame identical to the first frame based on bits obtained through decoding and error correction, and transmit the second frame to the STA. In addition, the relay may receive the first response frame, generate a second response frame identical to the first response frame based on bits obtained through decoding and error correction, and transmit the second response frame to the AP, as shown in FIG. 7A and FIG. 7B.

In addition, without performing a relay operation negotiation procedure with the AP and the STA, the relay may receive the first frame, wait from the end of retransmission of the first frame until a preset period of time elapses, and generate a second frame identical to the first frame based on bits obtained through decoding and error correction of the first frame, and transmit the second frame to the STA, as shown in FIG. 8A and FIG. 8B.

The methods according to the present disclosure may be implemented in the form of program instructions that can be executed through various computer means and recorded on a computer-readable medium. The computer-readable medium may include program instructions, data files, data structures, etc., alone or in combination. The program instructions recorded on the computer-readable medium may be those specially designed and configured for the present disclosure, or may be known and available to those skilled in the art of computer software.

Examples of the computer-readable medium include hardware devices specially configured to store and execute program instructions, such as ROM, RAM, and flash memory. Examples of program instructions include not only machine language code such as that produced by a compiler, but also high-level language code that can be executed by a computer using an interpreter or the like. The aforementioned hardware devices may be configured to operate as at least one software module to perform the operations of the present disclosure, and vice versa.

Although the present disclosure has been described with reference to the embodiments above, those skilled in the art will understand that various modifications and changes may be made to the present disclosure without departing from the spirit and scope of the present disclosure as set forth in the following claims.

### INDUSTRIAL APPLICABILITY

The foregoing may also be applicable to other systems.

What is claimed is:

1. A method of operating a first access point multi-link device (AP MLD) in a wireless LAN system, the method comprising:
performing, by the first AP MLD, one or more negotiations with at least one of a second AP MLD or a non-AP MLD;
generating, by the first AP MLD, a first downlink frame including downlink data to be transmitted to the non-AP MLD; and
transferring, by the first AP MLD, the downlink data for the non-AP MLD to the second AP MLD based on the one or more negotiations,
wherein the downlink data for the non-AP MLD is configured to be transferred to the non-AP MLD through a second downlink frame configured for transmission from the second AP MLD to the non-AP MLD, and
wherein the second downlink frame is a frame based on transmission context information of the downlink data.

2. The method of claim 1,
wherein a medium access control (MAC) service data unit (MSDU) or an aggregated MAC service data unit (A-MSDU) included in the first downlink frame is identical to an MSDU or A-MSDU included in the second downlink frame.

3. The method of claim 2,
wherein the second downlink frame is configured for transmission from the second AP MLD to the non-AP MLD based on the transmission context information, and
wherein the second downlink frame is configured to be decoded at the non-AP MLD based on the transmission context information to complete the transmission of the downlink data from the first AP MLD to the non-AP MLD.

4. The method of claim 1,
wherein the second downlink frame is configured based on the transmission context information available at the second AP MLD.

5. The method of claim 1,
wherein transferring the downlink data to the second AP MLD by the first AP MLD comprises transferring, to the second AP MLD, the first downlink frame generated by the first AP MLD to transmit the downlink data to the non-AP MLD, and
wherein the second downlink frame includes the first downlink frame as a payload or is configurable from the first downlink frame.

6. The method of claim 1,
wherein the first AP MLD transfers the downlink data to the second AP MLD through a channel occupied by the first AP MLD.

7. The method of claim 1,
wherein the first AP MLD transfers transmission context information for the first downlink frame and the second downlink frame to the second AP MLD.

8. The method of claim 7,
wherein the transmission context information transferred from the first AP MLD to the second AP MLD comprises traffic identifier (TID) information, a sequence number (SN) associated with the TID information and a packet number (PN) associated with the TID information.

9. The method of claim 1,
wherein the one or more negotiations are for the non-AP MLD to receive, through the second AP MLD, the downlink data to be transmitted by the first AP MLD to the non-AP MLD.

10. A first AP MLD in a wireless LAN system, the first AP MLD comprising:
a transceiver configured to transmit and receive wireless signals;
a memory storing instructions; and
a processor operatively coupled to the transceiver and the memory,
wherein the processor is configured to execute the instructions to perform specific operations,
wherein the specific operations comprise:
performing one or more negotiations with at least one of a second AP MLD or a non-AP MLD;
generating a first downlink frame including downlink data to be transmitted to the non-AP MLD; and
transferring the downlink data for the non-AP MLD to the second AP MLD based on the one or more negotiations,
wherein the downlink data for the non-AP MLD is configured to be transferred to the non-AP MLD through a second downlink frame configured for transmission from the second AP MLD to the non-AP MLD, and
wherein the second downlink frame is a frame based on transmission context information of the downlink data.

11. A method of operating a first AP MLD in a wireless LAN system, the method comprising:
performing, by the first AP MLD, one or more negotiations with a second AP MLD;
receiving, by the first AP MLD from the second AP MLD, downlink data to be transmitted to a non-AP MLD, wherein the downlink data corresponds to a first downlink frame that the second AP MLD intends to transmit to the non-AP MLD, and the first AP MLD receives, from the second AP MLD based on the one or more negotiations, the downlink data intended to be transmitted from the second AP MLD to the non-AP MLD; and
transferring the downlink data for the non-AP MLD to the non-AP MLD through a second downlink frame transmitted from the first AP MLD to the non-AP MLD, wherein the second downlink frame is a frame based on transmission context information of the downlink data.

12. The method of claim 11,
wherein a medium access control (MAC) service data unit (MSDU) or an aggregated MAC service data unit (A-MSDU) included in the first downlink frame is identical to an MSDU or A-MSDU included in the second downlink frame.

13. The method of claim 12,
wherein the second downlink frame is configured to be decoded at the non-AP MLD based on the transmission context information to complete the transmission of the downlink data from the second AP MLD to the non-AP MLD.

14. The method of claim 11,
wherein the second downlink frame is a frame configured by the first AP MLD based on the transmission context information.

15. The method of claim 11,
wherein receiving the downlink data from the second AP MLD by the first AP MLD comprises receiving, by the first AP MLD from the second AP MLD, the first downlink frame generated by the second AP MLD to transmit to the non-AP MLD, and
wherein the second downlink frame includes the first downlink frame as a payload or is configured from the first downlink frame.

16. The method of claim 11,
wherein the first AP MLD receives the downlink data from the second AP MLD through a channel occupied by the second AP MLD.

17. The method of claim 11,
wherein the first AP MLD receives transmission context information for the first downlink frame and the second downlink frame from the second AP MLD.

18. The method of claim 17,
wherein the transmission context information transferred to the first AP MLD comprises traffic identifier (TID) information, a sequence number (SN) associated with the TID information and a packet number (PN) associated with the TID information.

19. The method of claim 11,
wherein the one or more negotiations are for the non-AP MLD to receive, through the first AP MLD, the downlink data to be received by the non-AP MLD from the second AP MLD.

20. A first AP MLD in a wireless LAN system, the first AP MLD comprising:
a transceiver configured to transmit and receive wireless signals;
a memory storing instructions; and
a processor operatively coupled to the transceiver and the memory,
wherein the processor is configured to execute the instructions to perform specific operations,
wherein the specific operations comprise:
performing one or more negotiations with a second AP MLD;
receiving downlink data to be transmitted to a non-AP MLD, wherein the downlink data corresponds to a first downlink frame that the second AP MLD intends to transmit to the non-AP MLD, and the first AP MLD receives, from the second AP MLD based on the one or more negotiations, the downlink data intended to be transmitted from the second AP MLD to the non-AP MLD, and
transferring the downlink data for the non-AP MLD to the non-AP MLD through a second downlink frame transmitted from the first AP MLD to the non-AP MLD, wherein the second downlink frame is a frame based on transmission context information of the downlink data.
